(19) United States
(12) Patent Application Publication
(10) Pub. No.: US 2024/0357636 A1
(43) Pub. Date: Oct. 24, 2024

(54) METHOD AND APPARATUS OF UPLINK TIMING ADJUSTMENT

(71) Applicant: Samsung Electronics Co., Ltd., Suwon-si (KR)

(72) Inventors: Dalin Zhu, Allen, TX (US); Eko Onggosanusi, Coppell, TX (US); Emad N. Farag, Flanders, NJ (US); Md. Saifur Rahman, Plano, TX (US)

(21) Appl. No.: 18/758,258

(22) Filed: Jun. 28, 2024

Related U.S. Application Data
(63) Continuation of application No. 17/645,946, filed on Dec. 23, 2021, now abandoned.
(60) Provisional application No. 63/131,220, filed on Dec. 28, 2020.
(60) Provisional application No. 63/289,497, filed on Dec. 14, 2021.

(51) Int. Cl. H04W 74/00; H04W 74/0833

(52) U.S. Cl. CPC H04W 74/002; H04W 74/0833

(57) ABSTRACT

Apparatuses and methods for uplink timing adjustment in a wireless communication system. A method for operating a user equipment (UE) includes receiving a first uplink (UL) timing advance (TA) command for a first link associated with a first physical cell identity (PCI); receiving a second UL TA command for a second link associated with a second PCI; and determining, based on the first and second UL TA commands, first and second UL timing adjustments for the first and second links associated with the first and second PCIs, respectively. The method further includes transmitting a physical uplink control channel (PUCCH), a physical uplink shared channel (PUSCH), or a sounding reference signal (SRS) associated with the first PCI according to the first UL timing adjustment; and transmitting a PUCCH, a PUSCH, or a SRS associated with the second PCI according to the second UL timing adjustment. The second PCI is different from a serving cell PCI.

### CROSS-REFERENCE TO RELATED APPLICATIONS AND CLAIM OF PRIORITY

This application is a continuation of U.S. patent application Ser. No. 17/645,946, filed on Dec. 23, 2021, which claims priority to U.S. Provisional Patent Application No. 63/131,220, filed on Dec. 28, 2020, and U.S. Provisional Patent Application No. 63/289,497, filed on Dec. 14, 2021. The content of the above-identified patent documents are incorporated herein by reference.

### TECHNICAL FIELD

The present disclosure relates generally to wireless communication systems and, more specifically, the present disclosure relates to uplink (UL) timing adjustment in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to UL timing adjustment in a wireless communication system.

In one embodiment, a user equipment (UE) is provided. The UE includes a transceiver configured to receive a first UL timing advance (TA) command for a first link associated with a first physical cell identity (PCI) and receive a second UL TA command for a second link associated with a second PCI. The UE also includes a processor operably coupled to the transceiver. The processor is configured to determine, based on the first and second UL TA commands, first and second UL timing adjustments for the first and second links associated with the first and second PCIs, respectively. The transceiver is further configured to transmit a physical uplink control channel (PUCCH), a physical uplink shared channel (PUSCH), or a sounding reference signal (SRS) associated with the first PCI according to the first UL timing adjustment; and transmit a PUCCH, a PUSCH, or a SRS associated with the second PCI according to the second UL timing adjustment. The second PCI is different from a serving cell PCI.

In another embodiment, a base station (BS) is provided. The BS includes a transceiver configured to transmit a first UL TA command for a first link associated with a first PCI or transmit a second UL TA command for a second link associated with a second PCI. The BS further includes a processor operably coupled to the transceiver. The processor is configured to determine, based on the first or second UL TA commands, first or second UL timing adjustments for the first or second links associated with first or second PCIs, respectively. The transceiver is further configured to receive a PUCCH, a PUSCH, or a SRS associated with the first PCI according to the first UL timing adjustment; or receive a PUCCH, a PUSCH, or a SRS associated with the second PCI according to the second UL timing adjustment. The second PCI is different from a serving cell PCI.

In yet another embodiment, a method for operating a UE is provided. The method includes receiving a first UL TA command for a first link associated with a first PCI; receiving a second UL TA command for a second link associated with a second PCI; and determining, based on the first and second UL TA commands, first and second UL timing adjustments for the first and second links associated with the first and second PCIs, respectively. The method further includes transmitting a PUCCH, a PUSCH, or a SRS associated with the first PCI according to the first UL timing adjustment; and transmitting a PUCCH, a PUSCH, or a SRS associated with the second PCI according to the second UL timing adjustment. The second PCI is different from a serving cell PCI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6A illustrate an example of signaling flow for 4-step contention based random access procedure according to embodiments of the present disclosure;

FIG. 6B illustrate an example of signaling flow for 2-step contention based random access procedure according to embodiments of the present disclosure;

FIG. 7A illustrates an example of signaling flow for inter-cell mobility according to embodiments of the present disclosure;

FIG. 7B illustrates another example of signaling flow for inter-cell mobility according to embodiments of the present disclosure;

FIG. 8 illustrates a flowchart of a method for acquiring UL TA for a non-serving cell PCI according to embodiments of the present disclosure;

FIG. 9 illustrates an example of serving cell configuring non-serving cell RS resources and UE measuring the non-serving cell RSs according to embodiments of the present disclosure;

FIG. 10 illustrates an example of DL RS configurations and QCL relations for the non-serving cell PCI according to embodiments of the present disclosure;

FIG. 11 illustrates an example of the propagation delay difference between the serving cell and the non-serving cell according to embodiments of the present disclosure;

FIG. 12 illustrates an example of asynchronous reception according to embodiments of the present disclosure;

FIG. 13 illustrates a flowchart of a method for acquiring propagation delay difference in an inter-cell system according to embodiments of the present disclosure;

FIG. 14 illustrates an example of signaling flow for indicating necessary configurations required for acquiring propagation delay difference in an inter-cell system according to embodiments of the present disclosure;

FIG. 15 illustrates an example of a RRC parameter indicating non-serving cell SSB information according to embodiments of the present disclosure;

FIG. 16 illustrates a flowchart of a method for reporting to the serving cell the receive timing difference according to embodiments of the present disclosure;

FIG. 17 illustrates a flowchart of another method for reporting to the serving cell the receive timing difference according to embodiments of the present disclosure;

FIG. 18 illustrates an example of CSI payload according to embodiments of the present disclosure;

FIG. 19 illustrates an example of two-part CSI according to embodiments of the present disclosure;

FIG. 20 illustrates a flowchart of a method for reporting to the serving cell according to embodiments of the present disclosure;

FIG. 21 illustrates an example of a TA command MAC CE for non-serving cell PCI according to embodiments of the present disclosure;

FIG. 22A illustrates a flowchart of a method for reporting to the serving cell the timing difference (TD) according to embodiments of the present disclosure;

FIG. 22B illustrates a flowchart of a method for UE determining and applying the UL timing adjustments according to embodiments of the present disclosure;

FIG. 22C illustrates another flowchart of a method for UE determining and applying the UL timing adjustments according to embodiments of the present disclosure;

FIG. 23 illustrates an example of signaling flow for UE determining and applying the UL timing adjustments according to embodiments of the present disclosure;

FIG. 24 illustrates an example of signaling flow for RACH-less inter-cell mobility according to embodiments of the present disclosure;

FIG. 25 illustrates another example of signaling flow for RACH-less inter-cell mobility according to embodiments of the present disclosure;

FIG. 26 illustrates an example of multi-TRP multi-beam operation according to embodiments of the present disclosure; and

FIG. 27 illustrates an example of single-TRP multi-beam operation according to embodiments of the present disclosure.

### DETAILED DESCRIPTION

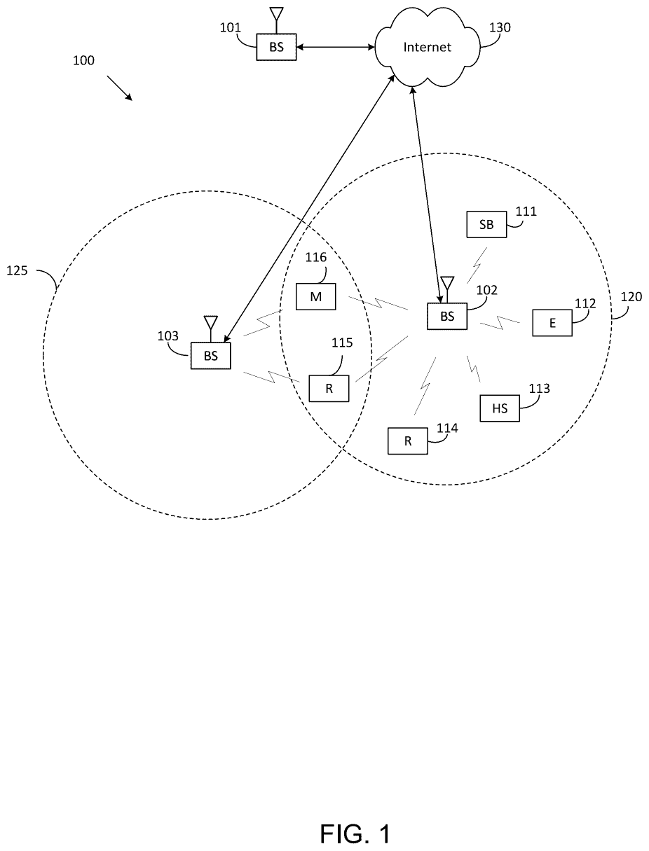

FIG. 1 through FIG. 27, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v16.1.0, “NR; Physical channels and modulation”; 3GPP TS 38.212 v16.1.0, “NR; Multiplexing and Channel coding”; 3GPP TS 38.213 v16.1.0, “NR; Physical Layer Procedures for Control”; 3GPP TS 38.214 v16.1.0, “NR; Physical Layer Procedures for Data”; 3GPP TS 38.321 v16.1.0, “NR; Medium Access Control (MAC) protocol specification”; and 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for beam management for timing advance acquisition in a wireless communication system. In certain embodiments, and one or more of the gNBs 101-103 includes circuitry, programing, or a combination thereof, for beam management for timing advance acquisition in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

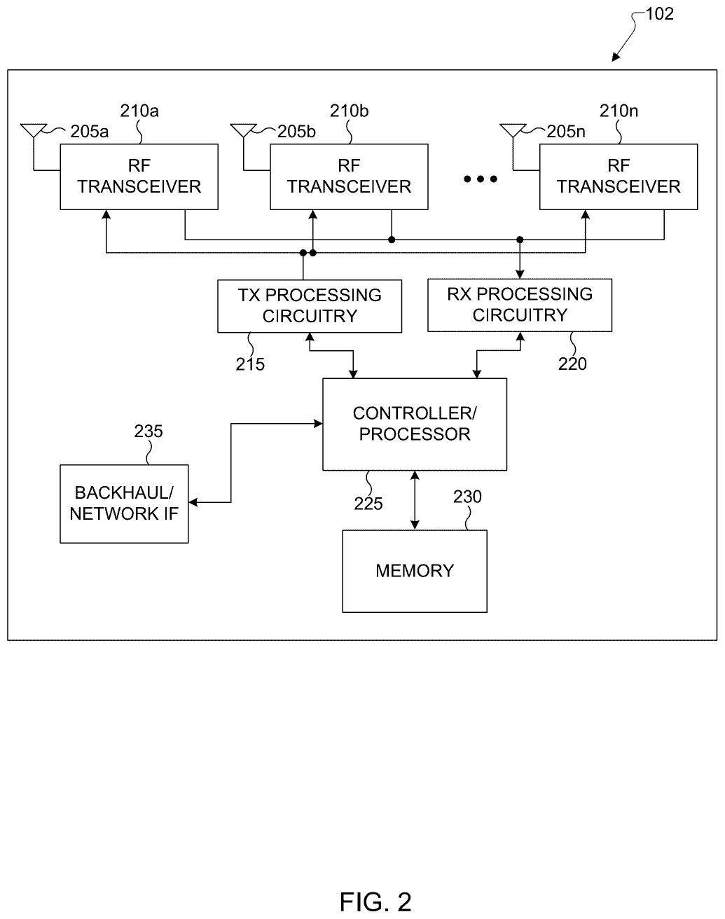

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple RF transceivers 210a-210n, transmit (TX) processing circuitry 215, and receive (RX) processing circuitry 220. The gNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the gNB 102 could include multiple instances of each (such as one per RF transceiver). Also, various components in FIG. 2 could be combined, further subdivided, or omitted and additional components could be added according to particular needs.

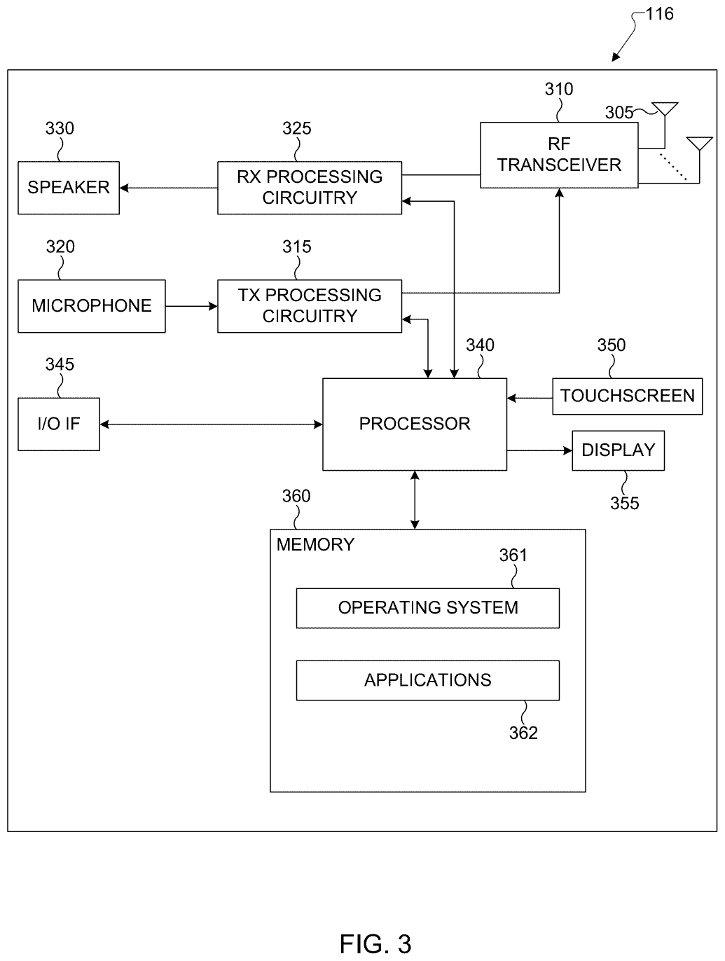

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, TX processing circuitry 315, a microphone 320, and receive (RX) processing circuitry 325. The UE 116 also includes a speaker 330, a processor 340, an input/output (I/O) interface (IF) 345, a touchscreen 350, a display 355, and a memory 360. The memory 360 includes an operating system (OS) 361 and one or more applications 362.

The RF transceiver 310 receives, from the antenna 305, an incoming RF signal transmitted by a gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data (such as web data, e-mail, or interactive video game data) from the processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the RF transceiver 310, the RX processing circuitry 325, and the TX processing circuitry 315 in accordance with well-known principles. In some embodiments, the processor 340 includes at least one microprocessor or microcontroller.

The processor 340 is also capable of executing other processes and programs resident in the memory 360, such as processes for beam management for timing advance acquisition in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the touchscreen 350 and the display 355. The operator of the UE 116 can use the touchscreen 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

A communication system includes a downlink (DL) that refers to transmissions from a base station or one or more transmission points to UEs and an uplink (UL) that refers to transmissions from UEs to a base station or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 0.5 milliseconds or 1 millisecond, include 14 symbols and an RB can include 12 SCs with inter-SC spacing of 15 KHz or 30 KHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB transmits one or more of multiple types of RS including channel state information RS (CSI-RS) and demodulation RS (DMRS). A CSI-RS is primarily intended for UEs to perform measurements and provide CSI to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE can determine CSI-RS transmission parameters through DL control signaling or higher layer signaling, such as radio resource control (RRC) signaling, from a gNB. Transmission instances of a CSI-RS can be indicated by DL control signaling or be configured by higher layer signaling. A DM-RS is transmitted only in the BW of a respective PDCCH or PDSCH and a UE can use the DMRS to demodulate data or control information.

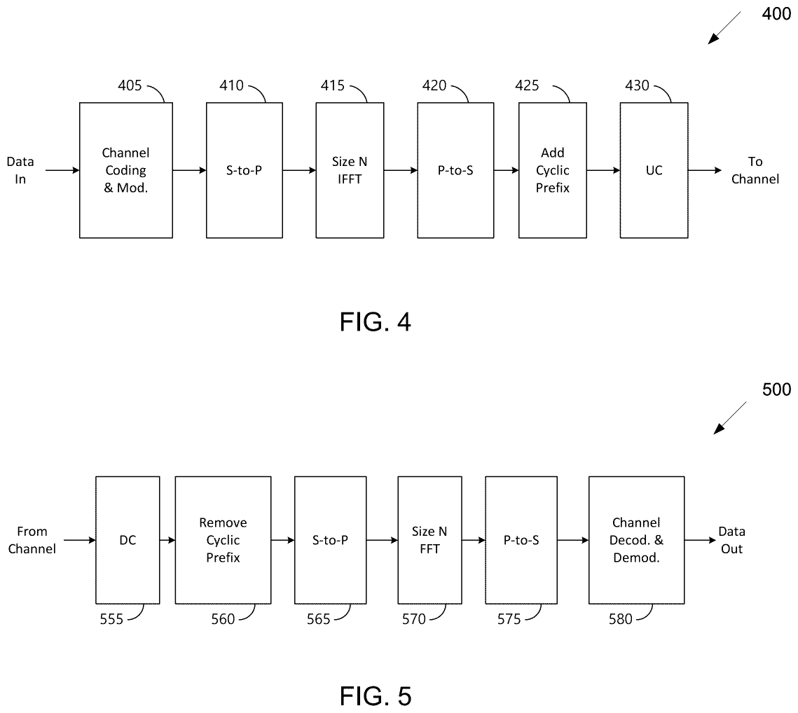

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support the codebook design and structure for systems having 2D antenna arrays as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

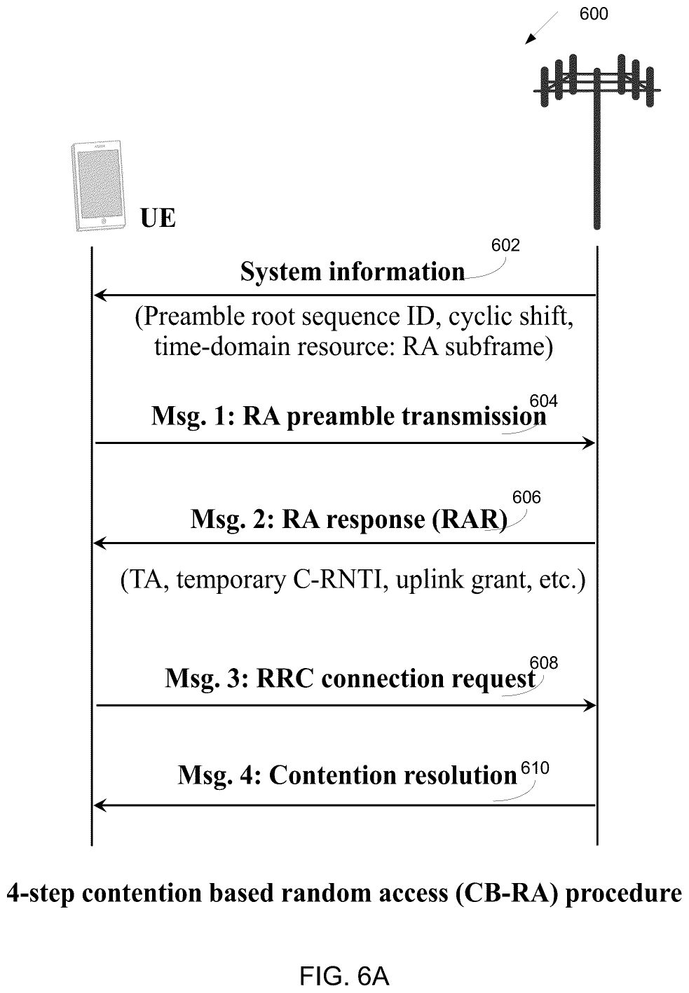

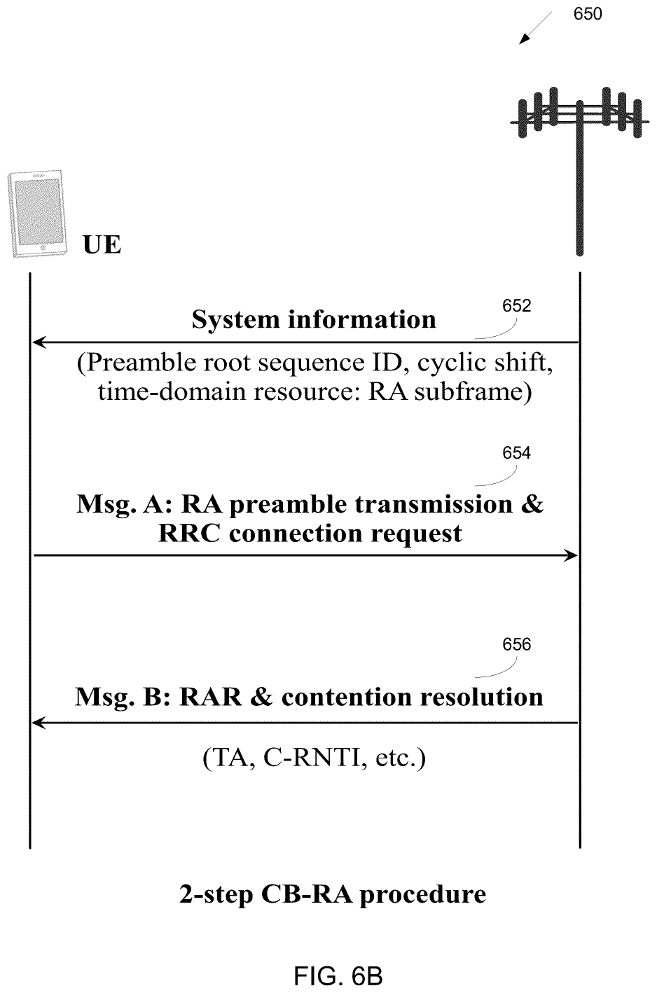

FIG. 6A illustrates an example of signaling flow 600 for 4-step contention based random access procedure according to embodiments of the present disclosure. For example, the signaling flow 600 as may be performed by a UE (e.g., 111-116 as illustrated in FIG. 1) and a BS (e.g., 101-103 as illustrated in FIG. 1). An embodiment of the signaling flow 600 shown in FIG. 6A is for illustration only. One or more of the components illustrated in FIG. 6A can be implemented in specialized circuitry configured to perform the noted functions or one or more of the components can be implemented by one or more processors executing instructions to perform the noted functions.

FIG. 6B illustrates an example of signaling flow 650 for 2-step contention based random access procedure according to embodiments of the present disclosure. For example, the signaling flow 650 as may be performed by a UE (e.g., 111-116 as illustrated in FIG. 1) and a BS (e.g., 101-103 as illustrated in FIG. 1). An embodiment of the signaling flow 650 shown in FIG. 6B is for illustration only. One or more of the components illustrated in FIG. 6B can be implemented in specialized circuitry configured to perform the noted functions or one or more of the components can be implemented by one or more processors executing instructions to perform the noted functions.

A UE could acquire uplink (UL) timing advance (TA) for a given cell during a random access (RA) process. In FIG. 6A and FIG. 6B, examples of both 4-step and 2-step contention based random access (CB-RA) procedures are presented. The UE transmits RA preamble to the gNB in Msg. 1 (in the 4-step RA as illustrated in FIG. 6A) or Msg. A (in the 2-step RA as illustrated in FIG. 6B). From the RA preamble, the gNB estimates the round-trip delay between the UE and the gNB, and determines the TA for the UE. The UE is then indicated by the gNB of the UL TA through Msg. 2 (in the 4-step RA) or Msg. B (in the 2-step RA). The acquisition of the UL TA could be delayed. For instance, if the gNB cannot successfully decode or receive Msg. A in the 2-step RA process, the UE may need to retransmit Msg. A or fall back to the 4-step RA procedure, which in turn, would result in additional time/delay for the UE to obtain the TA command from the gNB.

As illustrated in FIG. 6A, a UE in step 602 receives system information and transmits in step 604 Msg. 1 (e.g., RA preamble transmission). In step 606, the UE receives Msg. 2 (RA response (RAR)). And in step 608, the UE transmits Msg. 3 (e.g., RRC connection request). In step 610, the UE receives Msg. 4 (e.g., contention resolution).

As illustrated in FIG. 6B, a UE in step 652 receives system information and transmits in step 654 Msg. A (e.g., RA preamble transmission and RRC connection request). In step 656, the UE receives Msg. B (RAR and contention resolution).

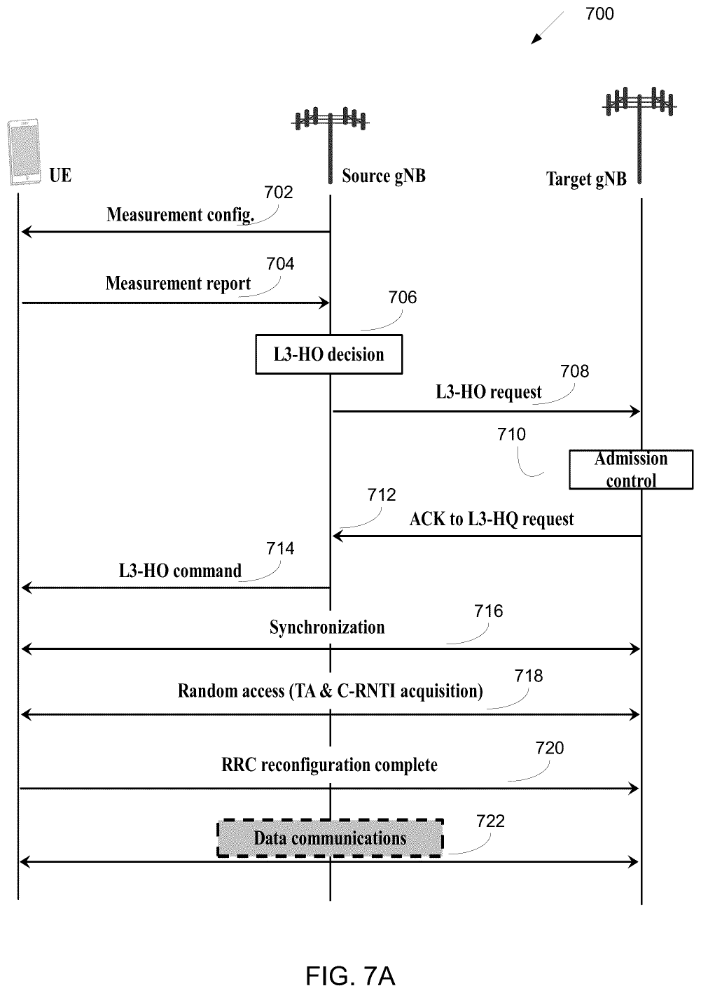

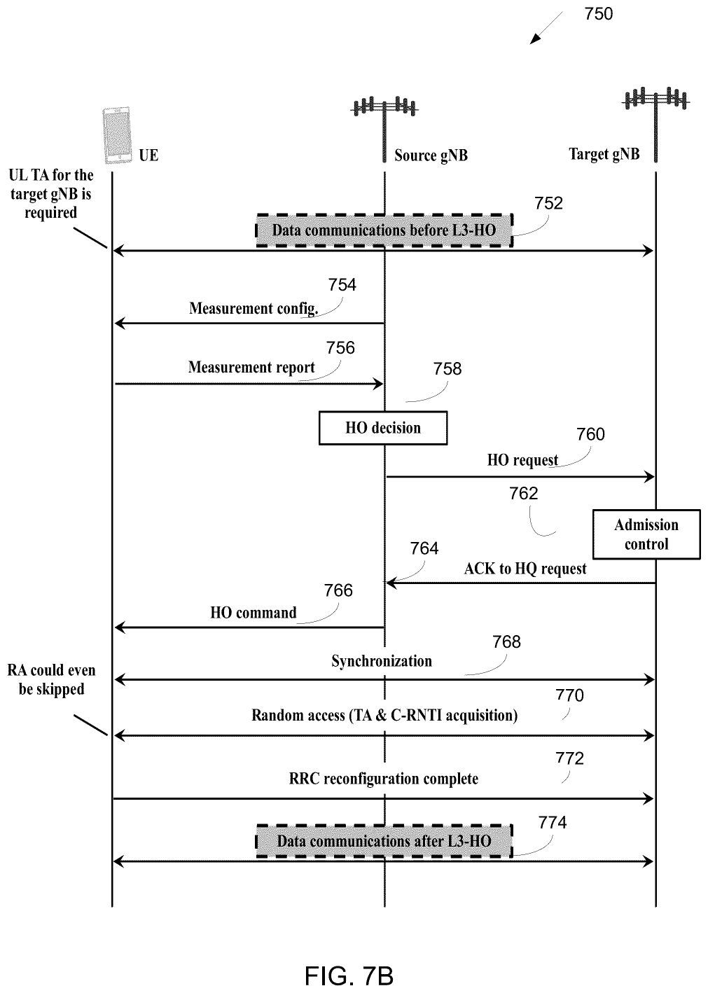

FIG. 7A illustrates an example of signaling flow 700 for inter-cell mobility according to embodiments of the present disclosure. For example, the signaling flow 700 as may be performed by a UE (e.g., 111-116 as illustrated in FIG. 1) and BSs (e.g., 101-103 as illustrated in FIG. 1). An embodiment of the signaling flow 700 shown in FIG. 7A is for illustration only. One or more of the components illustrated in FIG. 7A can be implemented in specialized circuitry configured to perform the noted functions or one or more of the components can be implemented by one or more processors executing instructions to perform the noted functions.

FIG. 7B illustrates another example of signaling flow 750 for inter-cell mobility according to embodiments of the present disclosure. For example, the signaling flow 750 as may be performed by a UE (e.g., 111-116 as illustrated in FIG. 1) and BSs (e.g., 101-103 as illustrated in FIG. 1). An embodiment of the signaling flow 750 shown in FIG. 7B is for illustration only. One or more of the components illustrated in FIG. 7B can be implemented in specialized circuitry configured to perform the noted functions or one or more of the components can be implemented by one or more processors executing instructions to perform the noted functions.

For inter-cell operation, the RACH procedure for the target cell/gNB could happen after the source cell/gNB sends the L3 handover (HO) command to the UE (see FIG. 7A). Only after the UE has finished the RACH procedure for the target cell/gNB, and therefore, acquired the TA for the target cell/gNB, the UE could transmit/receive data/control signals to/from the target gNB. In future-generation wireless communications systems, however, the UE could transmit/receive certain data/control signals to/from the target gNB before the L3-HO (one conceptual example is presented in FIG. 7B). In this case, the UE would need to acquire/estimate the TA for the target cell/gNB via other means than RACH. Furthermore, if the UE could acquire/estimate the TA for the target cell/gNB without transmitting the RA preamble, the RACH procedure during the L3-HO could even be skipped. How to obtain the TA for the target cell/gNB without relying on RACH, however, is a challenging problem.

In the present disclosure, the target cell(s)/gNB(s) could have/broadcast different physical cell IDs (PCIs) and/or other higher layer signaling index values from that of the serving cell or the serving cell PCI. That is, for the inter-cell operation considered in the present disclosure, different cells/gNBs could broadcast different PCIs and/or one or more cells/gNBs (referred to/defined as target cells/gNBs in the present disclosure) could broadcast different PCIs from that of the serving cell (i.e., the serving cell PCI) and/or one or more cells/gNBs are not associated with valid serving cell ID (e.g., provided by the higher layer parameter ServCellIndex). In the present disclosure, a target cell PCI can also be referred to as an additional PCI, another PCI or a different PCI (with respect to the serving cell PCI).

As illustrated in FIG. 7A, in step 702, a UE receives a measurement configuration from a source gNB. In step 704, the UE transmits a measurement report to the source gNB. In step 706, the source gNB performs a L3-HO decision. In step 708, the source gNB transmits a L3-HO request to a target gNB. In step 710, the target gNB performs an admission control operation. In step 712, the target gNB transmits an ACK corresponding to the L3-HO request. In step 714, the UE receives an L3-HO command from the source gNB. In step 716, the UE and the target gNB may be synchronized. In step 718, the UE and the target gNB may perform a random access operation (e.g., TA and C-RNTI acquisition). In step 720, the UE transmits an RRC reconfiguration complete to the target gNB. In step 722, the UE and the target gNB may perform data communications.

As illustrated in FIG. 7B, in step 752, a UE and a target gNB performs a data communication before an L3-HO operation. In step 754, the UE receives a measurement configuration from a source gNB. In step 756, the UE transmits a measurement report to the source gNB. In step 758, the source gNB performs a HO decision. In step 760, the source gNB transmits a HO request to the target gNB. In step 762, the target gNB performs an admission control operation. In step 764, the target gNB transmits an ACK corresponding to the HO request. In step 766, the UE receives an HO command from the source gNB. In step 768, the UE and the target gNB may be synchronized. In step 770, the UE and the target gNB may perform a random access operation (e.g., TA and C-RNTI acquisition). In step 772, the UE transmits an RRC reconfiguration complete to the target gNB. In step 774, the UE and the target gNB may perform data communications after the L3-HO.

In the present disclosure, various/several design strategies of acquiring the UL TA for a non-serving cell in an inter-cell system are provided. The UE could first estimate their propagation delay difference between the serving cell and the non-serving cell. This can be achieved by enabling L1 based beam measurement/reporting for the non-serving cell. The UE could then combine the estimated propagation delay difference and the UL TA for the serving cell (known a prior) to derive the UL TA for the non-serving cell.

Alternatively, the UE could send the propagation delay difference to the serving cell/gNB, and the serving cell/gNB would determine for the UE the UL TA for the non-serving cell. In this case, the UE would be indicated by the serving gNB the UL TA for the non-serving cell, through, e.g., MAC CE signaling. Other design alternatives and various configuration methods to acquire/estimate the TA for the non-serving cell are also considered in this disclosure.

In the present disclosure, non-serving cell(s) could have/broadcast different physical cell IDs (PCIs) and/or other higher layer signaling index values from that of the serving cell or the serving cell PCI. That is, for the inter-cell operation considered in the present disclosure, different cells could broadcast different PCIs and/or one or more cells (referred to/defined as non-serving cells in the present disclosure) could broadcast different PCIs from that of the serving cell (i.e., the serving cell PCI) and/or one or more cells (referred to/defined as non-serving cells in the present disclosure) are not associated with valid serving cell IDs (e.g., provided by the higher layer parameter ServCellIndex). In the present disclosure, a non-serving cell PCI can also be referred to as an additional PCI, another PCI or a different PCI (with respect to the serving cell PCI).

In the present disclosure, the serving cell PCI and non-serving cell PCI could correspond to different transmission-reception points (TRPs) in a multi-TRP system. For a multi-DCI based multi-TRP system, the serving cell or the serving cell PCI with one or more active TCI states for PDCCH/PDSCH and the non-serving (or neighboring) cell PCI with one or more active TCI states for PDCCH/PDSCH are associated with different values of CORESETPoolIndex if the CORESETPoolIndex is configured (and therefore, different TRPs in a multi-DCI based multi-TRP system).

For example, the serving cell PCI with one or more active TCI states for PDCCH/PDSCH could be associated with ‘CORESETPoolIndex=0’, while the non-serving (or neighboring) cell PCI with one or more active TCI states for PDCCH/PDSCH could be associated with ‘CORESETPoolIndex=1’. For another example, the serving cell PCI with one or more active TCI states for PDCCH/PDSCH could be associated with ‘CORESETPoolIndex=1’, while the non-serving (or neighboring) cell with one or more active TCI states for PDCCH/PDSCH could be associated with ‘CORESETPoolIndex=0’.

Or equivalently, when/if the UE is configured with PDCCH-Config that contains two different CORESETPoolIndex values in CORESET, different PCIs could be associated with different CORESETPoolIndex values, and therefore, the CORESETs corresponding to different CORESETPoolIndex values via the active TCI states of the CORESETs. That is, CORESETs corresponding to one CORESETPoolIndex value (e.g., ‘CORESETPoolIndex=0’) could be associated with a first PCI (e.g., the serving cell PCI), and CORESETs corresponding to another CORESETPoolIndex value (e.g., ‘CORESETPoolIndex=1’) could be associated with a second PCI (e.g., the non-serving cell PCI).

Furthermore, when/if the UE is configured with PDCCH-Config that contains two different CORESETPoolIndex values in CORESET, and if the UE receives from the network a MAC CE activation command—e.g., for CORESET(s) associated with each CORESETPoolIndex (as described in clause 6.1.3.14 of TS 38.321) used to map up to 8 TCI states to the codepoints of the DCI field “Transmission Configuration Indication”, the activated TCI states corresponding to one CORESETPoolIndex value (e.g., ‘CORESETPoolIndex=0’) could be associated with a first PCI (e.g., the serving cell PCI), and the activated TCI states corresponding to another CORESETPoolIndex value (e.g., ‘CORESETPoolIndex=1’) could be associated with a second PCI (e.g., the non-serving cell PCI).

Hence, throughout the present disclosure, discussions related to the serving cell PCI and non-serving cell PCI are also applicable or can be extended to different CORESETPoolIndex values (e.g., ‘0’ and ‘1’), and therefore, the corresponding TRPs in a multi-DCI based multi-TRP system. For a single-DCI based multi-TRP system, one or more CORESETs could be grouped together, and associated with a same CORESET group index value (denoted by CORESETGroupIndex analogous to CORESETPoolIndex for multi-DCI based framework). For example, the CORESETGroupIndex value could be indicated/included in the higher layer parameter ControlResourceSet configured for a CORESET. Hence, for a single-DCI based multi-TRP system, the serving cell or the serving cell PCI with one or more active TCI states for PDCCH/PDSCH and the non-serving (or neighboring) cell PCI with one or more active TCI states for PDCCH/PDSCH are associated with different values of CORESETGroupIndex if the CORESETGroupIndex is configured (and therefore, different TRPs in a single-DCI based multi-TRP system).

For example, the serving cell PCI with one or more active TCI states for PDCCH/PDSCH could be associated with ‘CORESETGroupIndex=0’, while the non-serving (or neighboring) cell PCI with one or more active TCI states for PDCCH/PDSCH could be associated with ‘CORESETGroupIndex=1’. For another example, the serving cell PCI with one or more active TCI states for PDCCH/PDSCH could be associated with ‘CORESETGroupIndex=1’, while the non-serving (or neighboring) cell with one or more active TCI states for PDCCH/PDSCH could be associated with ‘CORESETGroupIndex=0’.

Or equivalently, when/if the UE is configured with PDCCH-Config that contains two different CORESETGroupIndex values in CORESET, different PCIs could be associated with different CORESETGroupIndex values, and therefore, the CORESETs corresponding to different CORESETGroupIndex values via the active TCI states of the CORESETs. That is, CORESETs corresponding to one CORESETGroupIndex value (e.g., ‘CORESETGroupIndex=0’) could be associated with a first PCI (e.g., the serving cell PCI), and CORESETs corresponding to another CORESETGroupIndex value (e.g., ‘CORESETGroupIndex=1’) could be associated with a second PCI (e.g., the non-serving cell PCI).

Furthermore, when/if the UE is configured with PDCCH-Config that contains two different CORESETGroupIndex values in CORESET, and if the UE receives from the network a MAC CE activation command—e.g., for CORESET(s) associated with each CORESETGroupIndex (as described in clause 6.1.3.14 of TS 38.321) used to map up to 8 TCI states to the codepoints of the DCI field “Transmission Configuration Indication”, the activated TCI states corresponding to one CORESETGroupIndex value (e.g., ‘CORESETGroupIndex=0’) could be associated with a first PCI (e.g., the serving cell PCI), and the activated TCI states corresponding to another CORESETGroupIndex value (e.g., ‘CORESETGroupIndex=1’) could be associated with a second PCI (e.g., the non-serving cell PCI).

Hence, throughout the present disclosure, discussions related to the serving cell PCI and non-serving cell PCI are also applicable or can be extended to different CORESETGroupIndex values (e.g., ‘0’ and ‘1’), and therefore, the corresponding TRPs in a single-DCI based multi-TRP system.

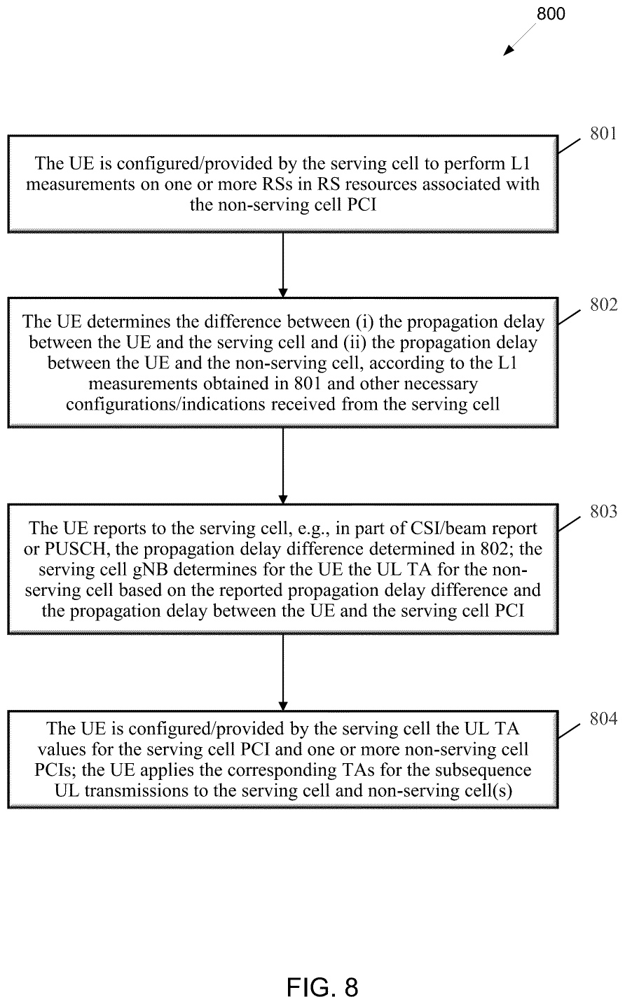

FIG. 8 illustrates a flowchart of a method 800 for acquiring UL TA for a non-serving cell PCI according to embodiments of the present disclosure. For example, the method 800 as may be performed by a UE (e.g., 111-116 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, a design example of acquiring the UL TA for the non-serving cell is presented. As can be seen from FIG. 8, the proposed strategy comprises of four key components. In the following, the basic design procedures for each of the four key components are first illustrated, followed by elaborated discussions on various design alternatives, detailed signaling/configuration mechanisms, and relevant measurement/reporting procedures.

As illustrated in FIG. 8, in step 801, the UE is configured by the serving cell to perform L1 measurements on one or more RSs transmitted from a non-serving cell. The non-serving cell RSs could correspond to SSBs, CSI-RSs, TRSs, PT RSs and etc., and the corresponding metrics could be L1-RSRPs, L1-SINRs, and etc. In one example, a non-serving cell RS resource could correspond to a SSB associated with the non-serving cell PCI. In another example, a non-serving cell RS resource could correspond to a CSI-RS resource configuration quasi co-located (QCL'ed) with a SSB associated with the non-serving cell PCI.

Certain non-serving cell information/identification needs to be incorporated/indicated in CSI resource setting provided by the higher layer parameter CSI-ResourceConfig including CSI-RS resource set provided by CSI-SSB-ResourceSet (for SSB resource set) or nzp-CSI-RS-ResourceSet (for NZP CSI-RS resource set), CSI reporting setting provided by the higher layer parameter CSI-ReportConfig, TCI state/QCL information provided by TCI-State/QCL-Info, and etc., configured for the serving cell so that the LIE could identify a RS in RS resource associated with a non-serving cell PCI, and conduct measurement on the corresponding non-serving cell RS.

For example, the UE could be configured with/provided by the network non-serving cell SSB information via the higher layer parameter AdditionalPCIInfo including frequency-domain information such as subcarrier spacing (SCS) and center frequency, time-domain information such as position of a SSB in a burst provided by ssb-PositionsInBurst and halfFrameIndex, transmission power, and etc. of a SSB associated with the non-serving cell PCI.

For another example, the UE could be configured with/provided by the network a SSB resource set (provided by the higher layer parameter CSI-SSB-ResourceSet) including one or more SSB indexes associated with a set of PCIs or PCI indexes pointing to PCIs in a list/set/pool of PCIs higher layer configured to the UE, respectively.

Yet for another example, the UE could be configured/provided by the network a TCI state (provided by the higher layer parameter TCI-State), wherein non-serving cell information, e.g., non-serving cell PCI or non-serving cell SSB information provided by AdditionalPCIInfo, or index of the non-serving cell information, is indicated/included.

In step 802, the UE estimates the propagation delay difference between the serving cell and the non-serving cell from the L1 measurements of/on the non-serving cell RSs (obtained in 601). The UE could be configured by the serving cell the exact starting symbol/slot of the non-serving cell RSs so that the UE could obtain accurate estimate of the propagation delay difference between the serving and non-serving cell PCIs. Furthermore, if the serving cell PCI and the non-serving cell PCI are not well synchronized, the UE could be indicated by the serving cell true timing drift/offset between the serving cell and the non-serving cell to compensate for the estimate of the propagation delay difference. The UE could also receive from the serving cell other necessary indications/configurations.

For example, the UE could be indicated/provided by the network, via CSI resource setting provided by the higher layer parameter CSI-ResourceConfig, the exact starting symbol/slot of the non-serving cell RSs for propagation delay difference measurement or the true timing drift/offset between the serving cell and the non-serving cell PCIs or other necessary indications/configurations.

For another example, the UE could be indicated/provided by the network, via CSI reporting setting provided by the higher layer parameter CSI-ReportConfig, the exact starting symbol/slot of the non-serving cell RSs for propagation delay difference measurement or the true timing drift/offset between the serving cell and the non-serving cell PCIs or other necessary indications/configurations.

Yet for another example, the UE could be indicated/provided by the network, via TCI state/QCL information provided by the higher layer parameter TCI-State/QCL-Info, the exact starting symbol/slot of the non-serving cell RSs for propagation delay difference measurement or the true timing drift/offset between the serving cell and the non-serving cell PCIs or other necessary indications/configurations.

In step 803, the UE could report to the serving cell the estimated propagation delay difference between the serving and non-serving cell PCIs determined in step 802. If the propagation delay difference is smaller than the CP length, the UE may not report to the serving cell the estimated propagation delay difference, or report to the serving cell that the estimated propagation delay difference is zero. The UE could report to the serving cell the estimated propagation delay difference in part of CSI/beam report or PUSCH. Upon receiving the propagation delay difference from the UE, the serving cell gNB could calculate for the UE the UL TA for the non-serving cell PCI. The calculation could be based on both the propagation delay difference and the propagation delay between the UE and the serving cell PCI. The propagation delay between the UE and the serving cell PCI is known to the serving cell gNB a priori.

In step 804, the UE is indicated/configured by the serving cell the UL TA for the non-serving cell through MAC CERACH response (RAR) or MAC CE signaling. That is, in addition to the UL TA for the serving cell PCI, the UE could be indicated/provided by the network UL TA(s) for non-serving cell PCI(s). For instance, the UE could be indicated/provided by the network, via one or more RARs or one or more MAC CEs, two TA values—one for the serving cell PCI and the other for the non-serving cell PCI. The UE could then apply the indicated/configured TAs for the subsequent UL transmissions to the serving cell and non-serving cell PCIs, respectively. As illustrated in step 803, under certain settings, the UE may not need to report the propagation delay difference to the serving cell as the propagation delay difference could be negligible, e.g., much smaller than the CP length. In this case, the UE could use the same TA for the serving cell as the TA for the non-serving cell, and apply it for the subsequent UL transmissions to the non-serving cell.

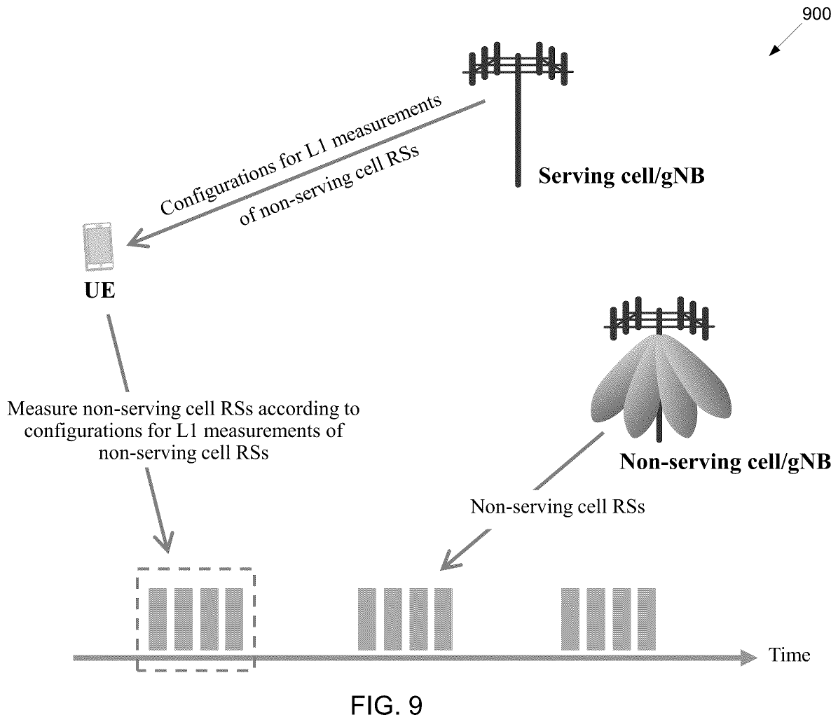

FIG. 9 illustrates an example of serving cell configuring non-serving cell RS resources and UE measuring the non-serving cell RSs 900 according to embodiments of the present disclosure. An embodiment of the serving cell configuring non-serving cell RS resources and the UE measuring the non-serving cell RSs 900 shown in FIG. 9 is for illustration only.

In FIG. 9, a conceptual example of UE measuring the non-serving cell RSs is presented. As illustrated in FIG. 9, the UE is first indicated/provided by the serving cell all necessary configurations for performing the L1 measurements on the non-serving cell RSs. For instance, if the non-serving cell RSs are SSBs, the UE could be first indicated/provided by the serving cell the SSB frequency, SSB periodicity, SSB burst pattern, SSB position in a burst, SSB transmission power, SSB subcarrier spacing (SCS), half frame index, PCI information and etc. of the non-serving cell (also referred to as non-serving cell SSB information provided by the higher layer parameter AdditionalPCIInfo).

To perform the actual L1 measurements on the non-serving cell SSBs, the UE could be then indicated/provided by the serving cell via CSI-ResourceConfig, CSI-SSB-ResourceSet, nzp-CSI-RS-ResourceSet, CSI-ReportConfig or TCI-State/QCL-Info, the exact SSBs (e.g., the SSB indexes) to measure for the non-serving cell PCI, and the association between the indicated CSI-ResourceConfig, CSI-SSB-ResourceSet, nzp-CSI-RS-ResourceSet, CSI-ReportConfig or TCI-State/QCL-Info with the non-serving cell SSB information. For another example, if the non-serving cell RSs are CSI-RSs, the UE could be first indicated by the serving cell the corresponding CSI-RS SCS, CSI-RS sequence generation configuration, PCI information and etc. of the non-serving cell (also referred to as non-serving cell CSI-RS information).

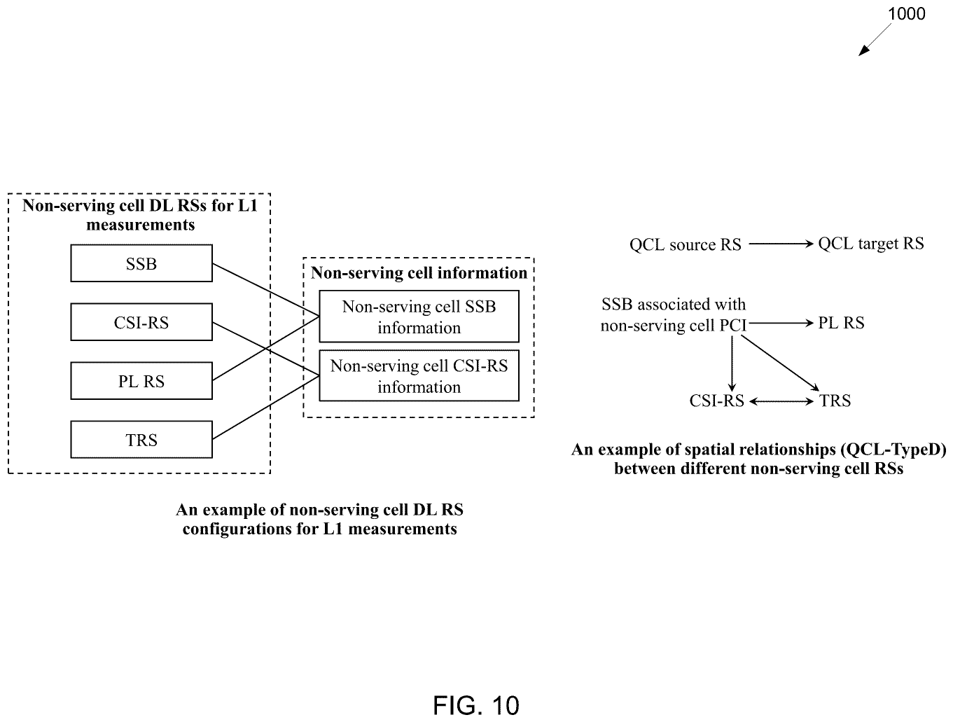

To perform the actual L1 measurements on the non-serving cell CSI-RSs, the UE could then be indicated by the serving cell via CSI-ResourceConfig or nzp-CSI-RS-ResourceSet the exact time, frequency and spatial domain behaviors of the CSI-RSs to measure for the non-serving cell PCI, and the association between the indicated CSI-ResourceConfig or nzp-CSI-RS-ResourceSet with the non-serving cell CSI-RS information. In addition, the UE could be indicated/provided by the network, via TCI-State/QCL-Info, the QCL source RSs (e.g., SSBs/SSB indexes associated with the non-serving cell PCI(s)) for the CSI-RS resource configurations. The UE could also be configured by the serving cell to perform L1 measurements on tracking RS (TRS) or path-loss RS (PL RS) from the non-serving cell PCI. If the UE is configured by the serving cell to measure the TRS from the non-serving cell, the UE would associate the TRS with the non-serving cell CSI-RS information. Similarly, if the UE is configured by the serving cell to measure the PL RS from the non-serving cell, the UE would associate the PL RS with the non-serving cell SSB information. The above described DL RS configurations for the non-serving cell are presented in FIG. 10.

FIG. 10 illustrates an example of DL RS configurations and QCL relations for the non-serving cell PCI 1000 according to embodiments of the present disclosure. An embodiment of the DL RS configurations and QCL relations for the non-serving cell PCI 1000 shown in FIG. 10 is for illustration only.

Furthermore, the UE could also be configured by the serving cell the spatial QCL-TypeD relationships between different DL RSs from the non-serving cell. For instance, following the spatial relationship illustrated on the right-hand-side (RHS) in FIG. 10, the UE could employ the same receive spatial filter as that used for receiving the QCL source SSB from the non-serving cell (indicated in TCI-State/QCL-Info) to receive/measure the TRS from the non-serving cell, and compute the corresponding L1 metric(s) such as L1-RSRP and/or L1-SINR.

In addition to obtaining the L1 metric(s), the UE could also use the non-serving cell RSs to estimate propagation delay difference (denoted by delta_d) between (i) the propagation delay between the UE and the serving cell (denoted by d0) and (ii) the propagation delay between the UE and the non-serving cell (denoted by d1). In the present disclosure, the propagation delay difference is computed as delta_d=d1−d0|.

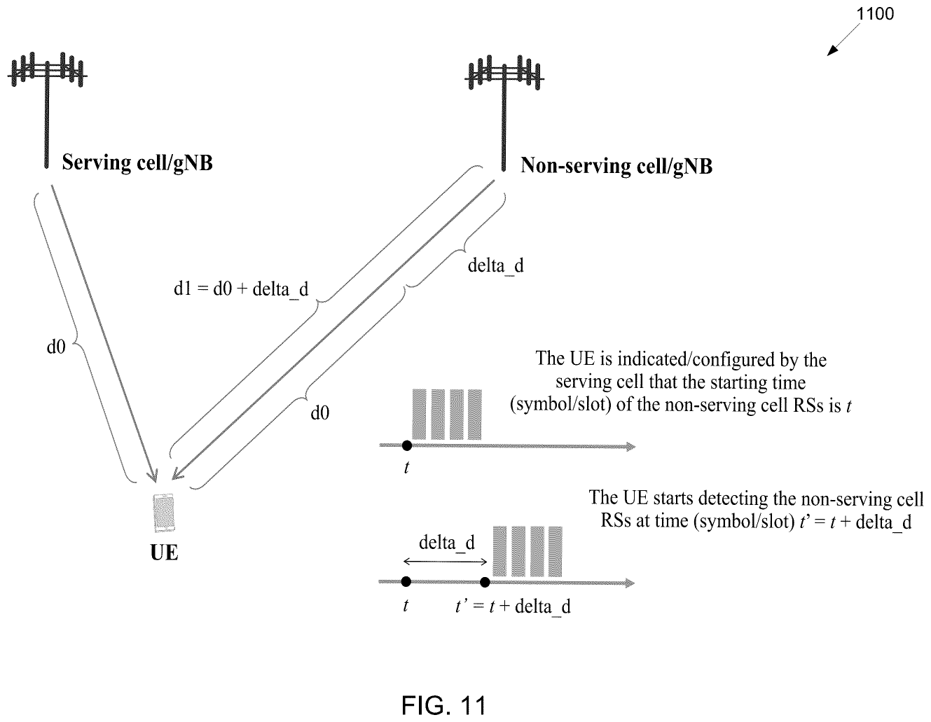

FIG. 11 illustrates an example of the propagation delay difference 1100 between the serving cell and the non-serving cell according to embodiments of the present disclosure. An embodiment of the propagation delay difference 1100 shown in FIG. 11 is for illustration only.

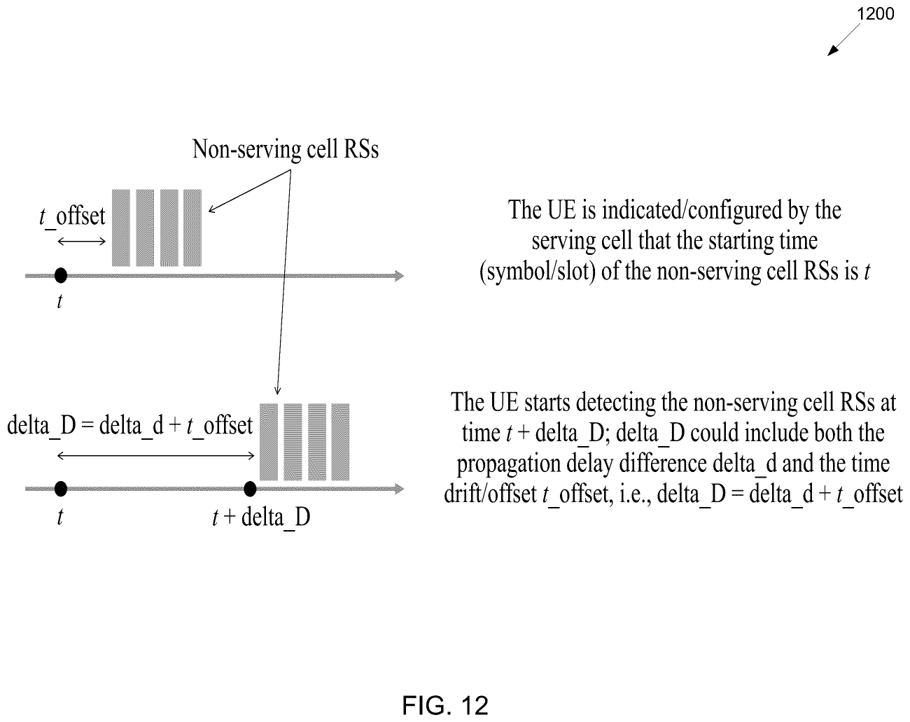

FIG. 12 illustrates an example of asynchronous reception 1200 according to embodiments of the present disclosure. An embodiment of the asynchronous reception 1200 shown in FIG. 12 is for illustration only.

In FIG. 11, a conceptual example characterizing the propagation delay difference between the serving cell and the non-serving cell is provided. In this example, the propagation delay d1 between the UE and the non-serving cell is larger than the propagation delay d0 between the UE and the serving cell by delta_d, i.e., d1=d0+delta_d. The UE is indicated/configured by the serving cell to measure the non-serving cell RSs, and generate the corresponding L1 metric(s). As illustrated in FIG. 11, the UE could be further indicated/configured by the serving cell the starting time (denoted by t), e.g., the starting symbol/slot/etc. of the non-serving cell RSs to measure. If the serving cell and the non-serving cell are synchronized and their propagation delays between the UE are identical (e.g., d1=d0), the UE would start detecting the non-serving cell RSs exactly at the indicated time t. Due to the propagation delay difference between the serving cell and the non-serving cell shown in FIG. 11, however, the UE would start detecting the non-serving cell RSs at time t′ (t′>t), and the UE could calculate the propagation delay difference as delta_d=t′−t.

If the serving cell and the non-serving cell are not synchronized, the UE could start detecting the non-serving cell RSs at t′=t+delta_D, where delta_D could comprise of both the propagation delay difference and true time drift/offset between the serving cell PCI and the non-serving cell PCI. One conceptual example characterizing the unsynchronized setup is given in FIG. 12, in which the actual timing of the non-serving cell PCI happens t_offset later than that of the serving cell PCI. Hence, delta_D=delta_d+t_offset.

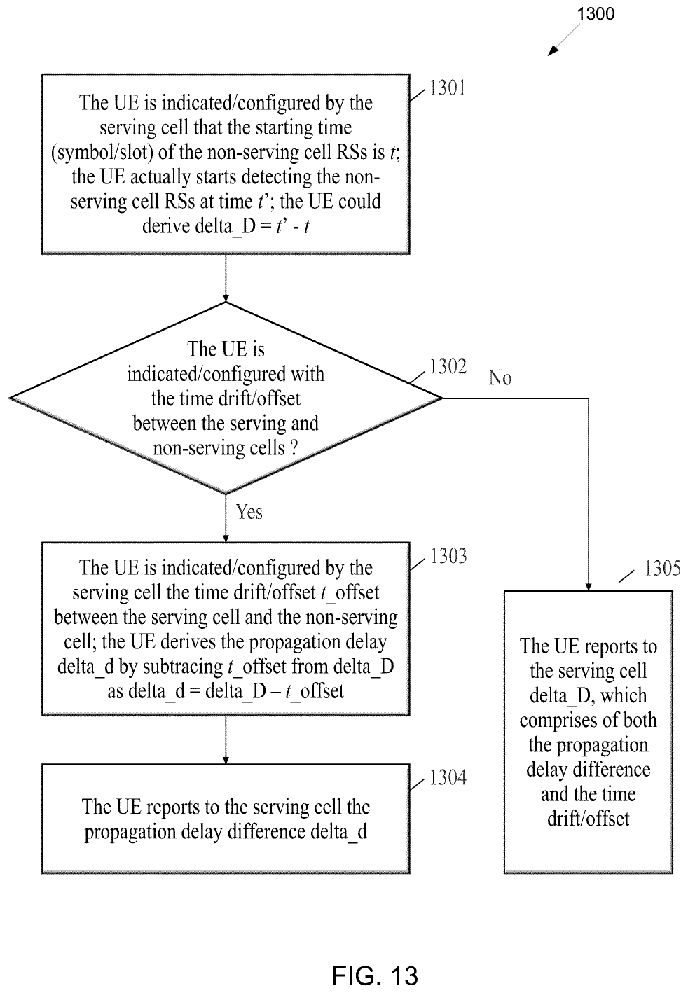

FIG. 13 illustrates a flowchart of a method 1300 for acquiring propagation delay difference in an inter-cell system according to embodiments of the present disclosure. For example, the method 1300 as may be performed by a UE (e.g., 111-116 as illustrated in FIG. 1). An embodiment of the method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

As illustrated in FIG. 13, in step 1301, the UE is indicated/configured by the serving cell that the starting time (symbol/slot) of the non-serving cell RSs is t; the UE actually starts detecting the non-serving cell RSs at time t′; the UE could derive delta_D=t′−t. In step 1302, the UE determines whether the UE is indicated/configured with the time drift/offset between the serving and non-serving cells. In step 1303, the UE is indicated/configured by the serving cell the time drift/offset t_offset between the serving cell and the non-serving cell; the UE derives the propagation delay delta_d by subtracing t_offset from delta_D as delta_d=delta_D−t_offset. In step 1304, the UE reports to the serving cell the propagation delay difference delta_d. In step 1305, the UE reports to the serving cell delta_D, which comprises of both the propagation delay difference and the time drift/offset.

More specifically, for steps 1303 and 1304 in FIG. 13, the UE could be indicated by the serving cell the true time drift/offset between the serving cell and the non-serving cell, and the UE could compute the propagation delay difference by accounting for the true time drift/offset. Note that the serving cell could decide whether to indicate to the UE the time drift/offset between the serving cell PCI and the non-serving cell PCI. For instance, as illustrated from 1305 in FIG. 13, the UE may not be indicated by the serving cell the true time drift/offset t_offset. In this case, the UE could only report to the serving cell delta_D, and the serving cell would derive the propagation delay difference by subtracting the true time drift/offset, i.e., delta_d=delta_D−t_offset.

The time drift/offset between the serving cell PCI and the non-serving cell PCI could change over time due to various hardware impairments, temperature change and etc. The UE could be indicated by the serving cell a new time drift/offset value as long as the variation of the time drift/offset is beyond a certain threshold. Alternatively, the UE could be indicated by the serving cell a differential delay value to characterize the variation of the time drift/offset over time. In the following, two design options are discussed.

In one example of Option-1, the UE is indicated by the serving cell the difference (denoted by delta_offset) between the new true time drift/offset t_offset_1 and the old (previous) true time drift/offset t_offset_0 via higher layer RRC signaling, MAC CE command, or DCI based signaling. As delta_offset=t_offset_1−t_offset_0, upon receiving the time drift/offset difference, the UE could calculate the new true time drift/offset value as t_offset_1=delta_offset+t_offset_0, and apply it to derive the propagation delay difference as delta_d=delta_D_0−t_offset_1=delta_D_0−t_offset_0−delta_offset. The UE could be indicated by the serving cell the explicit value of delta_offset, or |delta_offset| with a 1-bit sign indicator (+ve or −ve) because delta_offset could be either positive or negative. This indication could be in CSI resource setting (via CSI-ResourceConfig), CSI-RS resource set (SSB resource set via CSI-SSB-ResourceSet or NZP CSI-RS resource set via nzp-CSI-RS-ResourceSet), CSI reporting setting (via CSI-ReportConfig) or TCI state/QCL information indication (via TCI-State/QCL-Info).

In one example of Option-2, the UE is indicated by the serving cell that the starting time (e.g., starting symbol/slot) of the non-serving cell RSs is offset by delta_offset via higher layer RRC signaling, MAC CE command, or DCI based signaling. Hence, upon detecting the non-serving cell RSs, the UE could obtain the receive timing difference as delta_D_1=t′−t_1=t′−(t_0+delta_offset), where t_0 denotes the previous starting time of the non-serving cell RSs and t_1 represents the updated/offset starting time of the non-serving cell RSs. The UE could then compute the propagation delay difference as delta_d=delta_D_1−t_offset_0=t′−t_0−delta_offset−t_offset_0=delta_D_0−t_offset_0−delta_offset, which is the same as that derived from Option-1. Similar to Option-1, the UE could be indicated by the serving cell the explicit value of delta_offset, or |delta_offset| with a 1-bit sign indicator (+ve or −ve) because delta_offset could be either positive or negative. This indication could be in CSI resource setting (via CSI-ResourceConfig), CSI-RS resource set (SSB resource set via CSI-SSB-ResourceSet or NZP CSI-RS resource set via nzp-CSI-RS-ResourceSet), CSI reporting setting (via CSI-ReportConfig) or TCI state/QCL information indication (via TCI-State/QCL-Info).

Furthermore, depending on the exact values of delta_d (e.g., positive or negative) and/or the true time drift/offset between the serving and the non-serving cell PCIs, the receive timing difference delta_D and the propagation delay difference delta_d could be either positive or negative. The UE could explicitly report to the serving cell the “exact” value of delta_D or delta_d. For example, the “exact” value of delta_D or delta_d could be chosen from a predefined codebook/set containing both positive and negative discrete numbers/values. Alternatively, the UE could report to the network the absolute values of delta_D and delta_d, i.e., |delta_D| and |delta_d|, along with their 1-bit sign indicators (either +ve or −ve). Note that |delta_D| or |delta_d| could also be chosen from a predefined codebook/set containing only positive discrete numbers/values.

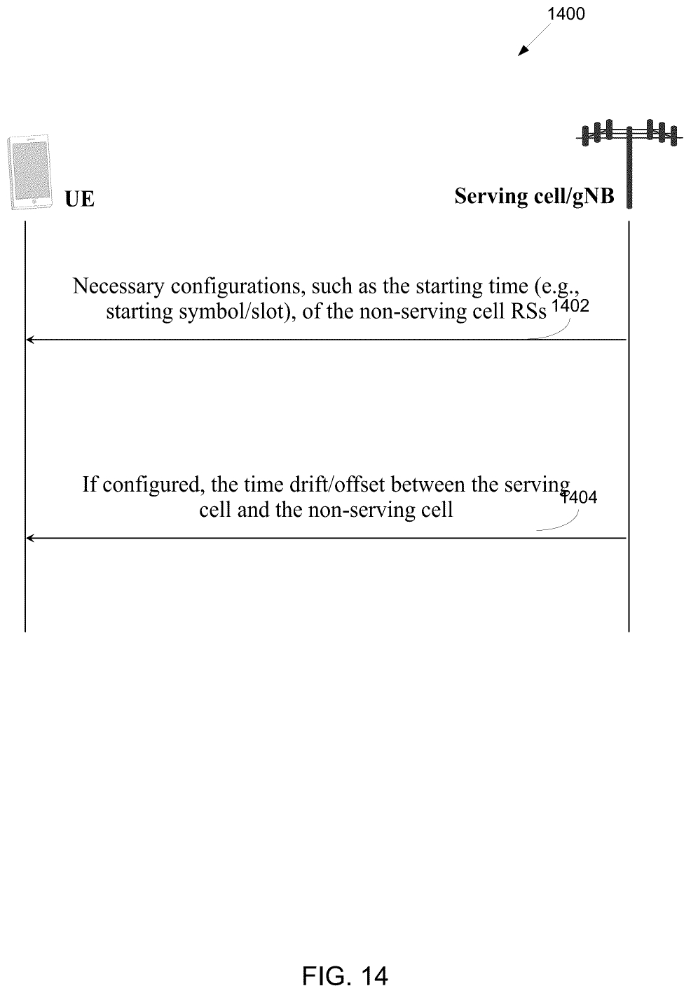

FIG. 14 illustrates an example of signaling flow 1400 for indicating necessary configurations required for acquiring propagation delay difference in an inter-cell system according to embodiments of the present disclosure. For example, the signaling flow 1400 as may be performed by a UE (e.g., 111-116 as illustrated in FIG. 1) and a BS (e.g., 11-103 as illustrated in FIG. 1). An embodiment of the signaling flow 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

In FIG. 14, necessary DL signaling (from the serving cell/gNB to the UE) required to enable the UL TA acquisition for the non-serving cell is provided. The UE could be first indicated by the serving cell/gNB necessary configurations/information of the non-serving cell RSs. The configurations could be in addition to those in the existing RRC parameters. For instance, the information of the starting time, such as the starting symbol/slot, of the non-serving cell RSs could be added/incorporated in the existing RRC configurations/parameters such as CSI-MeasConfig/CSI-ResourceConfig/CSI-SSB-ResourceSet/nzp-CSI-RS-ResourceSet/CSI-ReportConfig/TCI-State/QCL-Info, or in new RRC configurations/parameters such as non-serving cell SSB information/non-serving cell CSI-RS information (e.g., provided by AdditionalPCIInfo) defined in FIG. 9 and FIG. 10.

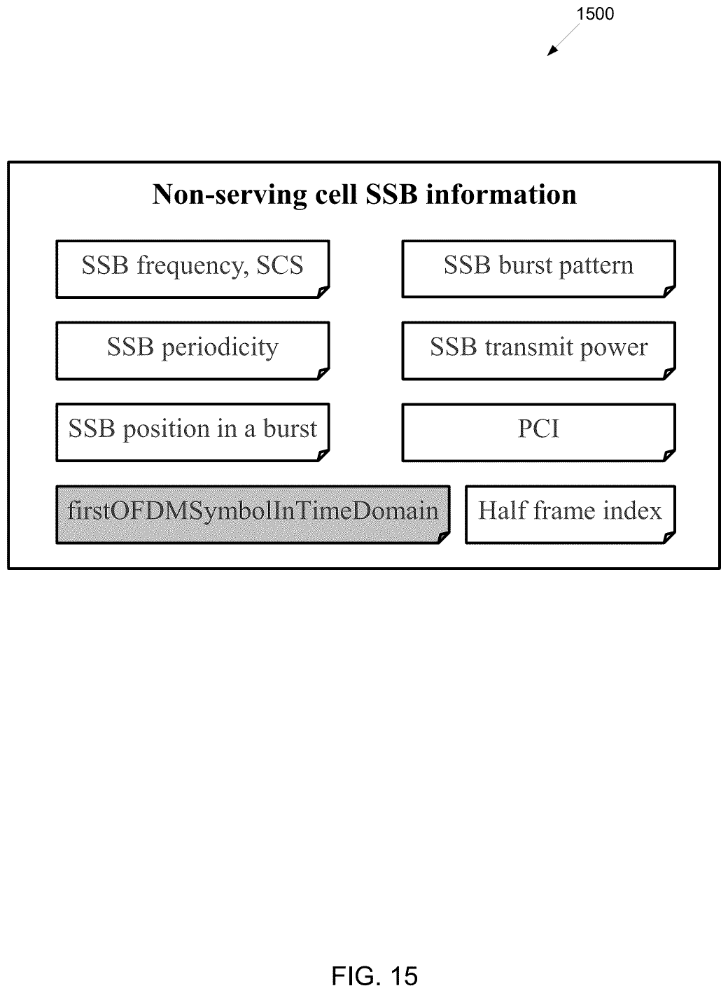

FIG. 15 illustrates an example of a RRC parameter indicating non-serving cell SSB information 1500 according to embodiments of the present disclosure. An embodiment of the RRC parameter indicating the non-serving cell SSB information 1500 shown in FIG. 15 is for illustration only.

In FIG. 15, an illustrative example of non-serving cell SSB information containing firstOFDMSymbolInTimeDomain as the starting symbol information of the non-serving cell SSBs is presented. Furthermore, as indicated in FIG. 14 and also in FIG. 13, whether the UE would be indicated/configured with the true time drift/offset between the serving cell PCI and the non-serving cell PCI is configurable, and determined by the network (or the serving cell).

For example, the UE could be explicitly indicated by the serving cell the true time drift/offset as long as the time drift/offset is greater than zero. For another example, the UE may not be indicated by the serving cell any valid time drift/offset if the serving cell and the non-serving cell are perfectly synchronized or the true time drift/offset is below a predefined threshold, e.g., the CP length. For this case, the UE could be indicated/configured by the serving cell that “the true time drift/offset=0” (e.g., a RRC parameter characterizing the time drift/offset is set/configured as zero) and/or “the serving cell and the non-serving cell are synchronized” (e.g., using a flag indicator to characterize the synchronization status: “1”—synchronized, “0”—unsynchronized).

After obtaining the receive timing difference (e.g., delta_D in FIG. 12), the UE could report it to the serving cell/gNB. As illustrated in FIG. 12, FIG. 13 and FIG. 14 in the present disclosure, the receive timing difference could correspond to only the propagation delay difference for synchronized serving and non-serving cells, or comprise of both the propagation delay difference and the true time drift/offset if the serving cell PCI and the non-serving cell PCI are not (perfectly/well) synchronized.

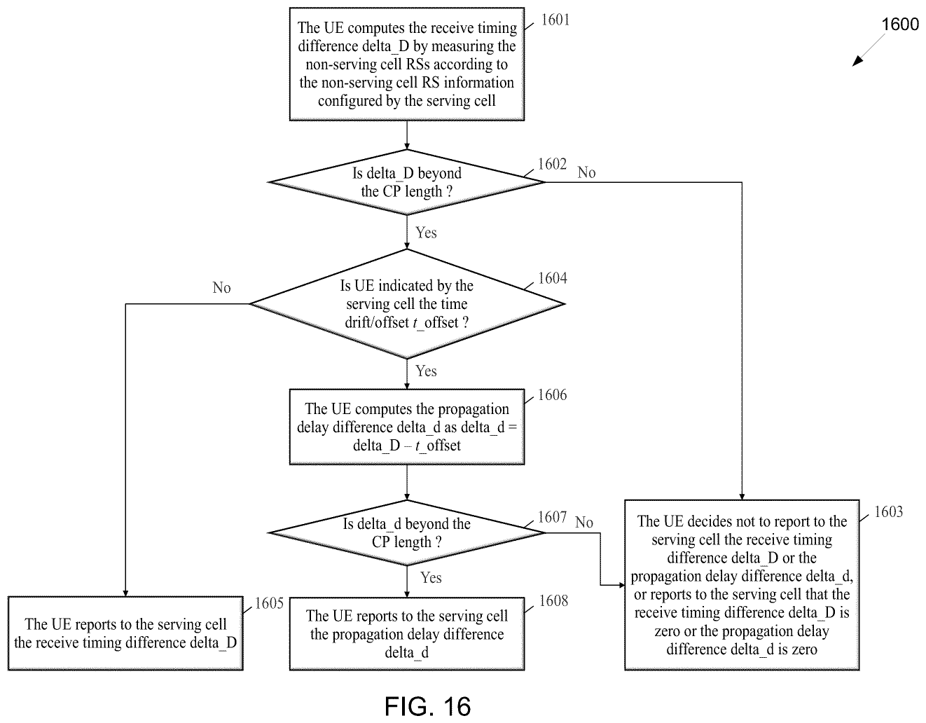

FIG. 16 illustrates a flowchart of a method 1600 for reporting to the serving cell the receive timing difference according to embodiments of the present disclosure. For example, the method 1600 as may be performed by a UE (e.g., 111-116 as illustrated in FIG. 1). An embodiment of the method 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

In FIG. 16, an algorithm procedure characterizing how/when the UE would report to the serving cell the receive timing difference is presented. As illustrated in FIG. 16, in step 1601, the UE calculates the receive timing difference delta_D. As discussed in FIG. 11, FIG. 12 and FIG. 13, to obtain the receive timing difference, the UE needs to be indicated/provided by the serving cell the exact starting time (e.g., the starting symbol/slot) of the corresponding non-serving cell RSs. Depending on whether the serving cell and the non-serving cell are synchronized, the receive timing difference delta_D could comprise of both the propagation delay difference and the time drift/offset between the serving cell and the non-serving cell.

In step 1602, the UE compares the receive timing difference delta_D with the CP length. If the receive timing difference is smaller than the CP length, the algorithm would proceed to 1603. Otherwise, if the receive timing difference is beyond the CP length, the algorithm would proceed to 1604. In addition to directly comparing the receive timing difference with the CP length, the UE could also compute how much the receive timing difference is beyond the CP length, and then decide the following steps. For instance, the UE could be first indicated/configured by the serving cell a predetermined threshold Th_CP. If the receive timing difference is larger than the CP length by Th_CP, the algorithm would proceed to 1604. Otherwise, the algorithm would proceed to 1603.

In step 1603, the UE could decide not to report to the serving cell the receive timing difference, or report to the serving cell that the receive timing difference is zero, because it is smaller than the CP length. Regardless whether the serving cell and the non-serving cell are synchronized (i.e., whether the receive timing difference includes the time drift/offset between the serving and non-serving cells), the UE could interpret from the comparison result (delta_D<CP) that the propagation delay difference is negligible, and the UE would use the same TA for the serving cell as the TA for the non-serving cell.

In step 1604, the UE would check whether they have received from the serving cell a valid time drift/offset (e.g., greater than zero) between the serving and non-serving cells. If the UE does not receive any time drift/offset from the serving cell, the algorithm would proceed to 1605. Otherwise, the algorithm would proceed to 1606.

In step 1605, the UE could report to the serving cell the receive timing difference delta_D determined in 1601 without any further processing. Here, the UE could not derive the propagation delay difference delta_d from the receive timing difference delta_D because the UE does not receive from the serving cell anything related to the synchronization status/condition between the serving cell and the non-serving cell.

In step 1606, the UE computes the propagation delay difference delta_d by subtracting the time drift/offset t_offset from the receive timing difference delta_D, i.e., delta_d=delta_D−t_offset. If the indicated t_offset=0, implying that the serving cell and the non-serving cell are synchronized, delta_d=delta_D.

In step 1607, the UE compares the calculated propagation delay difference delta_d with the CP length. If the propagation delay difference is smaller than the CP length, the algorithm would proceed to 1603. Otherwise, if the propagation delay difference is beyond the CP length, the algorithm would proceed to 1608.

In addition to directly comparing the propagation delay difference with the CP length, the UE could also compute how much the propagation delay difference is beyond the CP length, and then decide the following procedures. For instance, the UE could be first indicated/configured by the serving cell the predetermined threshold Th_CP. If the propagation delay difference delta_d is larger than the CP length by Th_CP, the algorithm would proceed to 1608. Otherwise, the algorithm would go back to 1603. In step 1608, the UE could report to the serving cell the propagation delay difference delta_d determined in 1606.

For step 1605 (1608) in FIG. 16, instead of directly reporting delta_D (delta_d), the UE could report the difference between delta_D (delta_d) and the CP length. Denoting the CP length by L_CP, the differential reports could be expressed as delta_D′=delta_D−L_CP and delta_d′=delta_d−L_CP. There could be other design alternatives to that shown in FIG. 16. For example, a special case of the algorithm procedure shown in FIG. 16 is to omit the comparisons with the CP length in 1602 and 1607.

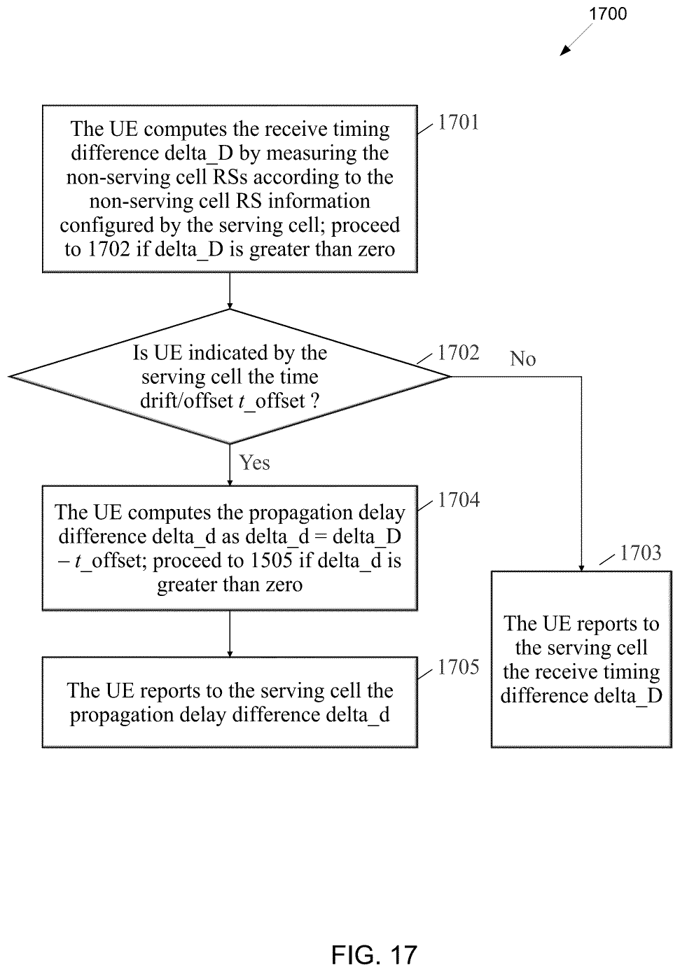

In this case (depicted in FIG. 17 in the present disclosure), the UE would report to the serving cell as long as delta_D or delta_d is greater than zero. For another example, the UE could first check whether they have received from the serving cell the time drift/offset between the serving and non-serving cells. The UE could then check whether delta_D/delta_d is beyond the CP length and/or how much delta_D/delta_d is beyond the CP length.

FIG. 17 illustrates a flowchart of another method 1700 for reporting to the serving cell the receive timing difference according to embodiments of the present disclosure. For example, the method 1700 as may be performed by a UE (e.g., 111-116 as illustrated in FIG. 1). An embodiment of the method 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

As illustrated in FIG. 17, in step 1701, the UE computes the receive timing difference delta_D by measuring the non-serving cell RSs according to the non-serving cell RS information configured by the serving cell; proceed to 1702 if delta_D is greater than zero. In step 1702, the UE determines whether the UE is indicated by the serving cell the time drift/offset t_offset. In step 1703, the UE reports to the serving cell the receive timing difference delta_D. In step 1704, the UE computes the propagation delay difference delta_d as delta_d=delta_D−t_offset; proceed to 1505 if delta_d is greater than zero. In step 1705, the UE reports to the serving cell the propagation delay difference delta_d.

In the present disclosure, a report quantity timing difference (TD) could correspond to at least one of: (1) the receive timing difference delta_D, (2) the propagation delay difference delta_d, and (3) their differences with the CP length delta_D′/delta_d′. The TD, can be transmitted, for example, as part of the CSI report (hence multiplexed with other CSI parameters), and/or by multiplexing it with HARQ-ACK transmission and/or Scheduling Request (SR). In one example, the TD can be transmitted via SR if it's payload (number of bits) is less or equal to B1 (e.g. B1=1). In one example, the TD can be transmitted via HARQ-ACK if it's payload (number of bits) is less or equal to B1 (e.g. B1=1). In one example, the TD can be transmitted via SR or HARQ-ACK if the number of TRPs=2 (i.e. number of TD is 1).

When multiplexed with other CSI parameters, at least one of the following examples can be used.

In one example, the TD is via a separate (new) CSI parameter, e.g., TDI (TD indicator).

In one example, the TD is joint with an existing CSI parameter (p), and the parameter (p) when reported indicates both a value for the CSI existing parameter and the TD. At least one of the following examples can be used for the existing CSI parameter (p).

In one example, the parameter (p) is a rank indicator (RI). When reported, RI indicates both a value for the rank and the TD.

In one example, the parameter (p) is a CSI-RS resource indicator (CRI). When reported, CRI indicates both a CSI-RS resource and the TD.

In one example, the parameter (p) is a layer indicator (LI). When reported, LI indicates both a layer and the TD.

In one example, the parameter (p) is a precoding matrix indicator (PMI) for a 2 port CSI-RS resource. When reported, PMI indicates both a precoding matrix and the TD.

In one example, the parameter (p) is a first precoding matrix indicator (PMI1) for a X>2 port CSI-RS resource. When reported, PMI1 indicates both first components of a precoding matrix and the TD.

In one example, the parameter (p) is a second precoding matrix indicator (PMI2) for a X>2 port CSI-RS resource. When reported, PMI2 indicates both second components of a precoding matrix and the TD.

In one example, the parameter (p) is a channel quality indicator (CQI). When reported, CQI indicates both a CQI value and the TD.

In one example, the parameter (p) is a layer 1 RSRP (L1-RSRP). When reported, L1-RSRP indicates both a RSRP value and the TD.

In one example, the parameter (p) is a layer 1 SINR (L1-SINR). When reported, L1-SINR indicates both a SINR value and the TD.

In one example, the TD is using reserved or unused code points of an existing CSI parameter (p) to indicate the TD. At least one of the following examples can be used for the existing CSI parameter (p): (1) the parameter (p) is a rank indicator (RI); (2) the parameter (p) is a CSI-RS resource indicator (CRI); (3) the parameter (p) is a layer indicator (LI); (4) the parameter (p) is a precoding matrix indicator (PMI) for a 2 port CSI-RS resource; (5) the parameter (p) is a first precoding matrix indicator (PMI1) for a X>2 port CSI-RS resource; (6) the parameter (p) is a second precoding matrix indicator (PMI2) for a X>2 port CSI-RS resource; (7) the parameter (p) is a channel quality indicator (CQI); and/or (8) the parameter (p) is a layer 1 RSRP (L1-RSRP).

In one example, the parameter (p) is a layer 1 SINR (L1-SINR). In one example, the usage of an existing CSI parameter (p) can be configured (e.g., RRC) as either as a CSI parameter or as a parameter for the TD. A code point of the parameter (p) indicates the CSI parameter of the TD depending on the configured usage.

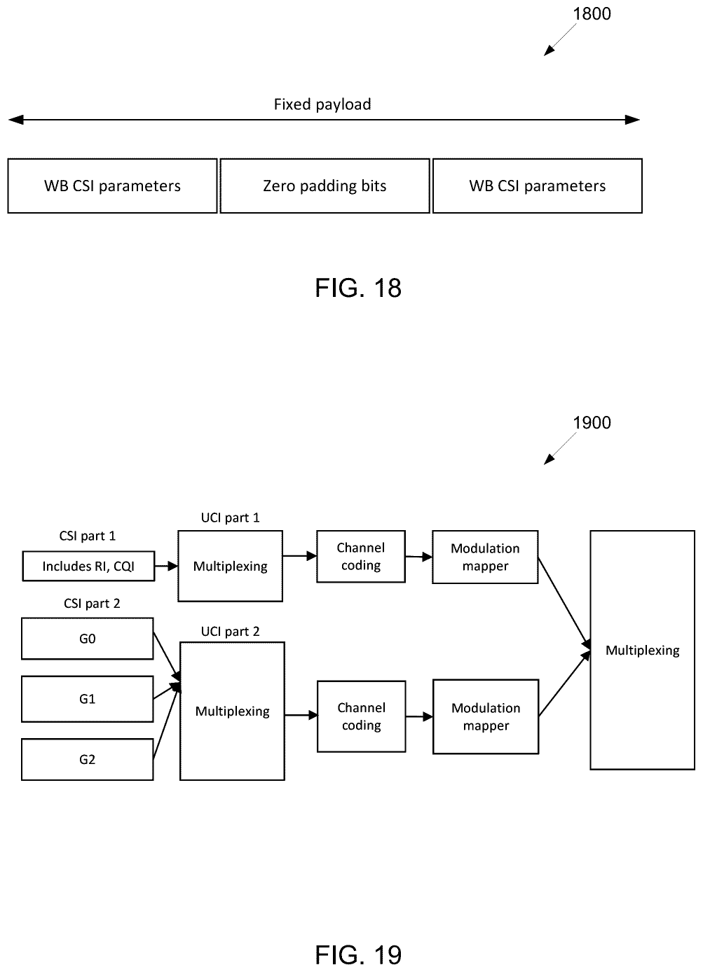

The TD can be multiplexed with a periodic or semi-persistent (P/SP) CSI with wideband (WB) reporting. For such WB CSI reporting, the CSI payload (number of bits) can be fixed regardless of the value of the reported CSI parameters such as RI (although the CSI payload can vary for different rank values). In order to ensure fixed CSI payload, a number of zero-padding bits can be appended with the CSI bits (as illustrated in FIG. 18). At least one of the following examples can be used for multiplexing the TD with the WB CSI.

In one example, a portion or all of the zero padding bits appended in the WB CSI report is used to report the TD. The least significant bits (LSBs) of the zero padding bits can be used for the TD. Or the most significant bits (MSBs) of the zero padding bits can be used for the TD. In one example, the TD is multiplexed with the WB CSI parameters, wherein the multiplexing method is according to one of the examples described above.

FIG. 18 illustrates an example of CSI payload 1800 according to embodiments of the present disclosure. An embodiment of the CSI payload 1800 shown in FIG. 18 is for illustration only.

FIG. 19 illustrates an example of two-part CSI 1900 according to embodiments of the present disclosure. An embodiment of the two-part CSI 1900 shown in FIG. 19 is for illustration only.

The TD can be multiplexed with an aperiodic (AP) CSI with subband (SB) reporting. For such SB reporting, the CSI can be partitioned into two parts, CSI part 1 and CSI part 2. The CSI part 1 includes RI and CQI (for the first codeword), and is multiplexed with UCI part 1. The CSI report includes LI, PMI, and CQI (for the second codeword when rank >4 is reported), and is multiplexed with UCI part 2. Here, UCI part 1 and UCI part 2 are parts of a two-part UCI (as illustrated in FIG. 19). At least one of the following examples can be used for multiplexing the TD with the SB CSI.

In one example, the TD is multiplexed with a CSI parameter in CSI part 1. For example, the TD is multiplexed with CQI (for the first code word) or RI, wherein the multiplexing method is according to one of the examples described above.

In one example, the TD is multiplexed with a CSI parameter in CSI part 2. For example, the TD is multiplexed with CQI (for the second code word when rank >4 is reported) or PMI or LI, wherein the multiplexing method is according to one of the examples described above.

In one example, the CSI part 2 is partitioned into three groups G0, G1, and G2 (as in Rel. 15/16 SB CSI reporting) and the UE reports either G0 or (G0, G1) or (G0, G1, G2) depending on the resource allocation for the CSI reporting and the total CSI part 2 payload (as described in UCI omission in Rel. 15/16 NR specification).

In one example, the TD is multiplexed with a CSI parameter in G0, wherein the multiplexing method is according to one of the examples described above.

In one example, the TD is multiplexed with a CSI parameter in G0 if only G0 is transmitted (reported) in UCI part 2 (i.e., G1 and G2 are omitted or not reported); the TD is multiplexed with a CSI parameter in G1 if only (G0, G1) is transmitted (reported) in UCI part 2 (i.e., G2 is omitted or not reported); and the TD is multiplexed with a CSI parameter in G2 if (G0, G1, G2) is transmitted (reported) in UCI part 2.

The bit-width (payload) B and codebook (CB) for the TD can be according to one of the following examples.

In one example, B=1 bit and the CB is one of the two examples shown in TABLE 1. In one instance, T is a threshold value, which can be fixed (e.g., T=CP) or configured (e.g., via RRC). In one instance, T1 and T2 are two values such that either T1<T2 (e.g., T1=2CP, T2=4CP) or T1>T2 (e.g., T1=4CP, T2=2CP).

In one example, B=2 bits and the CB is one of the two examples shown in TABLE 2. In one instance, T1, T2, and T3 are threshold values, which can be fixed (e.g., T=C T1=CP, T2=2CP, T3=3CP) or configured (e.g., via RRC). In one instance, T1, T2, T3, and T4 are four values such that either T1<T2<T3<T4 (e.g., T1=CP, T2=2CP, T3=3CP, T4=4CP) or T1>T2>T3>T4 (e.g., T1=4CP, T2=3CP, T3=2CP, T4=CP).

TABLE 1

| | TD value (X) | |
|---|---|---|
| Bit value | Example 1 | Example 2 |
| 0 | X <= T | T1 |
| 1 | T < X | T2 |

TABLE 2

| | TD value (x) | |
|---|---|---|
| Bit value | Example 1 | Example 2 |
| 00 | X <= T1 | T1 |
| 01 | T1 < X <= T2 | T2 |
| 10 | T2 < X <= T3 | T3 |
| 11 | T3 < X | T4 |

B can be fixed or configured (e.g., via RRC) or reported by the UE. Or CB can be fixed or configured (e.g., via RRC) or reported by the UE. Or B and CB can be fixed or configured (e.g., via RRC) or reported by the UE.

Whether the UE can report the TD can be configured, e.g., via higher layer RRC signaling. Also, whether a UE is capable of such reporting is indicated by the UE in the capability reporting and the configuration of the TD is subject to the reported UE capability.

The TD is subject to a restriction. For instance, at least one of the following examples is used as the restriction: (1) a measurement RS (e.g., CSI-RS) with only 1 port can be used/configured; (2) only periodic measurement RSs (such SSB, CSI-RS, TRS) can be used/configured; (3) only aperiodic measurement RSs (such CSI-RS) can be used/configured; (4) only semi-persistent measurement RSs (such CSI-RS) can be used/configured; (5) the TD can be multiplexed only with a WB CSI report, where the CSI report is periodic or semi-persistent; (6) the TD can be reported only via PUCCH; and/or (7) the TD can be reported only when rank 1 is reported via RI, but the max allowed rank value can be more than 1.

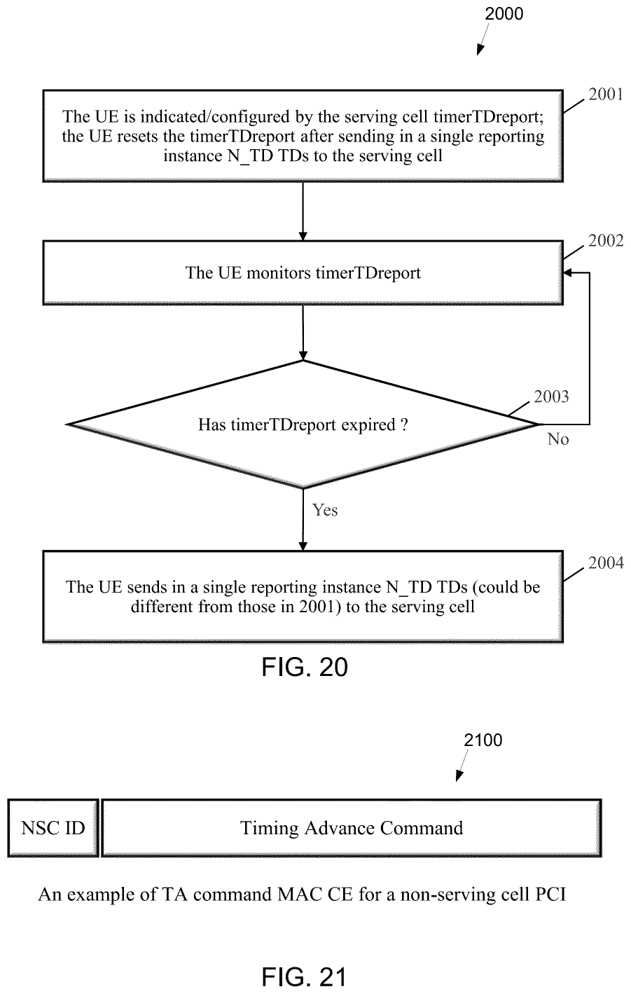

FIG. 20 illustrates a flowchart of a method 2000 for reporting to the serving cell the timing difference (TD) according to embodiments of the present disclosure. For example, the method 2000 as may be performed by a UE (e.g., 111-116 as illustrated in FIG. 1). An embodiment of the method 2000 shown in FIG. 20 is for illustration only. One or more of the components illustrated in FIG. 20 can be implemented in specialized circuitry configured to perform the noted functions or one or more of the components can be implemented by one or more processors executing instructions to perform the noted functions.

As illustrated in FIG. 20, in step 2001, the UE is indicated/configured by the serving cell timerTDreport; the UE resets the timerTDreport after sending in a single reporting instance N_TD TDs to the serving cell. In step 2002, the UE monitors timerTDreport. In step 2003, the UE determines whether timerTDreport has expired. In step 2004, the UE sends in a single reporting instance N_TD TDs (could be different from those in 2001) to the serving cell.

The UE could explicitly indicate to the serving cell whether the TD corresponds to the receive timing difference or the propagation delay difference. The serving cell could also know whether the TD corresponds to the receive timing difference or the propagation delay difference in an implicit manner such that as long as the serving cell has sent the true time drift/offset to the LIE, the corresponding TD should be the propagation delay difference. For the differential reports, the explicit indication from the UE is needed. Denote the number of TDs that could be sent in a single reporting instance by N_TD.

The UE could send to the serving cell a single TD (i.e., N_TD=1). The TD could correspond to the transmit beam from the non-serving cell (and therefore, the corresponding resource indicator such as SSBRI or CRI) with the highest L1 metric(s) such as L1-RSRP and/or L1-SINR. Furthermore, the UE could send to the serving cell multiple (i.e., N_TD>1) TDs, corresponding to the transmit beams from the non-serving cell that result in the highest L1-RSRPs and/or L1-SINRs.

The UE could also be configured by the serving cell a timer (denoted by timerTDreport) to track the frequency of the TD reporting. The UE could start/reset the timerTDreport as soon as the UE has sent to the serving cell a set of N_TD (≥1) TDs in a single reporting instance. The UE could send in a single reporting instance another set of N_TD (≥1) TDs to the serving cell only after the timerTDreport has expired. The above described procedure is characterized in FIG. 20.

Optionally, the UE could transmit to the network (e.g., to the serving cell) in Msg1 or MsgA of a random access procedure one or more PRACH preambles associated with one or more entity IDs, wherein each entity ID could correspond to a PCI, a PCI index pointing to a PCI in a list/set/pool of PCIs higher layer configured to the UE, a CORESETPoolIndex value, a CORESETGroupIndex value, a PCI indicator (e.g., a one-bit flag indicating either the serving cell PCI or the non-serving cell PCI or a multi-bit indicator with each state indicating a PCI), a UE panel ID, a SRSPoolIndex value, a SRS resource set index/ID, a SRS resource group index/ID or a SRS resource index/ID.

In the present disclosure, a SRS resource pool (provided by a SRSPoolIndex) could comprise one or more SRS resource sets, and a SRS resource set (provided by a SRS resource group index/ID) could comprise one or more SRS resource groups (provided by SRS resource group index(es)/ID(s)) each comprising one or more SRS resources (provided by SRS resource index(es)/ID(s)).

In one example, the UE could transmit in Msg1 or MsgA of a random access procedure, one or more PRACH preambles associated with the serving cell PCI, and one or more PRACH preambles associated with a non-serving cell PCI.

In another example, the UE could transmit in Msg1 or MsgA of a random access procedure, one or more PRACH preambles associated with the PCI index corresponding/pointing to the serving cell PCI in the list/set/pool of PCIs higher layer configured to the UE, and one or more PRACH preambles associated with the PCI index corresponding/pointing to a non-serving cell PCI in the list/set/pool of PCIs higher layer configured to the UE.

In yet another example, the UE could transmit in Msg1 or MsgA of a random access procedure, one or more PRACH preambles associated with value 0 of CORESETPoolIndex, and one or more PRACH preambles associated with value 1 of CORESETPoolIndex.

In yet another example, the UE could transmit in Msg1 or MsgA of a random access procedure, one or more PRACH preambles associated with value 0 of CORESETGroupIndex, and one or more PRACH preambles associated with value 1 of CORESETGroupIndex.

In yet another example, the UE could transmit in Msg1 or MsgA of a random access procedure, one or more PRACH preambles associated with the PCI indicator indicating the serving cell PCI, and one or more PRACH preambles associated with the PCI indicator indicating a non-serving cell PCI.

In yet another example, the UE could transmit in Msg1 or MsgA of a random access procedure, one or more PRACH preambles associated with a UE panel ID, which could be further associated with the serving cell PCI/value 0 of CORESETPoolIndex/value 0 of CORESETGroupIndex, and one or more PRACH preambles associated with another UE panel ID, which could be further associated with a non-serving cell PCI/value 1 of CORESETPoolIndex/value 1 of CORESETGroupIndex.

In yet another example, the UE could transmit in Msg1 or MsgA of a random access procedure, one or more PRACH preambles associated with value 0 of SRSPoolIndex, which could be further associated with the serving cell PCI/value 0 of CORESETPoolIndex/value 0 of CORESETGroupIndex, and one or more PRACH preambles associated with value 1 of SRSPoolIndex, which could be further associated with a non-serving cell PCI/value 1 of CORESETPoolIndex/value 1 of CORESETGroupIndex.

In yet another example, the UE could transmit in Msg1 or MsgA of a random access procedure, one or more PRACH preambles associated with a SRS resource set index/ID, which could be further associated with the serving cell PCI/value 0 of CORESETPoolIndex/value 0 of CORESETGroupIndex, and one or more PRACH preambles associated with another SRS resource set index/ID, which could be further associated with a non-serving cell PCI/value 1 of CORESETPoolIndex/value 1 of CORESETGroupIndex.

In yet another example, the UE could transmit in Msg1 or MsgA of a random access procedure, one or more PRACH preambles associated with a SRS resource index/ID, which could be further associated with the serving cell PCI/value 0 of CORESETPoolIndex/value 0 of CORESETGroupIndex, and one or more PRACH preambles associated with another SRS resource index/ID, which could be further associated with a non-serving cell PCI/value 1 of CORESETPoolIndex/value 1 of CORESETGroupIndex.

For Type-1 random access procedure, a UE could be provided a number N of entity IDs/SSB indexes associated with one or more entity IDs associated with one PRACH occasion and a number R of contention based preambles per entity ID/SSB index associated with an entity ID per valid occasion.

For Type-2 random access procedure with common configuration of PRACH occasions with Type-1 random access procedure, a UE could be provided a number N of entity IDs/SSB indexes associated with one or more entity IDs associated with one PRACH occasion and a number Q of contention based preambles per entity ID/SSB index associated with an entity ID per valid PRACH occasion. The PRACH transmission can be on a subset of PRACH occasions associated with a same entity ID/SSB index associated with an entity ID.

For Type-2 random access procedure with separate configuration of PRACH occasions with Type-1 random access procedure, a UE could be provided a number N of entity IDs/SSB indexes associated with one or more entity IDs associated with one PRACH occasion and a number R of contention based preambles per entity ID/SSB index associated with an entity ID per valid PRACH occasion.

For Type-1 random access procedure, or for Type-2 random access procedure with separate configuration of PRACH occasions from Type-1 random access procedure, if N<1, one entity ID could be mapped to 1/N consecutive valid PRACH occasions and R contention based preambles with consecutive indexes associated with the entity ID per valid PRACH occasion start from preamble index 0. If N≥1, R contention based preambles with consecutive indexes associated with entity ID n/SSB index n associated with an entity ID, 0≤n≤N−1, per valid PRACH occasion start from preamble index n·N_{preamble}^{total}/N, where N_{preamble}^{total} is provided by the higher layer parameter totalNumberOfRA-Preambles for Type-1 random access procedure, or by the higher layer parameter msgA-TotalNumberOfRA-Preambles for Type-2 random access procedure with separate configuration of PRACH occasions from a Type-1 random access procedure, and is an integer multiple of N.

For Type-2 random access procedure with common configuration of PRACH occasions with Type-1 random access procedure, if N<1, one entity ID/SSB index associated with an entity ID is mapped to 1/N consecutive valid PRACH occasions and Q contention based preambles with consecutive indexes associated with the entity ID/SSB index associated with an entity ID per valid PRACH occasion start from R. If N≥1, Q contention based preambles with consecutive indexes associated with entity ID n/SSB index n associated with an entity ID, 0≤n≤N−1, per valid PRACH occasion start from preamble index n·N_{preamble}^{total}/N+R, where N_{preamble}^{total} is provided by the higher layer parameter totalNumberOfRA-Preambles for Type-1 random access procedure.

The entity IDs/SSB indexes associated with one or more entity IDs are mapped to valid PRACH occasions in the following order: first, in increasing order of preamble indexes within a single PRACH occasion; second, in increasing order of frequency resource indexes for frequency multiplexed PRACH occasions; third, in increasing order of time resource indexes for time multiplexed PRACH occasions within a PRACH slot; fourth, in increasing order of indexes for PRACH slots.

An association period, starting from frame 0, for mapping entity IDs/SSB indexes associated with one or more entity IDs to PRACH occasions is the smallest value in the set determined by the PRACH configuration period according to Table 8.1-1 in the 3GPP TS 38.213 such that N_{Tx}^{PCI} entity IDs/N_{Tx}^{SSB} SSB indexes associated with one or more entity IDs are mapped at least once to the PRACH occasions within the association period, where the UE could be provided by the network N_{Tx}^{PCI} or N_{Tx}^{SSB}.

If after an integer of entity IDs/SSB indexes associated with one or more entity IDs to PRACH occasions mapping cycles within the association period, there is a set of PRACH occasions or PRACH preambles that are not mapped to N_{Tx}^{PCI} entity IDs/N_{Tx}^{SSB} SSB indexes associated with one or more entity IDs, no entity IDs/SSB indexes associated with one or more entity IDs are mapped to the set of PRACH occasions or PRACH preambles. An association pattern period includes one or more association periods and is determined so that a pattern between PRACH occasions and entity IDs/SSB indexes associated with one or more entity IDs repeats at most every 160 msec. PRACH occasions not associated with entity IDs/SSB indexes associated with one or more entity IDs after an integer number of association periods, if any, are not used for PRACH transmissions.

For a PRACH transmission triggered by a PDCCH order, the PRACH mask index field (described in the 3GPP TS 38.212 clause 5), if the value of the random access preamble index field is not zero, could indicate the PRACH occasion for the PRACH transmission where the PRACH occasions are associated with the entity ID/SSB index associated with an entity ID indicated by the corresponding field(s) of the PDCCH order.

For a PRACH transmission triggered by higher layers, the PRACH mask index could be indicated by the higher layer parameter ra-ssb-OccasionMaskIndex which indicates the PRACH occasions for the PRACH transmission where the PRACH occasions are associated with the selected entity ID/SSB index associated with an entity ID.

The PRACH occasions are mapped consecutively per corresponding entity ID/SSB index associated with an entity ID. The indexing of the PRACH occasion indicated by the mask index value is reset per mapping cycle of consecutive PRACH occasions per entity ID/SSB index associated with an entity ID. The UE could select for a PRACH transmission the PRACH occasion indicated by PRACH mask index value for the indicated entity ID/SSB index associated with an entity ID in the first available mapping cycle.

For the indicated preamble index, the ordering of the PRACH occasions is: first, in increasing order of frequency resource indexes for frequency multiplexed PRACH occasions; second, in increasing order of timing resource indexes for time multiplexed PRACH occasions within a PRACH slot; third, in increasing order of indexes for PRACH slots.

For a PRACH transmission triggered upon request by higher layers, a value of ra-OccasionList defined in the 3GPP TS 38.331 clause 12, indicates a list of PRACH occasions for the PRACH transmission where the PRACH occasions are associated with an entity ID or the selected CSI-RS index associated with an entity ID. The indexing of the PRACH occasions indicated by ra-OccasionList is reset per association pattern period.

Based on the TD report, the serving cell gNB could determine for the UE the UL TA(s)/timing adjustment(s) for the non-serving cell PCI(s). For example, assume that the TD only contains the propagation delay difference delta_d. The serving cell could then estimate the propagation delay between the UE and the non-serving cell as d1=d0+delta_d, where d0 represents the propagation delay between the UE and the serving cell, and is known to the serving cell/gNB a priori. The serving cell gNB could then determine the TA for the non-serving cell PCI according to the round-trip delay between the UE and the non-serving cell PCI, i.e., 2·d1. The UE could then be indicated/configured by the serving cell/gNB the UL TA for the non-serving cell PCI through RAR or absolute timing advance command MAC CE.

FIG. 21 illustrates an example of a TA command MAC CE for non-serving cell PCI 2100 according to embodiments of the present disclosure. An embodiment of the TA command MAC CE for non-serving cell PCI 2100 shown in FIG. 21 is for illustration only.

In FIG. 21, a conceptual example of the MAC CE entity to indicate the non-serving cell TA is provided. As can be seen from FIG. 21, the non-serving cell (NSC) identification (ID) is indicated in the timing advance command MAC CE. In the present disclosure, the NSC ID could correspond to at least one of: a PCI, a PCI index pointing to a PCI value in a list/set/pool of PCIs higher layer configured to the UE, a CORESETPoolIndex value, a CORESETGroupIndex value, a one-bit flag/indicator indicating either the serving cell PCI or the non-serving cell PCI, a multi-bit indicator with each state of the indicator indicating a PCI, a TRP ID/index, and a TRP-specific higher layer signaling index.

That is, a UE could be provided by the network one or more (e.g., Ntao=2) timing advance offset values for one or more cells/TRPs including at least a serving cell PCI or one or more UE panels. For example, the UE could be provided by the network Ntao=2 timing advance offset values with a first timing advance offset value N_{TA, offset} for the serving cell PCI provided by n-TimingAdvanceOffset-sc and a second timing advance offset value M_{TA, offset} for a non-serving cell PCI provided by n-TimingAdvanceOffset-nsc. If the UE is not provided n-TimingAdvanceOffset-sc for the serving cell or n-TimingAdvanceOffset-nsc for the non-serving cell PCI, the UE could determine default timing advance offset values for the serving cell PCI or the non-serving cell PCI according to the 3GPP TS 38.133 clause 10.

For another example, the UE could be provided by the network Ntao=2 timing advance offset values with a first timing advance offset value N_{TA, offset} for a first UE antenna panel provided by n-TimingAdvanceOffset-p1 and a second timing advance offset value MTA, offset for a second UE antenna panel provided by n-TimingAdvanceOffset-p2. If the UE is not provided n-TimingAdvanceOffset-p1 for the first UE antenna panel or n-TimingAdvanceOffset-p2 for the second UE antenna panel, the UE could determine default timing advance offset values for the first or the second UE antenna panel according to the 3GPP TS 38.133 clause 10.

Along with the indication(s) of the timing advance offset values, the UE could be provided by the network one or more entity IDs associated with the indicated timing advance offset values. The UE could be indicated by the network the entity IDs and the corresponding timing advance offset values in the same higher layer RRC parameter ServingCellConfigCommon.

In one example (example 1.1), an entity ID could correspond to a PCI. The UE could be provided by the network, e.g., via the higher layer parameter ServingCellConfigCommon, one or more (e.g., Ntao) PCIs associated with the one or more timing advance offset values indicated in the same ServingCellConfigCommon; alternatively, the UE could use the one or more (e.g., Ntao) PCIs, e.g., indicated/reported in the transmission of Msg1 or MsgA, to associate the one or more timing advance offset values indicated in the ServingCellConfigCommon.

For example, for Ntao=2, the UE could be provided by the network Ntao=2 PCIs each associated with/corresponding to a timing advance offset value indicated in the higher layer parameter ServingCellConfigCommon; alternatively, the UE could use the Ntao=2 PCIs, e.g., indicated/reported in the transmission of Msg1 or MsgA, to associate the Ntao=2 timing advance offset values; the first PCI or the lowest PCI or the serving cell PCI could be associated with the first (or the second) timing advance offset value N_{TA, offset} (or M_{TA, offset}), while the second PCI or the highest PCI or the non-serving cell PCI could be associated with the second (or the first) timing advance offset value M_{TA, offset} (or N_{TA, offset}).

For another example, for Ntao=2, the UE could be provided by the network a single PCI different from the serving cell PCI; alternatively, the UE could use the PCI different from the serving cell PCI, e.g., indicated/reported in the transmission of Msg1 or MsgA, to associate a timing advance offset value; for this case, the serving cell PCI could be associated with the first (or the second) timing advance offset value N_{TA, offset} (or M_{TA, offset}), while the PCI different from the serving cell PCI could be associated with the second (or the first) timing advance offset value M_{TA, offset} (or N_{TA, offset}).

In another example (example 1.2), an entity ID could correspond to a PCI index corresponding/pointing to a PCI value in a list/set/pool of PCIs higher layer configured to the UE. The UE could be provided by the network, e.g., via the higher layer parameter ServingCellConfigCommon, one or more (e.g., Ntao) PCI indexes associated with the one or more timing advance offset values indicated in the same ServingCellConfigCommon; alternatively, the UE could use the one or more (e.g., Ntao) PCI indexes, e.g., indicated/reported in the transmission of Msg1 or MsgA, to associate the one or more timing advance offset values indicated in the ServingCellConfigCommon.

For example, for Ntao=2, the UE could be provided by the network Ntao=2 PCI indexes each associated with/corresponding to a timing advance offset value indicated in the higher layer parameter ServingCellConfigCommon; alternatively, the UE could use the Ntao=2 PCI indexes, e.g., indicated/reported in the transmission of Msg1 or MsgA, to associate the Ntao=2 timing advance offset values; the first PCI index or the lowest PCI index or the PCI index corresponding/pointing to the lowest PCI or the serving cell PCI in the list/set/pool of PCIs higher layer configured to the UE could be associated with the first (or the second) timing advance offset value N_{TA, offset} (or M_{TA, offset}), while the second PCI index or the highest PCI index or the PCI index corresponding/pointing to the highest PCI or the non-serving cell PCI in the list/set/pool of PCIs higher layer configured to the UE could be associated with the second (or the first) timing advance offset value M_{TA, offset} (or N_{TA, offset}).

For another example, for Ntao=2, the UE could be provided by the network a single PCI index corresponding/pointing to a PCI different from the serving cell PCI in the list/set/pool of PCIs higher layer configured to the UE; alternatively, the UE could use the PCI index corresponding/pointing to the PCI different from the serving cell PCI in the list/set/pool of PCIs higher layer configured to the UE, e.g., indicated/reported in the transmission of Msg1 or MsgA, to associate a timing advance offset value; for this case, the serving cell PCI could be associated with the first (or the second) timing advance offset value N_{TA, offset} (or M_{TA, offset}), while the PCI indicated via the PCI index could be associated with the second (or the first) timing advance offset value M_{TA, offset} (or N_{TA, offset}).

In yet another example (example 1.3), an entity ID could correspond to a CORESETPoolIndex value. The UE could be configured with PDCCH-Config that contains two different CORESETPoolIndex values in CORESET. For example, for Ntao=2, CORESETPoolIndex value of 0 could be associated with the first (or the second) timing advance offset value N_{TA, offset} (or M_{TA, offset}), while CORESETPoolIndex value of 1 could be associated with the second (or the first) timing advance offset value M_{TA, offset} (or N_{TA, offset}). For another example, for Ntao=2, the CORESETPoolIndex value associated with the serving cell PCI could be associated with the first (or the second) timing advance offset value N_{TA, offset} (or M_{TA, offset}), while the CORESETPoolIndex value associated with the non-serving cell PCI could be associated with the second (or the first) timing advance offset value M_{TA, offset} (or N_{TA, offset}).

In yet another example (example 1.4), an entity ID could correspond to a CORESETGroupIndex value. The UE could be configured with PDCCH-Config that contains two different CORESETGroupIndex values in CORESET. For example, for Ntao=2, CORESETGroupIndex value of 0 could be associated with the first (or the second) timing advance offset value N_{TA, offset} (or M_{TA, offset}), while CORESETGroupIndex value of 1 could be associated with the second (or the first) timing advance offset value M_{TA, offset} (or N_{TA, offset}). For another example, for Ntao=2, the CORESETGroupIndex value associated with the serving cell PCI could be associated with the first (or the second) timing advance offset value N_{TA, offset} (or M_{TA, offset}), while the CORESETGroupIndex value associated with the non-serving cell PCI could be associated with the second (or the first) timing advance offset value M_{TA, offset} (or N_{TA, offset}).

In yet another example (example 1.5), an entity ID could correspond to a PCI indicator. The UE could be provided by the network, e.g., via the higher layer parameter ServingCellConfigCommon, one or more (e.g., Ntao) PCI indicators associated with the one or more timing advance offset values indicated in the same ServingCellConfigCommon; alternatively, the UE could use the one or more (e.g., Ntao) PCI indicators, e.g., indicated/reported in the transmission of Msg1 or MsgA, to associate the one or more timing advance offset values indicated in the ServingCellConfigCommon. In the present disclosure, a PCI indicator could be a one-bit flag indicator indicating either the serving cell PCI or the non-serving cell PCI or a multi-bit indicator with each state of the multi-bit indicator indicating a PCI.

For example, for Ntao=2, the UE could be provided by the network Ntao=2 PCI indicators each associated with/corresponding to a timing advance offset value indicated in the higher layer parameter ServingCellConfigCommon; alternatively, the UE could use the Ntao=2 PCI indicators, e.g., indicated/reported in the transmission of Msg1 or MsgA, to associate the Ntao=2 timing advance offset values; the first PCI indicator, and therefore, the corresponding PCI, CORESETPoolIndex, CORESETGroupIndex, TRP ID or TRP-specific higher layer signaling index, could be associated with the first (or the second) timing advance offset value N_{TA, offset} (or M_{TA, offset}), while the second PCI indicator, and therefore, the corresponding PCI, CORESETPoolIndex, CORESETGroupIndex, TRP ID or TRP-specific higher layer signaling index could be associated with the second (or the first) timing advance offset value M_{TA, offset} (or N_{TA, offset}).

For a multi-panel UE, one or more timing advance offset values could be indicated for or associated with an antenna panel at the UE. As discussed above, in the present disclosure, an antenna panel at the UE could be characterized/represented by a panel ID, a panel-specific higher layer signaling index SRSPoolIndex, a SRS resource set, a SRS resource group in a SRS resource set or one or more SRS resources in a SRS resource set.

In one example (example 1.6), the UE could be provided by the network, e.g., via the higher layer parameter ServingCellConfigCommon, one or more (e.g., Ntao) panel IDs associated with the one or more timing advance offset values indicated in the same ServingCellConfigCommon; alternatively, the UE could use the one or more (e.g., Ntao) panel IDs, e.g., indicated/reported in the transmission of Msg1 or MsgA, to associate the one or more timing advance offset values indicated in the ServingCellConfigCommon.

For example, for Ntao=2, the UE could be provided by the network Ntao=2 panel IDs each associated with/corresponding to a timing advance offset value indicated in the higher layer parameter ServingCellConfigCommon; alternatively, the UE could use the Ntao=2 panel IDs, e.g., indicated/reported in the transmission of Msg1 or MsgA, to associate the Ntao=2 timing advance offset values; the first panel ID or the lowest panel ID or the panel ID associated with/linked to the serving cell PCI/value 0 of CORESETPoolIndex/value 0 of CORESETGroupIndex could be associated with the first (or the second) timing advance offset value N_{TA, offset} (or M_{TA, offset}), while the second panel ID or the highest panel ID or the panel ID associated with/linked to the non-serving cell PCI/value 1 of CORESETPoolIndex/value 1 of CORESETGroupIndex could be associated with the second (or the first) timing advance offset value M_{TA, offset} (or N_{TA, offset}).

For another example, for Ntao=2, the UE could be provided by the network a single panel ID associated with/linked to the serving cell PCI or a PCI different from the serving cell PCI; alternatively, the UE could use the panel ID associated with/linked to the serving cell PCI or the PCI different from the serving cell PCI, e.g., indicated/reported in the transmission of Msg1 or MsgA, to associate a timing advance offset value; for this case, the panel ID associated with/linked to the serving cell PCI/value 0 of CORESETPoolIndex/value 0 of CORESETGroupIndex could be associated with the first (or the second) timing advance offset value N_{TA, offset} (or M_{TA, offset}), while the panel ID associated with/linked to the non-serving cell PCI/value 1 of CORESETPoolIndex/value 1 of CORESETGroupIndex could be associated with the second (or the first) timing advance offset value M_{TA, offset} (or N_{TA, offset}).

In another example (example 1.7), the UE could be configured with at least two UE panel-specific higher layer signaling index values—SRSPoolIndex values. For example, for Ntao=2, SRSPoolIndex value of 0 could be associated with the first (or the second) timing advance offset value N_{TA, offset} (or M_{TA, offset}), while SRSPoolIndex value of 1 could be associated with the second (or the first) timing advance offset value M_{TA, offset} (or N_{TA, offset}). For another example, for Ntao=2, the SRSPoolIndex value associated with/linked to the serving cell PCI/value 0 of CORESETPoolIndex/value 0 of CORESETGroupIndex could be associated with the first (or the second) timing advance offset value N_{TA, offset} (or M_{TA, offset}), while the SRSPoolIndex value associated with the non-serving cell PCI/value 1 of CORESETPoolIndex/value 1 of CORESETGroupIndex could be associated with the second (or the first) timing advance offset value M_{TA, offset} (or N_{TA, offset}).

In yet another example (example 1.8), the UE could be provided by the network, e.g., via the higher layer parameter ServingCellConfigCommon, one or more (e.g., Ntao) SRS resource set indexes/IDs associated with the one or more timing advance offset values indicated in the same ServingCellConfigCommon; alternatively, the UE could use the one or more (e.g., Ntao) SRS resource set indexes/IDs, e.g., indicated/reported in the transmission of Msg1 or MsgA, to associate the one or more timing advance offset values indicated in the ServingCellConfigCommon.

For example, for Ntao=2, the UE could be provided by the network Ntao=2 SRS resource set indexes/IDs each associated with/corresponding to a timing advance offset value indicated in the higher layer parameter ServingCellConfigCommon; alternatively, the UE could use the Ntao=2 SRS resource set indexes/IDs, e.g., indicated/reported in the transmission of Msg1 or MsgA, to associate the Ntao=2 timing advance offset values; the first SRS resource set index/ID or the lowest SRS resource set index/ID or the SRS resource set index/ID associated with/linked to the serving cell PCI/value 0 of CORESETPoolIndex/value 0 of CORESETGroupIndex could be associated with the first (or the second) timing advance offset value N_{TA, offset} (or M_{TA, offset}), while the second SRS resource set index/ID or the highest SRS resource set index/ID or the SRS resource set index/ID associated with/linked to the non-serving cell PCI/value 1 of CORESETPoolIndex/value 1 of CORESETGroupIndex could be associated with the second (or the first) timing advance offset value M_{TA, offset} (or N_{TA, offset}).

For another example, for Ntao=2, the UE could be provided by the network a single SRS resource set index/ID associated with/linked to the serving cell PCI or a PCI different from the serving cell PCI; alternatively, the UE could use the SRS resource set index/ID associated with/linked to the serving cell PCI or the PCI different from the serving cell PCI, e.g., indicated/reported in the transmission of Msg1 or MsgA, to associate a timing advance offset value; for this case, the SRS resource set index/ID associated with/linked to the serving cell PCI/value 0 of CORESETPoolIndex/value 0 of CORESETGroupIndex could be associated with the first (or the second) timing advance offset value N_{TA, offset} (or M_{TA, offset}), while the SRS resource set index/ID associated with/linked to the non-serving cell PCI/value 1 of CORESETPoolIndex/value 1 of CORESETGroupIndex could be associated with the second (or the first) timing advance offset value M_{TA, offset} (or N_{TA, offset}).

In yet another example (example 1.9), the UE could be provided by the network, e.g., via the higher layer parameter ServingCellConfigCommon, one or more (e.g., Ntao) SRS resource group indexes/IDs associated with the one or more timing advance offset values indicated in the same ServingCellConfigCommon; alternatively, the UE could use the one or more (e.g., Ntao) SRS resource group indexes/IDs, e.g., indicated/reported in the transmission of Msg1 or MsgA, to associate the one or more timing advance offset values indicated in the ServingCellConfigCommon. As discussed above, a SRS resource group could comprise one or more SRS resources configured in a SRS resource set, and one SRS resource set could comprise one or more SRS resource groups.

For example, for Ntao=2, the UE could be provided by the network Ntao=2 SRS resource group indexes/IDs each associated with/corresponding to a timing advance offset value indicated in the higher layer parameter ServingCellConfigCommon; alternatively, the UE could use the Ntao=2 SRS resource group indexes/IDs, e.g., indicated/reported in the transmission of Msg1 or MsgA, to associate the Ntao=2 timing advance offset values; the first SRS resource group index/ID or the lowest SRS resource group index/ID or the SRS resource group index/ID associated with/linked to the serving cell PCI/value 0 of CORESETPoolIndex/value 0 of CORESETGroupIndex could be associated with the first (or the second) timing advance offset value N_{TA, offset} (or M_{TA, offset}), while the second SRS resource group index/ID or the highest SRS resource group index/ID or the SRS resource group index/ID associated with/linked to the non-serving cell PCI/value 1 of CORESETPoolIndex/value 1 of CORESETGroupIndex could be associated with the second (or the first) timing advance offset value M_{TA, offset} (or N_{TA, offset}).

For another example, for Ntao=2, the UE could be provided by the network a single SRS resource group index/ID associated with/linked to the serving cell PCI or a PCI different from the serving cell PCI; alternatively, the UE could use the SRS resource group index/ID associated with/linked to the serving cell PCI or the PCI different from the serving cell PCI, e.g., indicated/reported in the transmission of Msg1 or MsgA, to associate a timing advance offset value; for this case, the SRS resource group index/ID associated with/linked to the serving cell PCI/value 0 of CORESETPoolIndex/value 0 of CORESETGroupIndex could be associated with the first (or the second) timing advance offset value N_{TA, offset} (or M_{TA, offset}), while the SRS resource group index/ID associated with/linked to the non-serving cell PCI/value 1 of CORESETPoolIndex/value 1 of CORESETGroupIndex could be associated with the second (or the first) timing advance offset value M_{TA, offset} (or N_{TA, offset}).

In yet another example (example 1.10), the UE could be provided by the network, e.g., via the higher layer parameter ServingCellConfigCommon, one or more (e.g., Ntao) SRS resource indexes/IDs in a SRS resource set associated with the one or more timing advance offset values indicated in the same ServingCellConfigCommon; alternatively, the UE could use the one or more (e.g., Ntao) SRS resource indexes/IDs in a SRS resource set, e.g., indicated/reported in the transmission of Msg1 or MsgA, to associate the one or more timing advance offset values indicated in the ServingCellConfigCommon.

For example, for Ntao=2, the UE could be provided by the network Ntao=2 SRS resource indexes/IDs each associated with/corresponding to a timing advance offset value indicated in the higher layer parameter ServingCellConfigCommon; alternatively, the UE could use the Ntao=2 SRS resource indexes/IDs, e.g., indicated/reported in the transmission of Msg1 or MsgA, to associate the Ntao=2 timing advance offset values; the first SRS resource index/ID or the lowest SRS resource index/ID or the SRS resource index/ID associated with/linked to the serving cell PCI/value 0 of CORESETPoolIndex/value 0 of CORESETGroupIndex could be associated with the first (or the second) timing advance offset value N_{TA, offset} (or M_{TA, offset}), while the second SRS resource index/ID or the highest SRS resource index/ID or the SRS resource index/ID associated with/linked to the non-serving cell PCI/value 1 of CORESETPoolIndex/value 1 of CORESETGroupIndex could be associated with the second (or the first) timing advance offset value M_{TA, offset} (or N_{TA, offset}).

For another example, for Ntao=2, the UE could be provided by the network a single SRS resource index/ID associated with/linked to the serving cell PCI or a PCI different from the serving cell PCI; alternatively, the UE could use the SRS resource index/ID associated with/linked to the serving cell PCI or the PCI different from the serving cell PCI, e.g., indicated/reported in the transmission of Msg1 or MsgA, to associate a timing advance offset value; for this case, the SRS resource index/ID associated with/linked to the serving cell PCI/value 0 of CORESETPoolIndex/value 0 of CORESETGroupIndex could be associated with the first (or the second) timing advance offset value N_{TA, offset} (or M_{TA, offset}), while the SRS resource index/ID associated with/linked to the non-serving cell PCI/value 1 of CORESETPoolIndex/value 1 of CORESETGroupIndex could be associated with the second (or the first) timing advance offset value M_{TA, offset} (or N_{TA, offset}).

For the design examples 1.1, 1.2, 1.3, 1.4 and 1.5, upon reception of timing advance command(s), the UE could adjust uplink timing for PUSCH/SRS/PUCCH transmission for/associated with a PCI, PCI index, CORESETPoolIndex value, CORESETGroupIndex value and PCI indicator, respectively, based on a timing advance offset value associated with the corresponding PCI, PCI index, CORESETPoolIndex value, CORESETGroupIndex value and PCI indicator, respectively, and based on received timing advance command(s) for the corresponding PUSCH/SRS/PUCCH transmission.

More specifically, for Ntao=2, upon reception of timing advance command(s), the UE could adjust uplink timing for first PUSCH/SRS/PUCCH transmission for/associated with the serving cell PCI, PCI index corresponding/pointing to the serving cell PCI in the list/set/pool of PCIs higher layer configured to the UE, value 0 of CORESETPoolIndex, value 0 of CORESETGroupIndex or PCI indicator associated with the serving cell PCI based on a value N_{TA, offset} (or M_{TA, offset}) associated with the serving cell PCI, PCI index corresponding/pointing to the serving cell PCI in the list/set/pool of PCIs higher layer configured to the UE, value 0 of CORESETPoolIndex, value 0 of CORESETGroupIndex or PCI indicator associated with the serving cell PCI, and based on received timing advance command(s) for the first PUSCH/SRS/PUCCH transmission.

Furthermore, the UE could adjust uplink timing for second PUSCH/SRS/PUCCH transmission for/associated with the non-serving cell PCI, PCI index corresponding/pointing to the non-serving cell PCI in the list/set/pool of PCIs higher layer configured to the UE, value 1 of CORESETPoolIndex, value 1 of CORESETGroupIndex or PCI indicator associated with the non-serving cell PCI based on a value M_{TA, offset} (or N_{TA, offset}) associated with the non-serving cell PCI, PCI index corresponding/pointing to the non-serving cell PCI in the list/set/pool of PCIs higher layer configured to the UE, value 1 of CORESETPoolIndex, value 1 of CORESETGroupIndex or PCI indicator associated with the non-serving cell PCI, and based on received timing advance command(s) for the second PUSCH/SRS/PUCCH transmission.

For the design examples 1.6, 1.7, 1.8, 1.9 and 1.10, upon reception of timing advance command(s), the UE could adjust uplink timing for PUSCH/SRS/PUCCH transmission associated with a UE panel ID, a UE panel-specific higher layer signaling index value SRSPoolIndex value, a SRS resource set index/ID, a SRS resource group index/ID in a SRS resource set and one or more SRS resource indexes/IDs, respectively, based on a timing advance offset value associated with the corresponding UE panel ID, SRSPoolIndex value, SRS resource set index/ID, SRS resource group index/ID in a SRS resource set and one or more SRS resource indexes/IDs, respectively, and based on received timing advance command(s) for the corresponding PUSCH/SRS/PUCCH transmission.

More specifically, for Ntao=2, upon reception of timing advance command(s), the UE could adjust uplink timing for first PUSCH/SRS/PUCCH transmission associated with the panel ID, value 0 of SRSPoolIndex, SRS resource set index/ID, SRS resource group index/ID or one or more SRS resource indexes/IDs associated with the serving cell PCI/value 0 of CORESETPoolIndex/value 0 of CORESETGroupIndex based on a value N_{TA, offset} (or M_{TA, offset}) associated with the panel ID, value 0 of SRSPoolIndex, SRS resource set index/ID, SRS resource group index/ID or one or more SRS resource indexes/IDs associated with the serving cell PCI/value 0 of CORESETPoolIndex/value 0 of CORESETGroupIndex, and based on received timing advance command(s) for the first PUSCH/SRS/PUCCH transmission.

Furthermore, the UE could adjust uplink timing for second PUSCH/SRS/PUCCH transmission associated with the panel ID, value 1 of SRSPoolIndex, SRS resource set index/ID, SRS resource group index/ID or one or more SRS resource indexes/IDs associated with the non-serving cell PCI/value 1 of CORESETPoolIndex/value 1 of CORESETGroupIndex based on a value M_{TA, offset} (or N_{TA, offset}) associated with the panel ID, value 1 of SRSPoolIndex, SRS resource set index/ID, SRS resource group index/ID or one or more SRS resource indexes/IDs associated with the non-serving cell PCI/value 1 of CORESETPoolIndex/value 1 of CORESETGroupIndex, and based on received timing advance command(s) for the second PUSCH/SRS/PUCCH transmission.

In addition to the timing advance offset value(s), the UE could also receive from the network one or more (e.g., Nta=2) timing advance commands associated with one or more cells/TRPs including at least a serving cell PCI or one or more UE panels. For example, the UE could be provided by the network Nta=2 timing advance commands with a first timing advance command, T_{A,1}, provided in a first RAR or a first absolute timing advance command MAC CE for the serving cell PCI and a second timing advance command, T_{A,2}, provided in a second RAR or a second absolute timing advance command MAC CE for a non-serving cell PCI.

For another example, the UE could be provided by the network Nta=2 timing advance commands with a first timing advance command, T_{A,1}, provided in a first RAR or a first absolute timing advance command MAC CE for a first UE antenna panel and a second timing advance command, T_{A,2}, provided in a second RAR or a second absolute timing advance command MAC CE for a second UE antenna panel.

For example, for Nta=2, the first or the second timing advance command (as described in the 3GPP TS 38.321) in case of the first or the second RAR or in the first or the second absolute timing advance command MAC CE, T_{A,1} or T_{A,2}, for a first or a second TAG indicates N_{TA,1} or N_{TA,2} values by index values of T_{A,1}=0, 1, . . . , 3846 or T_{A,2}=0, 1, 2 . . . , 3846, where an amount of the time alignment for the first or the second TAG with SCS of 2^{μ}·15 kHz is N_{TA,1}=T_{A,1}·16·64/2^{μ} or N_{TA,2}=T_{A,2}·16·64/2^{μ}. Here, N_{TA,1} or N_{TA,2} is defined in the 3GPP TS 38.211 and is relative to the SCS of the first uplink transmission from the UE after the reception of the first or the second random access response or the first or the second absolute timing advance command MAC CE.

In other cases, the first or the second timing advance command, T_{A,1} or T_{A,2}, for the first or the second TAG indicates adjustment of a current N_{TA,1} or N_{TA,2} value, N_{TA_old,1} or N_{TA_old,2} to the new N_{TA,1} or N_{TA,2} value, N_{TA_new,1} or N_{TA_new,2}, by index values of T_{A,1}=0, 1, . . . , 63 or T_{A,2}=0, 1, 2 . . . , 63, where for a SCS of 2^{μ}·15 kHz, N_{TA_new,1}=N_{TA_old,1}+(T_{A,1}−31)·16·64/2^{μ} or N_{TA_new,2}=N_{TA_old,2}+(T_{A,2}−31)·16·64/2^{μ}. Adjustment of an N_{TA,1} or N_{TA,2} value by a positive or a negative amount indicates advancing or delaying the uplink transmission timing for the first or the second TAG by a corresponding amount, respectively.

Along with the indication(s) of the timing advance commands, the UE could be provided by the network one or more entity IDs associated with the indicated timing advance commands. The UE could be indicated by the network the entity ID and the corresponding timing advance command in the same RAR or absolute timing advance command MAC CE.

In one example (example I.1), an entity ID could correspond to a PCI. The UE could be provided by the network, e.g., in one or more RARs or absolute timing advance command MAC CEs, one or more (e.g., Nta) PCIs associated with the one or more timing advance commands indicated in the same RARs or absolute timing advance command MAC CEs; alternatively, the UE could use the one or more (e.g., Nta) PCIs, e.g., indicated/reported in the transmission of Msg1 or MsgA, to associate the one or more timing advance commands indicated in the one or more RARs or absolute timing advance command MAC CEs.

For example, for Nta=2, the UE could be provided by the network Nta=2 PCIs with a first PCI indicated in the first RAR or the first absolute timing advance command MAC CE and associated with the first timing advance command indicated therein, and a second PCI indicated in the second RAR or the second absolute timing advance command MAC CE and associated with the second timing advance command indicated therein; alternatively, the UE could use the Nta=2 PCIs, e.g., indicated/reported in the transmission of Msg1 or MsgA, to associate the Nta=2 timing advance commands; the first PCI or the lowest PCI or the serving cell PCI could be associated with the first (or the second) timing advance command T_{A,1} (or T_{A,2}) indicated in the first (or the second) RAR or absolute timing advance command MAC CE, while the second PCI or the highest PCI or the non-serving cell PCI could be associated with the second (or the first) timing advance command T_{A,2} (or T_{A,1}) indicated in the second (or the first) RAR or absolute timing advance command MAC CE.

For another example, for Nta=2, the UE could be provided by the network, e.g., in the first RAR/absolute timing advance command MAC CE or the second RAR/absolute timing advance command MAC CE, a single PCI different from the serving cell PCI; alternatively, the UE could use the PCI different from the serving cell PCI, e.g., indicated/reported in the transmission of Msg1 or MsgA, to associate a timing advance command; for this case, the serving cell PCI could be associated with the first (or the second) timing advance command T_{A,1} (or T_{A,2}) indicated in the first (or the second) RAR or absolute timing advance command MAC CE, while the PCI different from the serving cell PCI could be associated with the second (or the first) timing advance command T_{A,2} (or T_{A,1}) indicated in the second (or the first) RAR or absolute timing advance command MAC CE.

In another example (example I.2), an entity ID could correspond to a PCI index corresponding/pointing to a PCI value in a list/set/pool of PCIs higher layer configured to the UE. The UE could be provided by the network, e.g., in one or more RARs or one or more absolute timing advance command MAC CEs, one or more (e.g., Nta) PCI indexes associated with the one or more timing advance commands indicated in the same RARs or absolute timing advance command MAC CEs; alternatively, the UE could use the one or more (e.g., Nta) PCI indexes, e.g., indicated/reported in the transmission of Msg1 or MsgA, to associate the one or more timing advance commands indicated in the one or more RARs or absolute timing advance command MAC CEs.

For example, for Nta=2, the UE could be provided by the network Nta=2 PCI indexes with a first PCI index indicated in the first RAR or the first absolute timing advance command MAC CE and associated with the first timing advance command indicated therein, and a second PCI index indicated in the second RAR or the second absolute timing advance command MAC CE and associated with the second timing advance command indicated therein; alternatively, the UE could use the Nta=2 PCI indexes, e.g., indicated/reported in the transmission of Msg1 or MsgA, to associate the Nta=2 timing advance commands; the first PCI index or the lowest PCI index or the PCI index corresponding/pointing to the lowest PCI or the serving cell PCI in the list/set/pool of PCIs higher layer configured to the UE could be associated with the first (or the second) timing advance command T_{A,1} (or T_{A,2}) indicated in the first (or the second) RAR or absolute timing advance command MAC CE, while the second PCI index or the highest PCI index or the PCI index corresponding/pointing to the highest PCI or the non-serving cell PCI in the list/set/pool of PCIs higher layer configured to the UE could be associated with the second (or the first) timing advance command T_{A,2} (or T_{A,1}) indicated in the second (or the first) RAR or absolute timing advance command MAC CE.

For another example, for Nta=2, the UE could be provided by the network, e.g., in the first RAR/absolute timing advance command MAC CE or the second RAR/absolute timing advance command MAC CE, a single PCI index corresponding/pointing to a PCI different from the serving cell PCI in the list/set/pool of PCIs higher layer configured to the UE; alternatively, the UE could use the PCI index corresponding/pointing to the PCI different from the serving cell PCI in the list/set/pool of PCIs higher layer configured to the UE, e.g., indicated/reported in the transmission of Msg1 or MsgA, to associate a timing advance command; for this case, the serving cell PCI could be associated with the first (or the second) timing advance command T_{A,1} (or T_{A,2}) indicated in the first (or the second) RAR or absolute timing advance command MAC CE, while the PCI indicated via the PCI index could be associated with the second (or the first) timing advance command T_{A,2} (or T_{A,1}) indicated in the second (or the first) RAR or absolute timing advance command MAC CE.

In yet another example (example I.3), an entity ID could correspond to a CORESETPoolIndex value. The UE could be configured with PDCCH-Config that contains two different CORESETPoolIndex values in CORESET. For example, for Nta=2, CORESETPoolIndex value of 0 could be associated with the first (or the second) timing advance command T_{A,1} (or T_{A,2}) indicated in the first (or the second) RAR or absolute timing advance command MAC CE, while CORESETPoolIndex value of 1 could be associated with the second (or the first) timing advance command T_{A,2} (or T_{A,1}) indicated in the second (or the first) RAR or absolute timing advance command MAC CE. For another example, for Nta=2, the CORESETPoolIndex value associated with the serving cell PCI could be associated with the first (or the second) timing advance command T_{A,1} (or T_{A,2}) indicated in the first (or the second) RAR or absolute timing advance command MAC CE, while the CORESETPoolIndex value associated with the non-serving cell PCI could be associated with the second (or the first) timing advance command T_{A,2} (or T_{A,1}) indicated in the second (or the first) RAR or absolute timing advance command MAC CE.

In yet another example (example I.4), an entity ID could correspond to a CORESETGroupIndex value. The UE could be configured with PDCCH-Config that contains two different CORESETGroupIndex values in CORESET. For example, for Nta=2, CORESETGroupIndex value of 0 could be associated with the first (or the second) timing advance command T_{A,1} (or T_{A,2}) indicated in the first (or the second) RAR or absolute timing advance command MAC CE, while CORESETGroupIndex value of 1 could be associated with the second (or the first) timing advance command T_{A,2} (or T_{A,1}) indicated in the second (or the first) RAR or absolute timing advance command MAC CE. For another example, for Nta=2, the CORESETGroupIndex value associated with the serving cell PCI could be associated with the first (or the second) timing advance command T_{A,1} (or T_{A,2}) indicated in the first (or the second) RAR or absolute timing advance command MAC CE, while the CORESETGroupIndex value associated with the non-serving cell PCI could be associated with the second (or the first) timing advance command T_{A,2} (or T_{TA,1}) indicated in the second (or the first) RAR or absolute timing advance command MAC CE.

In yet another example (example I.5), an entity ID could correspond to a PCI indicator. The UE could be provided by the network, e.g., in one or more RARs or absolute timing advance command MAC CEs, one or more (e.g., Nta) PCI indicators associated with the one or more timing advance commands indicated in the same RARs or absolute timing advance command MAC CEs; alternatively, the UE could use the one or more (e.g., Nta) PCI indicators, e.g., indicated/reported in the transmission of Msg1 or MsgA, to associate the one or more timing advance commands indicated in the one or more RARs or absolute timing advance command MAC CEs. In the present disclosure, a PCI indicator could be a one-bit flag indicator indicating either the serving cell PCI or the non-serving cell PCI or a multi-bit indicator with each state of the multi-bit indicator indicating a PCI.

For example, for Nta=2, the UE could be provided by the network Nta=2 PCI indicators with a first PCI indicator indicated in the first RAR or the first absolute timing advance command MAC CE and associated with the first timing advance command indicated therein, and a second PCI indicator indicated in the second RAR or the second absolute timing advance command MAC CE and associated with the second timing advance command indicated therein; alternatively, the UE could use the Nta=2 PCI indicators, e.g., indicated/reported in the transmission of Msg1 or MsgA, to associate the Nta=2 timing advance commands; the first PCI indicator, and therefore, the corresponding PCI, CORESETPoolIndex, CORESETGroupIndex, TRP ID or TRP-specific higher layer signaling index, could be associated with the first (or the second) timing advance command T_{TA,1} (or T_{TA,2}) indicated in the first (or second) RAR or absolute timing advance command MAC CE, while the second PCI indicator, and therefore, the corresponding PCI, CORESETPoolIndex, CORESETGroupIndex, TRP ID or TRP-specific higher layer signaling index could be associated with the second (or the first) timing advance command T_{TA,2} (or T_{TA,1}) indicated in the second (or the first) RAR or absolute timing advance command MAC CE.

For a multi-panel UE, one or more timing advance commands could be indicated for or associated with an antenna panel at the UE. As discussed above, in the present disclosure, an antenna panel at the UE could be characterized/represented by a panel ID, a panel-specific higher layer signaling index SRSPoolIndex, a SRS resource set, a SRS resource group in a SRS resource set or one or more SRS resources in a SRS resource set.

In one example (example I.6), the UE could be provided by the network, e.g., in one or more RARs or absolute timing advance command MAC CEs, one or more (e.g., Nta) panel IDs associated with the one or more timing advance commands indicated in the same RARs or absolute timing advance command MAC CEs; alternatively, the UE could use the one or more (e.g., Nta) panel IDs, e.g., indicated/reported in the transmission of Msg1 or MsgA, to associate the one or more timing advance commands indicated in the one or more RARs or absolute timing advance command MAC CEs.

For example, for Nta=2, the UE could be provided by the network Nta=2 panel IDs with a first panel ID indicated in the first RAR or the first absolute timing advance command MAC CE and associated with the first timing advance command indicated therein, and a second panel ID indicated in the second RAR or the second absolute timing advance command MAC CE and associated with the second timing advance command indicated therein; alternatively, the UE could use the Nta=2 panel IDs, e.g., indicated/reported in the transmission of Msg1 or MsgA, to associate the Nta=2 timing advance commands; the first panel ID or the lowest panel ID or the panel ID associated with/linked to the serving cell PCI/value 0 of CORESETPoolIndex/value 0 of CORESETGroupIndex could be associated with the first (or the second) timing advance command T_{A,1} (or T_{A,2}) indicated in the first (or the second) RAR or absolute timing advance command MAC CE, while the second panel ID or the highest panel ID or the panel ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the second (or the first) RAR or absolute timing advance command MAC CE.

For another example, for Nta=2, the UE could be provided by the network, e.g., in the first RAR/absolute timing advance command MAC CE or the second RAR/absolute timing advance command MAC CE, a single panel ID associated with/linked to the serving cell PCI or a PCI different from the serving cell PCI; alternatively, the UE could use the panel ID associated with/linked to the serving cell PCI or the PCI different from the serving cell PCI, e.g., indicated/reported in the transmission of Msg1 or MsgA, to associate a timing advance command; for this case, the panel ID associated with/linked to the serving cell PCI/value 0 of CORESETPoolIndex/value 0 of CORESETGroupIndex could be associated with the first (or the second) timing advance command T_{A,1} (or T_{A,2}) indicated in the first (or the second) RAR or absolute timing advance command MAC CE, while the panel ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the second (or the first) RAR or absolute timing advance command MAC CE.

In another example (example I.7), the UE could be configured with at least two UE panel-specific higher layer signaling index values—SRSPoolIndex values. For example, for Nta=2, SRSPoolIndex value of 0 could be associated with the first (or the second) timing advance command T_{A,1} (or T_{A,2}) indicated in the first (or the second) RAR or absolute timing advance command MAC CE, while SRSPoolIndex value of 1 could be associated with the second (or the first) timing advance command T_{A,2} (or T_{A,1}) indicated in the second (or the first) RAR or absolute timing advance command MAC CE. For another example, for Nta=2, the SRSPoolIndex value associated with/linked to the serving cell PCI/value 0 of CORESETPoolIndex/value 0 of CORESETGroupIndex could be associated with the first (or the second) timing advance command T_{A,1} (or T_{A,2}) indicated in the first (or the second) RAR or absolute timing advance command MAC CE, while the SRSPoolIndex value associated with the non-serving cell PCI/value 1 of CORESETPoolIndex/value 1 of CORESETGroupIndex could be associated with the second (or the first) timing advance command T_{A,2} (or T_{A,1}) indicated in the second (or the first) RAR or absolute timing advance command MAC CE.

In yet another example (example I.8), the UE could be provided by the network, e.g., in one or more RARs or absolute timing advance command MAC CEs, one or more (e.g., Nta) SRS resource set indexes/IDs associated with the one or more timing advance commands indicated in the same RARs or absolute timing advance command MAC CEs; alternatively, the UE could use the one or more (e.g., Nta) SRS resource set indexes/IDs, e.g., indicated/reported in the transmission of Msg1 or MsgA, to associate the one or more timing advance commands indicated in the one or more RARs or absolute timing advance command MAC CEs.

For example, for Nta=2, the UE could be provided by the network Nta=2 SRS resource set indexes/IDs with a first SRS resource set index/ID indicated in the first RAR or the first absolute timing advance command MAC CE and associated with the first timing advance command indicated therein, and a second SRS resource set index/ID indicated in the second RAR or the second absolute timing advance command MAC CE and associated with the second timing advance command indicated therein; alternatively, the UE could use the Nta=2 SRS resource set indexes/IDs, e.g., indicated/reported in the transmission of Msg1 or MsgA, to associate the Nta=2 timing advance commands; the first SRS resource set index/ID or the lowest SRS resource set index/ID or the SRS resource set index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the first (or the second) RAR or absolute timing advance command MAC CE, while the second SRS resource set index/ID or the highest SRS resource set index/ID or the SRS resource set index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the second (or the first) RAR or absolute timing advance command MAC CE.

For another example, for Nta=2, the UE could be provided by the network, e.g., in the first RAR/absolute timing advance command MAC CE or the second RAR/absolute timing advance command MAC CE, a single SRS resource set index/ID associated with/linked to the serving cell PCI or a PCI different from the serving cell PCI; alternatively, the UE could use the SRS resource set index/ID associated with/linked to the serving cell PCI or the PCI different from the serving cell PCI, e.g., indicated/reported in the transmission of Msg1 or MsgA, to associate a timing advance command; for this case, the SRS resource set index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the first (or the second) RAR or absolute timing advance command MAC CE, while the SRS resource set index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the second (or the first) RAR or absolute timing advance command MAC CE.

In yet another example (example I.9), the UE could be provided by the network, e.g., in one or more RARs or absolute timing advance command MAC CEs, one or more (e.g., Nta) SRS resource group indexes/IDs associated with the one or more timing advance commands indicated in the same RARs or absolute timing advance command MAC CEs; alternatively, the UE could use the one or more (e.g., Nta) SRS resource group indexes/IDs, e.g., indicated/reported in the transmission of Msg1 or MsgA, to associate the one or more timing advance commands indicated in the one or more RARs or absolute timing advance command MAC CEs. As discussed above, a SRS resource group could comprise one or more SRS resources configured in a SRS resource set, and one SRS resource set could comprise one or more SRS resource groups.

For example, for Nta=2, the UE could be provided by the network Nta=2 SRS resource group indexes/IDs with a first SRS resource group index/ID indicated in the first RAR or absolute timing advance command MAC CE and associated with the first timing advance command indicated therein, and a second SRS resource group index/ID indicated in the second RAR/absolute timing advance command MAC CE and associated with the second timing advance command indicated therein; alternatively, the UE could use the Nta=2 SRS resource group indexes/IDs, e.g., indicated/reported in the transmission of Msg1 or MsgA, to associate the Nta=2 timing advance commands; the first SRS resource group index/ID or the lowest SRS resource group index/ID or the SRS resource group index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the first (or the second) RAR or absolute timing advance command MAC CE, while the second SRS resource group index/ID or the highest SRS resource group index/ID or the SRS resource group index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the second (or the first) RAR or absolute timing advance command MAC CE.

For another example, for Nta=2, the UE could be provided by the network, e.g., in the first RAR/absolute timing advance command MAC CE or the second RAR/absolute timing advance command MAC CE, a single SRS resource group index/ID associated with/linked to the serving cell PCI or a PCI different from the serving cell PCI; alternatively, the UE could use the SRS resource group index/ID associated with/linked to the serving cell PCI or the PCI different from the serving cell PCI, e.g., indicated/reported in the transmission of Msg1 or MsgA, to associate a timing advance command; for this case, the SRS resource group index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the first (or the second) RAR or absolute timing advance command MAC CE, while the SRS resource group index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the second (or the first) RAR or absolute timing advance command MAC CE.

In yet another example (example I.10), the UE could be provided by the network, e.g., in one or more RARs or one or more absolute timing advance command MAC CEs, one or more (e.g., Nta) SRS resource indexes/IDs in a SRS resource set associated with the one or more timing advance commands indicated in the same RARs or absolute timing advance command MAC CEs; alternatively, the UE could use the one or more (e.g., Nta) SRS resource indexes/IDs in a SRS resource set, e.g., indicated/reported in the transmission of Msg1 or MsgA, to associate the one or more timing advance commands indicated in the one or more RARs or absolute timing advance command MAC CEs.

For example, for Nta=2, the UE could be provided by the network Nta=2 SRS resource indexes/IDs with a first SRS resource index/ID indicated in the first RAR or the first absolute timing advance command MAC CE and associated with the first timing advance command indicated therein, and a second SRS resource index/ID indicated in the second RAR or the second absolute timing advance command MAC CE and associated with the second timing advance command indicated therein; alternatively, the UE could use the Nta=2 SRS resource indexes/IDs, e.g., indicated/reported in the transmission of Msg1 or MsgA, to associate the Nta=2 timing advance commands; the first SRS resource index/ID or the lowest SRS resource index/ID or the SRS resource index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the first (or the second) RAR or absolute timing advance command MAC CE, while the second SRS resource index/ID or the highest SRS resource index/ID or the SRS resource index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the second (or the first) RAR or absolute timing advance command MAC CE.

For another example, for Nta=2, the UE could be provided by the network, e.g., in the first RAR/absolute timing advance command MAC CE or the second RAR/absolute timing advance command MAC CE, a single SRS resource index/ID associated with/linked to the serving cell PCI or a PCI different from the serving cell PCI; alternatively, the UE could use the SRS resource index/ID associated with/linked to the serving cell PCI or the PCI different from the serving cell PCI, e.g., indicated/reported in the transmission of Msg1 or MsgA, to associate a timing advance command; for this case, the SRS resource index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the first (or the second) RAR or absolute timing advance command MAC CE, while the SRS resource index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the second (or the first) RAR or absolute timing advance command MAC CE.

In addition to the timing advance offset value(s), the UE could also receive from the network one or more (e.g., Nta=2) timing advance commands associated with one or more cells/TRPs including at least a serving cell PCI or one or more UE panels. For example, the UE could be provided by the network Nta=2 timing advance commands with a first timing advance command, T_{A,1}, provided in a RAR or an absolute timing advance command MAC CE for the serving cell PCI and a second timing advance command, T_{A,2}, provided in the same RAR or absolute timing advance command MAC CE for a non-serving cell PCI. For another example, the UE could be provided by the network Nta=2 timing advance commands with a first timing advance command, T_{A,1}, provided in a RAR or an absolute timing advance command MAC CE for a first UE antenna panel and a second timing advance command, T_{A,2}, provided in the same RAR or absolute timing advance command MAC CE for a second UE antenna panel.

For example, for Nta=2, the first or the second timing advance command (as described in the 3GPP TS 38.321) in case of a master/main RAR or in a master/main absolute timing advance command MAC CE, T_{A,1} or T_{A,2}, for a first or a second TAG indicates N_{TA,1} or N_{TA,2} values by index values of T_{A,1}=0, 1, . . . , 3846 or T_{A,2}=0, 1, 2 . . . , 3846, where an amount of the time alignment for the first or the second TAG with SCS of 2^{μ}·15 kHz is N_{TA,1}=T_{A,1}·16·64/2^{μ} or N_{TA,2}=T_{A,2}·16·64/2^{μ}. Here, N_{TA,1} or N_{TA,2} is defined in the 3GPP TS 38.211 and is relative to the SCS of the first uplink transmission from the UE after the reception of the master/main random access response or the master/main absolute timing advance command MAC CE.

In other cases, the first or the second timing advance command, T_{A,1} or T_{A,2}, for the first or the second TAG indicates adjustment of a current N_{TA,1} or N_{TA,2} value, N_{TA_old,1} or N_{TA_old,2} to the new N_{TA,1} or N_{TA,2} value, N_{TA_new,1} or N_{TA_new,2}, by index values of T_{A,1}=0, 1, . . . , 63 or T_{A,2}=0, 1, 2 . . . , 63, where for a SCS of 2^{μ}·15 kHz, N_{TA_new,1}=N_{TA_old,1}+(T_{A,1}−31)·16·64/2^{μ} or N_{TA_new,2}=N_{TA_old,2}+(T_{A,2}−31)·16·64/2^{μ}. Adjustment of an N_{TA,1} or N_{TA,2} value by a positive or a negative amount indicates advancing or delaying the uplink transmission timing for the first or the second TAG by a corresponding amount, respectively.

Along with the indication(s) of the timing advance commands, the UE could be provided by the network one or more entity IDs associated with the indicated timing advance commands. The UE could be indicated by the network the entity ID and the corresponding timing advance command in the same master/main RAR or absolute timing advance command MAC CE.

In one example (example a.1), an entity ID could correspond to a PCI. The UE could be provided by the network, e.g., in a master/main RAR or absolute timing advance command MAC CE, one or more (e.g., Nta) PCIs associated with the one or more timing advance commands indicated in the same master/main RAR or absolute timing advance command MAC CE; alternatively, the UE could use the one or more (e.g., Nta) PCIs, e.g., indicated/reported in the transmission of Msg1 or MsgA, to associate the one or more timing advance commands indicated in the master/main RAR or absolute timing advance command MAC CE.

For example, for Nta=2, the UE could be provided by the network Nta=2 PCIs with a first PCI indicated in the master/main RAR or absolute timing advance command MAC CE and associated with the first timing advance command indicated therein, and a second PCI indicated in the master/main RAR or absolute timing advance command MAC CE and associated with the second timing advance command indicated therein; alternatively, the UE could use the Nta=2 PCIs, e.g., indicated/reported in the transmission of Msg1 or MsgA, to associate the Nta=2 timing advance commands; the first PCI or the lowest PCI or the serving cell PCI could be associated with the first (or the second) timing advance command T_{A,1} (or T_{A,2}) indicated in the master/main RAR or absolute timing advance command MAC CE, while the second PCI or the highest PCI or the non-serving cell PCI could be associated with the second (or the first) timing advance command T_{A,2} (or T_{A,1}) indicated in the same master/main RAR or absolute timing advance command MAC CE.

For another example, for Nta=2, the UE could be provided by the network, e.g., in the master/main RAR or absolute timing advance command MAC CE, a single PCI different from the serving cell PCI; alternatively, the UE could use the PCI different from the serving cell PCI, e.g., indicated/reported in the transmission of Msg1 or MsgA, to associate a timing advance command; for this case, the serving cell PCI could be associated with the first (or the second) timing advance command T_{A,1} (or T_{A,2}) indicated in the master/main RAR or absolute timing advance command MAC CE, while the PCI different from the serving cell PCI could be associated with the second (or the first) timing advance command T_{A,2} (or T_{A,1}) indicated in the same master/main RAR or absolute timing advance command MAC CE.

In another example (example a.2), an entity ID could correspond to a PCI index corresponding/pointing to a PCI value in a list/set/pool of PCIs higher layer configured to the UE. The UE could be provided by the network, e.g., in a master/main RAR or absolute timing advance command MAC CE, one or more (e.g., Nta) PCI indexes associated with the one or more timing advance commands indicated in the same master/main RAR or absolute timing advance command MAC CE; alternatively, the UE could use the one or more (e.g., Nta) PCI indexes, e.g., indicated/reported in the transmission of Msg1 or MsgA, to associate the one or more timing advance commands indicated in the master/main RAR or absolute timing advance command MAC CE.

For example, for Nta=2, the UE could be provided by the network Nta=2 PCI indexes with a first PCI index indicated in the master/main RAR or timing advance command MAC CE and associated with the first timing advance command indicated therein, and a second PCI index indicated in the same master/main RAR or absolute timing advance command MAC CE and associated with the second timing advance command indicated therein; alternatively, the UE could use the Nta=2 PCI indexes, e.g., indicated/reported in the transmission of Msg1 or MsgA, to associate the Nta=2 timing advance commands; the first PCI index or the lowest PCI index or the PCI index corresponding/pointing to the lowest PCI or the serving cell PCI in the list/set/pool of PCIs higher layer configured to the UE could be associated with the first (or the second) timing advance command T_{A,1} (or T_{A,2}) indicated in the master/main RAR or absolute timing advance command MAC CE, while the second PCI index or the highest PCI index or the PCI index corresponding/pointing to the highest PCI or the non-serving cell PCI in the list/set/pool of PCIs higher layer configured to the UE could be associated with the second (or the first) timing advance command T_{A,2} (or T_{A,1}) indicated in the same master/main RAR or absolute timing advance command MAC CE.

For another example, for Nta=2, the UE could be provided by the network, e.g., in the main/master RAR or absolute timing advance command MAC CE, a single PCI index corresponding/pointing to a PCI different from the serving cell PCI in the list/set/pool of PCIs higher layer configured to the UE; alternatively, the UE could use the PCI index corresponding/pointing to the PCI different from the serving cell PCI in the list/set/pool of PCIs higher layer configured to the UE, e.g., indicated/reported in the transmission of Msg1 or MsgA, to associate a timing advance command; for this case, the serving cell PCI could be associated with the first (or the second) timing advance command T_{A,1} (or T_{A,2}) indicated in the master/main RAR or absolute timing advance command MAC CE, while the PCI indicated via the PCI index could be associated with the second (or the first) timing advance command T_{A,2} (or T_{A,1}) indicated in the same master/main RAR or absolute timing advance command MAC CE.

In yet another example (example a.3), an entity ID could correspond to a CORESETPoolIndex value. The UE could be configured with PDCCH-Config that contains two different CORESETPoolIndex values in CORESET. For example, for Nta=2, CORESETPoolIndex value of 0 could be associated with the first (or the second) timing advance command T_{A,1} (or T_{A,2}) indicated in a master/main RAR or absolute timing advance command MAC CE, while CORESETPoolIndex value of 1 could be associated with the second (or the first) timing advance command T_{A,2} (or T_{A,1}) indicated in the same master/main RAR or absolute timing advance command MAC CE. For another example, for Nta=2, the CORESETPoolIndex value associated with the serving cell PCI could be associated with the first (or the second) timing advance command T_{A,1} (or T_{A,2}) indicated in the master/main RAR or absolute timing advance command MAC CE, while the CORESETPoolIndex value associated with the non-serving cell PCI could be associated with the second (or the first) timing advance command T_{A,2} (or T_{A,1}) indicated in the same master/main RAR or absolute timing advance command MAC CE.

In yet another example (example a.4), an entity ID could correspond to a CORESETGroupIndex value. The UE could be configured with PDCCH-Config that contains two different CORESETGroupIndex values in CORESET. For example, for Nta=2, CORESETGroupIndex value of 0 could be associated with the first (or the second) timing advance command T_{A,1} (or T_{A,2}) indicated in a master/main RAR or absolute timing advance command MAC CE, while CORESETGroupIndex value of 1 could be associated with the second (or the first) timing advance command T_{A,2} (or T_{A,1}) indicated in the master/main RAR or absolute timing advance command MAC CE. For another example, for Nta=2, the CORESETGroupIndex value associated with the serving cell PCI could be associated with the first (or the second) timing advance command T_{A,1} (or T_{A,2}) indicated in the master/main RAR or absolute timing advance command MAC CE, while the CORESETGroupIndex value associated with the non-serving cell PCI could be associated with the second (or the first) timing advance command T_{A,2} (or T_{TA,1}) indicated in the same master/main RAR or absolute timing advance command MAC CE.

In yet another example (example a.5), an entity ID could correspond to a PCI indicator. The UE could be provided by the network, e.g., in a master/main RAR or absolute timing advance command MAC CE, one or more (e.g., Nta) PCI indicators associated with the one or more timing advance commands indicated in the same master/main RAR or absolute timing advance command MAC CE; alternatively, the UE could use the one or more (e.g., Nta) PCI indicators, e.g., indicated/reported in the transmission of Msg1 or MsgA, to associate the one or more timing advance commands indicated in the master/main RAR or absolute timing advance command MAC CE. In the present disclosure, a PCI indicator could be a one-bit flag indicator indicating either the serving cell PCI or the non-serving cell PCI or a multi-bit indicator with each state of the multi-bit indicator indicating a PCI.

For example, for Nta=2, the UE could be provided by the network Nta=2 PCI indicators with a first PCI indicator indicated in the master/main RAR or absolute timing advance command MAC CE and associated with the first timing advance command indicated therein, and a second PCI indicator indicated in the same master/main RAR or absolute timing advance command MAC CE and associated with the second timing advance command indicated therein; alternatively, the UE could use the Nta=2 PCI indicators, e.g., indicated/reported in the transmission of Msg1 or MsgA, to associate the Nta=2 timing advance commands; the first PCI indicator, and therefore, the corresponding PCI, CORESETPoolIndex, CORESETGroupIndex, TRP ID or TRP-specific higher layer signaling index, could be associated with the first (or the second) timing advance command T_{TA,1} (or T_{TA,2}) indicated in the master/main RAR or absolute timing advance command MAC CE, while the second PCI indicator, and therefore, the corresponding PCI, CORESETPoolIndex, CORESETGroupIndex, TRP ID or TRP-specific higher layer signaling index could be associated with the second (or the first) timing advance command T_{TA,2} (or T_{TA,1}) indicated in the same master/main RAR or absolute timing advance command MAC CE.

For a multi-panel UE, one or more timing advance commands could be indicated for or associated with an antenna panel at the UE. As discussed above, in the present disclosure, an antenna panel at the UE could be characterized/represented by a panel ID, a panel-specific higher layer signaling index SRSPoolIndex, a SRS resource set, a SRS resource group in a SRS resource set or one or more SRS resources in a SRS resource set.

In one example (example a.6), the UE could be provided by the network, e.g., in a master/main RAR or absolute timing advance command MAC CE, one or more (e.g., Nta) panel IDs associated with the one or more timing advance commands indicated in the same master/main RAR or absolute timing advance command MAC CE; alternatively, the UE could use the one or more (e.g., Nta) panel IDs, e.g., indicated/reported in the transmission of Msg1 or MsgA, to associate the one or more timing advance commands indicated in the master/main RAR or absolute timing advance command MAC CE.

For example, for Nta=2, the UE could be provided by the network Nta=2 panel IDs with a first panel ID indicated in the master/main RAR or absolute timing advance command MAC CE and associated with the first timing advance command indicated therein, and a second panel ID indicated in the same master/main RAR or absolute timing advance command MAC CE and associated with the second timing advance command indicated therein; alternatively, the UE could use the Nta=2 panel IDs, e.g., indicated/reported in the transmission of Msg1 or MsgA, to associate the Nta=2 timing advance commands; the first panel ID or the lowest panel ID or the panel ID associated with/linked to the serving cell PCI/value 0 of CORESETPoolIndex/value 0 of CORESETGroupIndex could be associated with the first (or the second) timing advance command T_{A,1} (or T_{A,2}) indicated in the master/main RAR or absolute timing advance command MAC CE, while the second panel ID or the highest panel ID or the panel ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the same master/main RAR or absolute timing advance command MAC CE.

For another example, for Nta=2, the UE could be provided by the network, e.g., in the master/main RAR or absolute timing advance command MAC CE, a single panel ID associated with/linked to the serving cell PCI or a PCI different from the serving cell PCI; alternatively, the UE could use the panel ID associated with/linked to the serving cell PCI or the PCI different from the serving cell PCI, e.g., indicated/reported in the transmission of Msg1 or MsgA, to associate a timing advance command; for this case, the panel ID associated with/linked to the serving cell PCI/value 0 of CORESETPoolIndex/value 0 of CORESETGroupIndex could be associated with the first (or the second) timing advance command T_{A,1} (or T_{A,2}) indicated in the master/main RAR or absolute timing advance command MAC CE, while the panel ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the same master/main RAR or absolute timing advance command MAC CE.

In another example (example a.7), the UE could be configured with at least two UE panel-specific higher layer signaling index values—SRSPoolIndex values. For example, for Nta=2, SRSPoolIndex value of 0 could be associated with the first (or the second) timing advance command T_{A,1} (or T_{A,2}) indicated in a master/main RAR or absolute timing advance command MAC CE, while SRSPoolIndex value of 1 could be associated with the second (or the first) timing advance command T_{A,2} (or T_{A,1}) indicated in the same master/main RAR or absolute timing advance command MAC CE. For another example, for Nta=2, the SRSPoolIndex value associated with/linked to the serving cell PCI/value 0 of CORESETPoolIndex/value 0 of CORESETGroupIndex could be associated with the first (or the second) timing advance command T_{A,1} (or T_{A,2}) indicated in the master/main RAR or absolute timing advance command MAC CE, while the SRSPoolIndex value associated with the non-serving cell PCI/value 1 of CORESETPoolIndex/value 1 of CORESETGroupIndex could be associated with the second (or the first) timing advance command T_{A,2} (or T_{A,1}) indicated in the same master/main RAR or absolute timing advance command MAC CE.

In yet another example (example a.8), the UE could be provided by the network, e.g., in a master/main RAR or absolute timing advance command MAC CE, one or more (e.g., Nta) SRS resource set indexes/IDs associated with the one or more timing advance commands indicated in the same master/main RAR or absolute timing advance command MAC CE; alternatively, the UE could use the one or more (e.g., Nta) SRS resource set indexes/IDs, e.g., indicated/reported in the transmission of Msg1 or MsgA, to associate the one or more timing advance commands indicated in the master/main RAR or absolute timing advance command MAC CE.

For example, for Nta=2, the UE could be provided by the network Nta=2 SRS resource set indexes/IDs with a first SRS resource set index/ID indicated in the master/main RAR or absolute timing advance command MAC CE and associated with the first timing advance command indicated therein, and a second SRS resource set index/ID indicated in the same master/main RAR or absolute timing advance command MAC CE and associated with the second timing advance command indicated therein; alternatively, the UE could use the Nta=2 SRS resource set indexes/IDs, e.g., indicated/reported in the transmission of Msg1 or MsgA, to associate the Nta=2 timing advance commands; the first SRS resource set index/ID or the lowest SRS resource set index/ID or the SRS resource set index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the master/main RAR or absolute timing advance command MAC CE, while the second SRS resource set index/ID or the highest SRS resource set index/ID or the SRS resource set index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the same master/main RAR or absolute timing advance command MAC CE.

For another example, for Nta=2, the UE could be provided by the network, e.g., in the master/main RAR/absolute timing advance command MAC CE, a single SRS resource set index/ID associated with/linked to the serving cell PCI or a PCI different from the serving cell PCI; alternatively, the UE could use the SRS resource set index/ID associated with/linked to the serving cell PCI or the PCI different from the serving cell PCI, e.g., indicated/reported in the transmission of Msg1 or MsgA, to associate a timing advance command; for this case, the SRS resource set index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the master/main RAR or absolute timing advance command MAC CE, while the SRS resource set index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the same master/main RAR or absolute timing advance command MAC CE.

In yet another example (example a.9), the UE could be provided by the network, e.g., in one or more RARs or absolute timing advance command MAC CEs, one or more (e.g., Nta) SRS resource group indexes/IDs associated with the one or more timing advance commands indicated in the same RARs or absolute timing advance command MAC CEs; alternatively, the UE could use the one or more (e.g., Nta) SRS resource group indexes/IDs, e.g., indicated/reported in the transmission of Msg1 or MsgA, to associate the one or more timing advance commands indicated in the one or more RARs or absolute timing advance command MAC CEs. As discussed above, a SRS resource group could comprise one or more SRS resources configured in a SRS resource set, and one SRS resource set could comprise one or more SRS resource groups.

For example, for Nta=2, the UE could be provided by the network Nta=2 SRS resource group indexes/IDs with a first SRS resource group index/ID indicated in the first RAR or absolute timing advance command MAC CE and associated with the first timing advance command indicated therein, and a second SRS resource group index/ID indicated in the second RAR/absolute timing advance command MAC CE and associated with the second timing advance command indicated therein; alternatively, the UE could use the Nta=2 SRS resource group indexes/IDs, e.g., indicated/reported in the transmission of Msg1 or MsgA, to associate the Nta=2 timing advance commands; the first SRS resource group index/ID or the lowest SRS resource group index/ID or the SRS resource group index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the master/main RAR or absolute timing advance command MAC CE, while the second SRS resource group index/ID or the highest SRS resource group index/ID or the SRS resource group index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the same master/main RAR or absolute timing advance command MAC CE.

For another example, for Nta=2, the UE could be provided by the network, e.g., in the master/main RAR/absolute timing advance command MAC CE, a single SRS resource group index/ID associated with/linked to the serving cell PCI or a PCI different from the serving cell PCI; alternatively, the UE could use the SRS resource group index/ID associated with/linked to the serving cell PCI or the PCI different from the serving cell PCI, e.g., indicated/reported in the transmission of Msg1 or MsgA, to associate a timing advance command; for this case, the SRS resource group index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the master/main RAR or absolute timing advance command MAC CE, while the SRS resource group index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the same master/main RAR or absolute timing advance command MAC CE.

In yet another example (example a.10), the UE could be provided by the network, e.g., in a master/main RAR or absolute timing advance command MAC CE, one or more (e.g., Nta) SRS resource indexes/IDs in a SRS resource set associated with the one or more timing advance commands indicated in the same master/main RAR or absolute timing advance command MAC CE; alternatively, the UE could use the one or more (e.g., Nta) SRS resource indexes/IDs in a SRS resource set, e.g., indicated/reported in the transmission of Msg1 or MsgA, to associate the one or more timing advance commands indicated in the master/main RAR or absolute timing advance command MAC CE.

For example, for Nta=2, the UE could be provided by the network Nta=2 SRS resource indexes/IDs with a first SRS resource index/ID indicated in the master/main RAR or absolute timing advance command MAC CE and associated with the first timing advance command indicated therein, and a second SRS resource index/ID indicated in the same master/main RAR or absolute timing advance command MAC CE and associated with the second timing advance command indicated therein; alternatively, the UE could use the Nta=2 SRS resource indexes/IDs, e.g., indicated/reported in the transmission of Msg1 or MsgA, to associate the Nta=2 timing advance commands; the first SRS resource index/ID or the lowest SRS resource index/ID or the SRS resource index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the master/main RAR or absolute timing advance command MAC CE, while the second SRS resource index/ID or the highest SRS resource index/ID or the SRS resource index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the same master/main RAR or absolute timing advance command MAC CE.

For another example, for Nta=2, the UE could be provided by the network, e.g., in the master/main RAR/absolute timing advance command MAC CE, a single SRS resource index/ID associated with/linked to the serving cell PCI or a PCI different from the serving cell PCI; alternatively, the UE could use the SRS resource index/ID associated with/linked to the serving cell PCI or the PCI different from the serving cell PCI, e.g., indicated/reported in the transmission of Msg1 or MsgA, to associate a timing advance command; for this case, the SRS resource index/ID associated with/linked to the serving cell PCI/value 0 of CORESETPoolIndex/value 0 of CORESETGroupIndex could be associated with the first (or the second) timing advance command T_{A,1} (or T_{A,2}) indicated in the master/main RAR or absolute timing advance command MAC CE, while the SRS resource index/ID associated with/linked to the non-serving cell PCI/value 1 of CORESETPoolIndex/value 1 of CORESETGroupIndex could be associated with the second (or the first) timing advance command T_{A,2} (or T_{A,1}) indicated in the same master/main RAR or absolute timing advance command MAC CE.

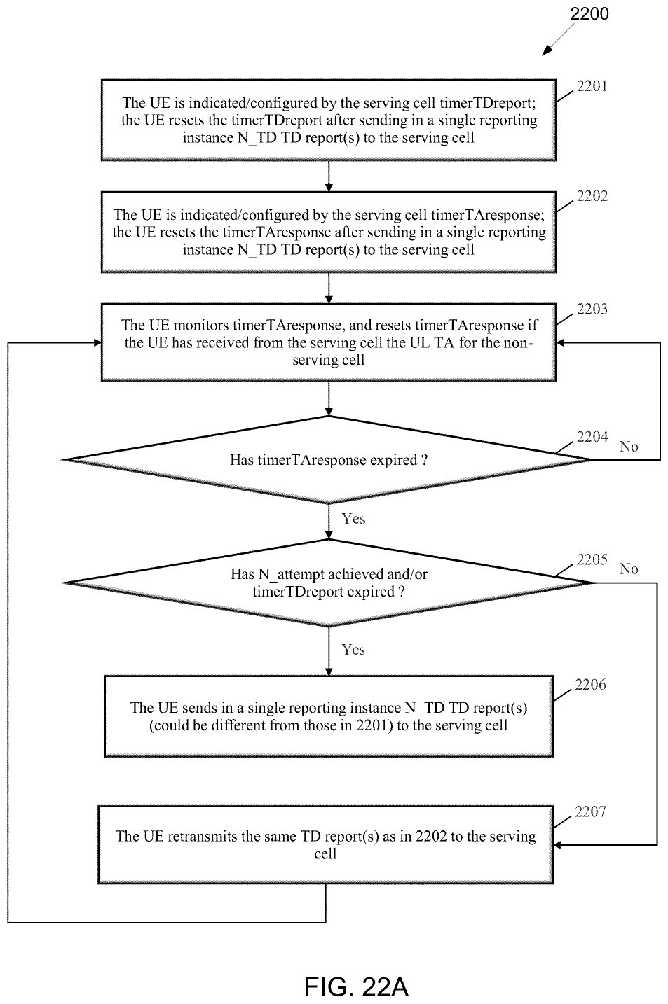

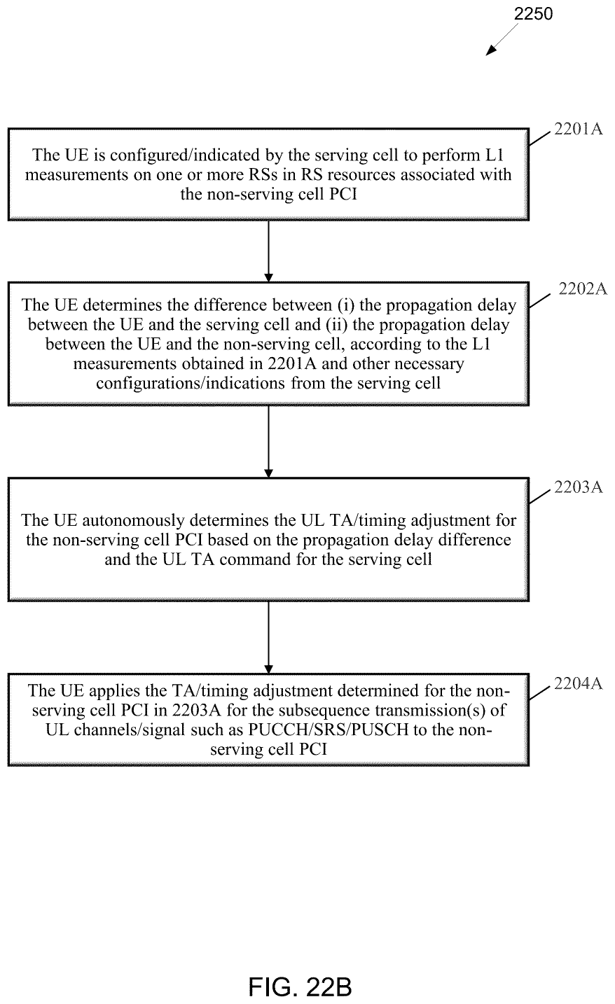

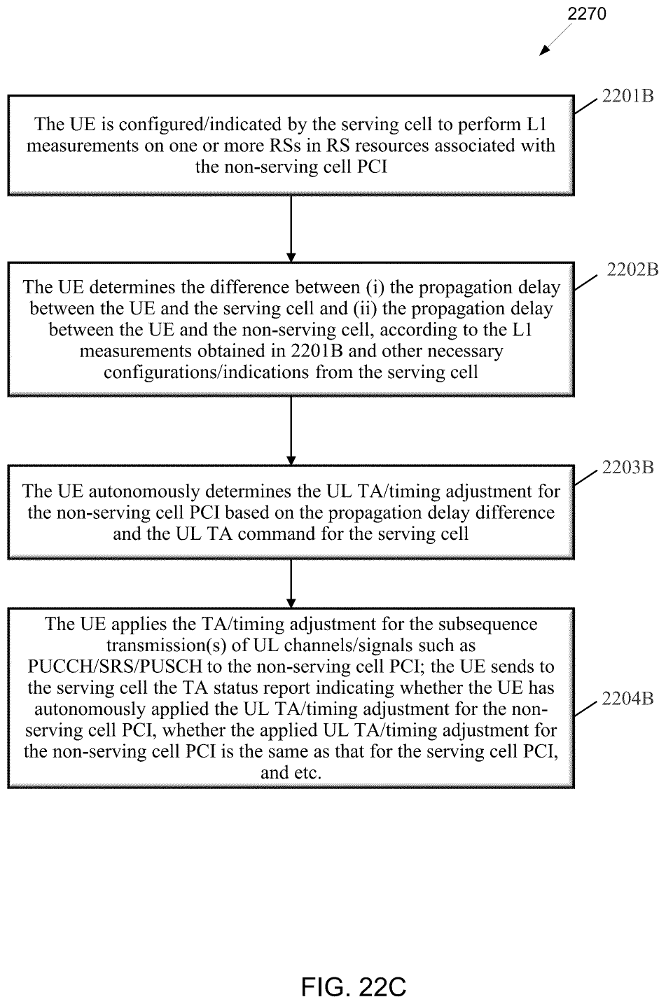

FIG. 22A illustrates a flowchart of a method 2200 for reporting to the serving cell the timing difference (TD) according to embodiments of the present disclosure. For example, the method 2200 as may be performed by a UE (e.g., 111-116 as illustrated in FIG. 1). An embodiment of the method 2200 shown in FIG. 22A is for illustration only. One or more of the components illustrated in FIG. 22A can be implemented in specialized circuitry configured to perform the noted functions or one or more of the components can be implemented by one or more processors executing instructions to perform the noted functions.

As illustrated in FIG. 22A, in step 2201, the UE is indicated/configured by the serving cell timerTDreport; the UE resets the timerTDreport after sending in a single reporting instance N_TD TDs to the serving cell. In step 2202, the UE is indicated/configured by the serving cell timerTAresponse; the UE resets the timerTAresponse after sending in a single reporting instance N_TD TDs to the serving cell. In step 2203, the UE monitors timerTAresponse, and resets timerTAresponse if the UE has received from the serving cell the UL TA for the non-serving cell. In step 2204, the UE determines whether the timerTAresponse has expired. In step 2205, the UE determines whether the N_attempt achieved and/or timerTDreport has expired. In step 2206, the UE sends in a single reporting instance N_TD TDs (could be different from those in 2201) to the serving cell. In step 2207, the UE retransmits the same TDs as in step 2202 to the serving cell.

The UE could expect to receive from the serving cell the UL TA command for the non-serving cell within a certain time window after the UE has sent to the serving cell the TD(s). Otherwise, if the UE does not receive any response from the serving cell within that time window, the UE would retransmit the TD(s) to the serving cell. After a few attempts/retransmissions (denoted by N_attempt) and/or timerTDreport expires, the UE could start sending different TD(s) to the serving cell.

For instance, the UE could be configured/indicated by the serving cell a timer, denoted by timerTAresponse, to track the TA command from the serving cell. As soon as the UE has received from the serving cell the TA for the non-serving cell, the UE would reset timerTAresponse. The UE would retransmit the TD(s) if timerTAresponse expires. The above described design procedure is depicted in FIG. 22A.

For the first or second timing advance command T_{A,1} or T_{A,2} received on uplink slot n and for a transmission other than a PUSCH scheduled by a RAR UL grant or a fallbackRAR UL grant as described in the 3GPP TS 38.213 clause 8.2A or 8.3, or a PUCCH with HARQ-ACK information in response to a successRAR as described in the 3GPP TS 38.213 clause 8.2A, the corresponding adjustment of the uplink transmission timing applies from the beginning of uplink slot n+k+1 where k=┌Nₛₗₒₜ^{subframe,μ}·(N_{T,1}+N_{T,2}+N_{TA,max}+0.5)/T^{sf}┐, N_{T,1} is a time duration in msec of N₁ symbols corresponding to a PDSCH processing time for UE processing capability 1 when additional PDSCH DM-RS is configured, N_{T,2} is a time duration in msec of N₂ symbols corresponding to a PUSCH preparation time for UE processing capability 1, N_{TA,max} is the maximum timing advance value in msec that can be provided by a TA command field of K bits (e.g., K=12), Nₛₗₒₜ^{subframe,μ} represents the number of slots per subframe, and T_{sf} is the subframe duration of 1 msec.

For the first timing advance command T_{A,1}, N₁ and N₂ could be determined with respect to the minimum SCS among the SCSs of all configured UL BWPs for all uplink carriers in the first TAG or in the first and second TAGs and of all configured DL BWPs for the corresponding downlink carriers, slot n and Nₛₗₒₜ^{subframe,μ} could be determined with respect to the minimum SCS among the SCSs of all configured UL BWPs for all uplink carriers in the first TAG or in the first and second TAGs, and N_{TA,max} could be determined with respect to the minimum SCS among the SCSs of all configured UL BWPs for all uplink carriers in the first TAG or in the first and second TAGs and for all configured initial UL BWPs provided by the higher layer parameter initialUplinkBWP.

For the second timing advance command T_{A,2}, N₁ and N₂ could be determined with respect to the minimum SCS among the SCSs of all configured UL BWPs for all uplink carriers in the second TAG or in the first and second TAGs and of all configured DL BWPs for the corresponding downlink carriers, slot n and Nₛₗₒₜ^{subframe,μ} could be determined with respect to the minimum SCS among the SCSs of all configured UL BWPs for all uplink carriers in the second TAG or in the first and second TAGs, and N_{TA,max} could be determined with respect to the minimum SCS among the SCSs of all configured UL BWPs for all uplink carriers in the second TAG or in the first and second TAGs and for all configured initial UL BWPs provided by the higher layer parameter initialUplinkBWP. Furthermore, the uplink slot n is the last slot among uplink slot(s) overlapping with the slot(s) of PDSCH reception assuming T_{TA}=0, where the PDSCH provides the timing advance command and T_{TA} is defined in the 3GPP TS 38.211 clause 4.

If a UE changes an active UL BWP between a time of one or more timing advance commands reception (provided in one or more RARs or absolute timing advance command MAC CEs) and a time of applying the corresponding adjustment(s) for the uplink transmission timing(s), the UE determines one or more of the timing advance command values based on the SCS of the new active UL BWP. If the UE changes an active UL BWP after applying adjustment(s) for the uplink transmission timing(s), the UE assumes same absolute timing advance command value(s) before and after the active UL BWP change. Specifically, for Nta=2:

If a UE changes an active UL BWP between a time of the first or the second timing advance command reception and a time of applying a corresponding adjustment for the uplink transmission timing, the UE determines the first or the second timing advance command value based on the SCS of the new active UL BWP. If the UE changes an active UL BWP after applying an adjustment for the uplink transmission timing, the UE assumes a same first or second absolute timing advance command value before and after the active UL BWP change.

If a UE changes an active UL BWP between a time of the first or the second timing advance command reception and a time of applying a corresponding adjustment for the uplink transmission timing, the UE determines the first and the second timing advance command values based on the SCS of the new active UL BWP. If the UE changes an active UL BWP after applying an adjustment for the uplink transmission timing, the UE assumes a same first or second absolute timing advance command value before and after the active UL BWP change.

If the received downlink timing changes and is not compensated or is only partly compensated by the uplink timing adjustment(s) without the first or the second timing advance command, i.e., T_{A,1} or T_{A,2}, as described in the 3GPP TS 38.133 clause 10, the UE changes N_{TA,1} or N_{TA,2} accordingly. Furthermore, if two adjacent slots overlap due to the first or the second timing advance command (i.e., T_{A,1} or T_{A,2}), the latter slot is reduced in duration relative to the former slot.

In another embodiment, the UE could autonomously compute and apply the UL TA(s)/timing adjustment(s) for the non-serving cell PCI(s) by themselves, without the need to send to the network (e.g., the serving cell) the TD report, or transmit to the network (e.g., the serving cell) in Msg1 or MsgA the PRACH preambles associated with the non-serving cell PCI(s), or wait for the TA command for the non-serving cell PCI(s) provided by the serving cell in RAR or absolute timing advance command MAC CE. That is, the UE could execute step 801 and step 802 in FIG. 8 to derive the UL TA(s)/timing adjustment(s) for the non-serving cell PCI(s), without relying on step 803 and step 804 in FIG. 8. In FIG. 22B, a design example of UE autonomously determining and applying the UL TA(s)/timing adjustment(s) for the non-serving cell PCI(s) is presented.

FIG. 22B illustrates a flowchart of a method 2250 for UE determining and applying the UL timing adjustments according to embodiments of the present disclosure. For example, the method 2250 as may be performed by a UE (e.g., 111-116 as illustrated in FIG. 1). An embodiment of the method 2250 shown in FIG. 22B is for illustration only. One or more of the components illustrated in FIG. 22B can be implemented in specialized circuitry configured to perform the noted functions or one or more of the components can be implemented by one or more processors executing instructions to perform the noted functions.

As illustrated in FIG. 22B, steps 2201A and 2202A are the same as steps 801 and 802 in FIG. 8. In steps 2203A and 2204A, the UE computes the UL TA/timing adjustment for the non-serving cell PCI based on the estimated propagation delay difference and the received UL TA command for the serving cell PCI provided in RAR or absolute timing advance command MAC CE. For example, assume that the serving cell and the non-serving cell are synchronized (i.e., their true time offset/drift t_offset=0), and the UE has obtained the propagation delay difference delta_d from measuring the non-serving cell RSs based on the configured non-serving cell RS information. For example, denote the TA value for the serving cell by t_SC. The UE could estimate the propagation delay between the non-serving cell and the UE as d1=t_SC+delta_d.

The UE could then obtain the TA/timing adjustment value for the non-serving cell according to t_NSC=2*d1 (step 2003A), which is the round-trip delay between the UE and the non-serving cell. The UE could then apply the TA/timing adjustment obtained in step 2203A for the subsequent transmissions of UL channels/signals such as PUCCH/SRS/PUSCH to the non-serving cell gNB, as illustrated in step 2204A in FIG. 22B. There could be various reasons that the UE would autonomously compute and apply the UL TA/timing adjustment for the non-serving cell.

For example, the UE could compute and apply the UL TA/timing adjustment for the non-serving cell by themselves if they have not received any UL TA command associated with/for the non-serving cell PCI. For another example, if delta_d is smaller than the CP length, the UE could decide not reporting it to the serving cell, or reporting to the serving cell that the propagation delay difference is zero (as illustrated in FIG. 16). In this case, the UE could compute and apply the UL TA/timing adjustment for the non-serving cell (same as the TA for the serving cell) by themselves.

Yet in another embodiment, the UE could indicate to the network, e.g., transmit to the serving cell, whether the UE has autonomously applied the UL TA/timing adjustment for the non-serving cell PCI(s), whether the applied UL TA/timing adjustment for the non-serving cell PCI(s) is the same as that for the serving cell PCI, and etc. (referred to as UL TA status report for the non-serving cell PCI(s)); this indication could be transmitted in part of CSI/beam report or PUSCH; this indication could be in form of a one-bit flag with 1 (or 0) indicating that the UE has autonomously applied the UL TA/timing adjustment for the non-serving cell PCI(s) and 0 (or 1) indicating otherwise.

FIG. 22C illustrates another flowchart of a method 2270 for UE determining and applying the UL timing adjustments according to embodiments of the present disclosure. For example, the method 2270 as may be performed by a UE (e.g., 111-116 as illustrated in FIG. 1). An embodiment of the method 2270 shown in FIG. 22C is for illustration only. One or more of the components illustrated in FIG. 22C can be implemented in specialized circuitry configured to perform the noted functions or one or more of the components can be implemented by one or more processors executing instructions to perform the noted functions.

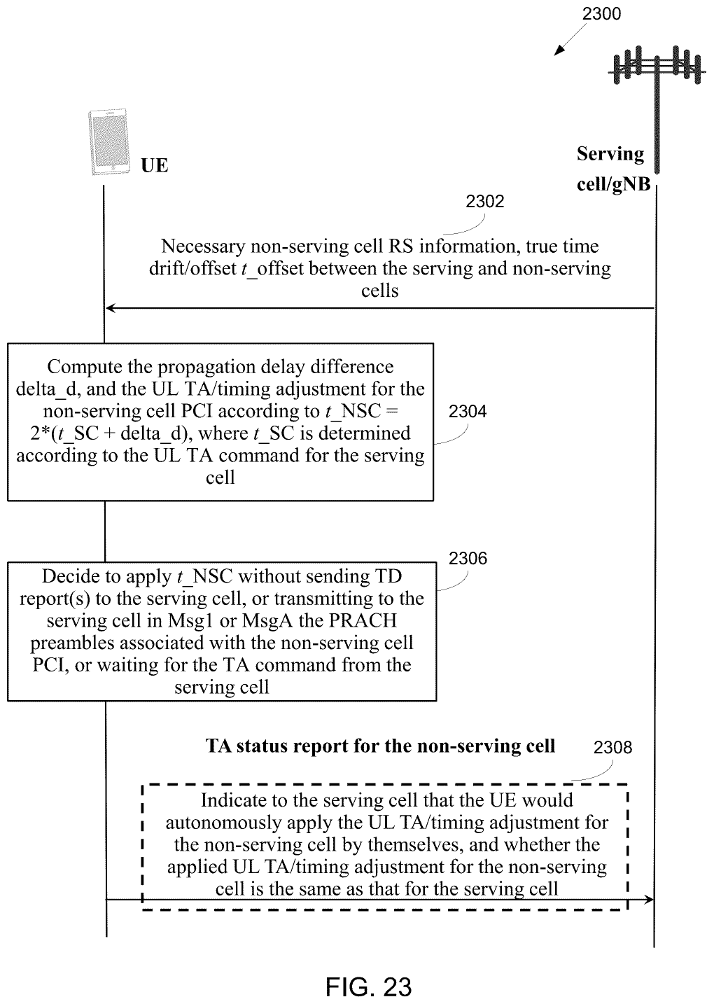

In FIG. 22C, a modified algorithm flowchart to that shown in FIG. 22B is presented. Different from step 2204A in FIG. 22B, in step 2204B in FIG. 22C, the UE would send to the serving cell the TA status report for the non-serving cell PCI. The corresponding signaling procedure between the UE and the serving cell is depicted in FIG. 23. As shown in FIG. 23, if delta_D or delta_d is negligible, e.g., smaller than the CP length as shown in FIG. 16, the UE could indicate to the serving cell that the UE has autonomously applied for the non-serving cell the same TA as that for the serving cell (in part of the TA status report for the non-serving cell).

As illustrated in FIG. 22C, in step 2201B, the UE is configured by the serving cell to perform L1 measurements on one or more RSs in RS resources associated with the non-serving cell PCI. In step 2202B, the UE determines the difference between (i) the propagation delay between the UE and the serving cell and (ii) the propagation delay between the UE and the non-serving cell, according to the L1 measurements obtained in 2201B and other necessary configurations/indications from the serving cell. In step 2203B, the UE autonomously determines the UL TA/timing adjustment for the non-serving cell PCI based on the propagation delay difference and the UL TA command for the serving cell. In step 2204B, the UE applies the TA/timing adjustment for the subsequence transmission(s) of UL channels/signals such as PUCCH/SRS/PUSCH to the non-serving cell PCI; the UE sends to the serving cell the TA status report indicating whether the UE has autonomously applied the UL TA/timing adjustment for the non-serving cell PCI, whether the applied UL TA/timing adjustment for the non-serving cell PCI is the same as that for the serving cell PCI, and etc.

FIG. 23 illustrates an example of signaling flow 2300 for UE determining and applying the UL timing adjustments according to embodiments of the present disclosure. For example, the signaling flow 2300 as may be performed by a UE (e.g., 111-116 as illustrated in FIG. 1) and a BS (e.g., 101-103 as illustrated in FIG. 1). An embodiment of the signaling flow 2300 shown in FIG. 23 is for illustration only. One or more of the components illustrated in FIG. 23 can be implemented in specialized circuitry configured to perform the noted functions or one or more of the components can be implemented by one or more processors executing instructions to perform the noted functions.

As illustrated in FIG. 23, in step 2302, a UE receives necessary non-serving cell RS information, true time drift/offset t_offset between the serving and non-serving cells. In step 2304, the UE computes the propagation delay difference delta_d, and the UL TA/timing adjustment for the non-serving cell PCI according to t_NSC=2*(t_SC+delta_d), where t_SC is determined according to the UL TA command for the serving cell. In step 2306, the UE decides to apply t_NSC without reporting TD(s) to the serving cell, or transmitting to the serving cell in Msg1 or MsgA the PRACH preambles associated with the non-serving cell PCI, or waiting for the TA command from the serving cell. In step 2308, the UE sends an indication to the serving cell that the UE would autonomously apply the UL TA/timing adjustment for the non-serving cell by themselves, and whether the applied UL TA/timing adjustment for the non-serving cell is the same as that for the serving cell.

The UE could be configured/indicated by the network/serving cell gNB (i) whether the UE needs to send to the serving cell the TD(s) or transmit to the serving cell in Msg1 or MsgA the PRACH preambles associated the non-serving cell PCI and wait for the UL TA command for the non-serving cell PCI, or (ii) whether the UE could autonomously determine and apply the UL TA/timing adjustment for the non-serving cell, in either an explicit or an implicit manner.

For instance, a new RRC parameter, intercellTDreport, could be defined and indicated in CSI resource setting provided by CSI-ResourceConfig or CSI reporting setting provided by CSI-ReportConfig. If intercellTDreport is “enabled” by the serving cell gNB, the UE is required to report the TD(s) to the serving cell or transmit to the serving cell in Msg1 or MsgA the PRACH preambles associated with the non-serving cell PCI and receive from the serving cell the UL TA/timing adjustment for the non-serving cell. Otherwise, i.e., if intercellTDreport is set to “disabled” by the serving cell gNB, the UE could autonomously determine and apply the UL TA/timing adjustment for the non-serving cell by themselves.

For another example, if the UE is not indicated by the serving cell any time drift/offset between the serving cell and the non-serving cell, the UE could implicitly know that they need to report the TD(s) to the serving cell or transmit to the serving cell in Msg1 or MsgA the PRACH preambles associated with the non-serving cell PCI and receive from the serving cell the UL TA/timing adjustment for the non-serving cell.

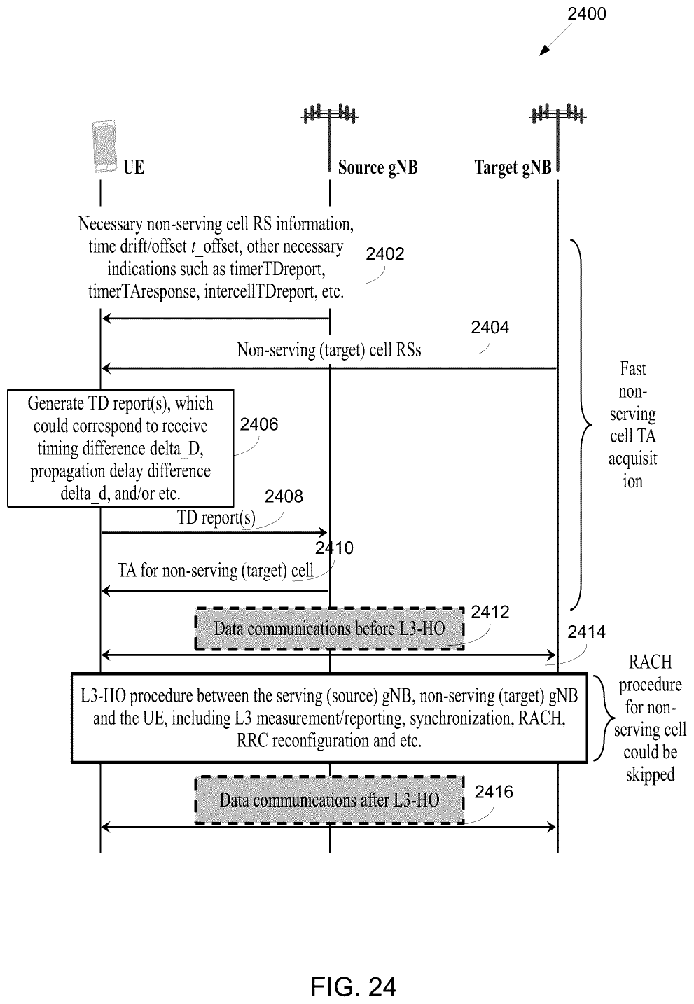

FIG. 24 illustrates an example of signaling flow 2400 for RACH-less inter-cell mobility according to embodiments of the present disclosure. For example, the signaling flow 2400 as may be performed by a UE (e.g., 111-116 as illustrated in FIG. 1) and BSs (e.g., 101-103 as illustrated in FIG. 1). An embodiment of the signaling flow 2400 shown in FIG. 24 is for illustration only. One or more of the components illustrated in FIG. 24 can be implemented in specialized circuitry configured to perform the noted functions or one or more of the components can be implemented by one or more processors executing instructions to perform the noted functions.

The above described RACH-less fast TA acquisition strategies could pave the way for the UE to transmit/receive data/control channels to/from the non-serving (target) cell/gNB prior to triggering and completing the L3-HO. As can be seen from the example shown in FIG. 24, by employing the proposed fast TA acquisition method, the UE could receive from the serving cell/gNB the UL TA command for the non-serving cell without initiating the RACH procedure with the non-serving cell, which would occur during the L3-HO.

Under certain settings, the RACH procedure with the non-serving cell/gNB could be completely skipped during the L3-HO such that after the completion of the L3-HO, the UE could apply the TA obtained prior to the L3-HO (for the non-serving cell) for the current serving/source cell. By circumventing the RACH procedure to obtain the non-serving cell's TA, the overall access latency could be reduced.

As illustrated in FIG. 24, in step 2402, a UE receives necessary non-serving cell RS information, time drift/offset t_offset, other necessary indications such as timerTDreport, timerTAresponse, intercellTDreport, etc. In step 2404, the UE measures non-serving (target) cell RSs. In step 2406, the UE generates TD(s)/TD report(s), which could correspond to receive timing difference delta_D, propagation delay difference delta_d, and/or etc. In step 2408, the UE sends the TD(s)/TD report(s). In step 2410, the UE receives UL TA/timing adjustment for non-serving (target) cell. In step 2412, the UE and a target gNB perform data communication before L3-HO. In step 2414, the UE and the target gNB performs an L3-HO procedure between the serving (source) gNB, non-serving (target) gNB and the UE, including L3 measurement/reporting, synchronization, RACH, RRC reconfiguration and etc. In step 2416, the UE and the target gNB perform the data communications after L3-HO.

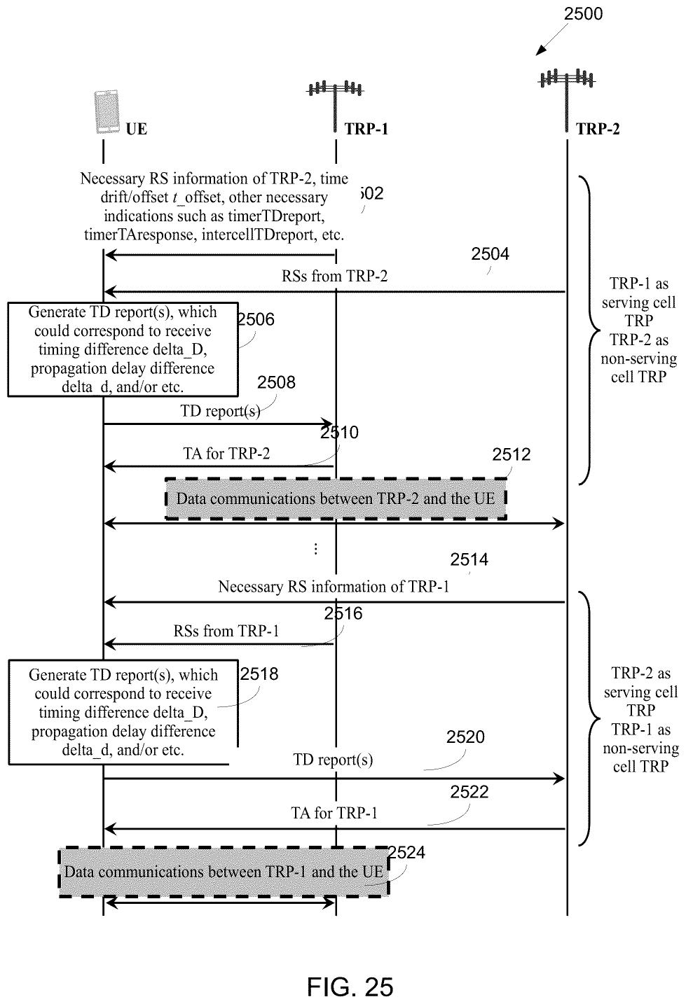

FIG. 25 illustrates another example of signaling flow 2500 for RACH-less inter-cell mobility according to embodiments of the present disclosure. For example, the method 2500 as may be performed by a UE (e.g., 111-116 as illustrated in FIG. 1) and BSs (e.g., 101-103 as illustrated in FIG. 1). An embodiment of the signaling flow 2500 shown in FIG. 25 is for illustration only. One or more of the components illustrated in FIG. 25 can be implemented in specialized circuitry configured to perform the noted functions or one or more of the components can be implemented by one or more processors executing instructions to perform the noted functions.

In FIG. 25, an example of applying the developed fast TA acquisition strategies for dynamic inter-cell operation is presented. As indicated in FIG. 25, depending on the channel conditions, the UE could dynamically switch between TRP-1 and TRP-2 for data and control channels communications, and TRP-1 and TRP-2 would take turns in acting as the serving cell TRP and the non-serving cell TRP. This setting could also be referred to as inter-cell dynamic point selection (DPS) or inter-cell dynamic TRP selection.

To better enable the inter-cell DPS operation, the UE needs to know/monitor the UL TA for the non-serving cell TRP such that as soon as the non-serving cell TRP becomes to the serving cell TRP, the UE could start to communicate with the serving cell TRP with minimal delay. As can be seen from FIG. 25, if TRP-1 is the serving cell TRP and TRP-2 is the non-serving cell TRP, the UE could indicate to TRP-1 the TD(s) and receive from TRP-1 the UL TA for the non-serving cell TRP-2. Similarly, if TRP-2 is the serving cell TRP while TRP-1 is the non-serving cell TRP, the UE could indicate to TRP-2 the TD(s) and receive from TRP-2 the UL TA for the non-serving cell TRP-1. Overall, the UE could completely circumvent the RACH procedure (either contention-based or contention-free) to acquire the TA for the non-serving cell TRP, which in turn, would reduce the access delay especially when the inter-cell DPS operation is enabled.

As illustrated in FIG. 25, in step 2502, the UE receives necessary RS information of TRP-2, time drift/offset t_offset, other necessary indications such as timerTDreport, timerTAresponse, intercellTDreport, etc. In step 2504, the UE measures RSs from TRP-2. In step 2506, the UE generates TD(s)/TD report(s), which could correspond to receive timing difference delta_D, propagation delay difference delta_d, and/or etc. In step 2508, the UE sends TD(s)/TD report(s). In step 2510, the UE receives UL TA/timing adjustment for TRP-2. In step 2512, the UE and the TRP-2 performs data communications. In step 2514, the UE receives necessary RS information of TRP-1. In step 2516, the UE measures RSs from the TRP-1. In step 2518, the UE generates TD(s)/TD report(s), which could correspond to receive timing difference delta_D, propagation delay difference delta_d, and/or etc. In step 2020, the UE sends TD(s)/TD report(s). In step 2522, the UE receives UL TA/timing adjustment for the TRP-1. In step 2524, the UE and the TRP-1 performs data communications.

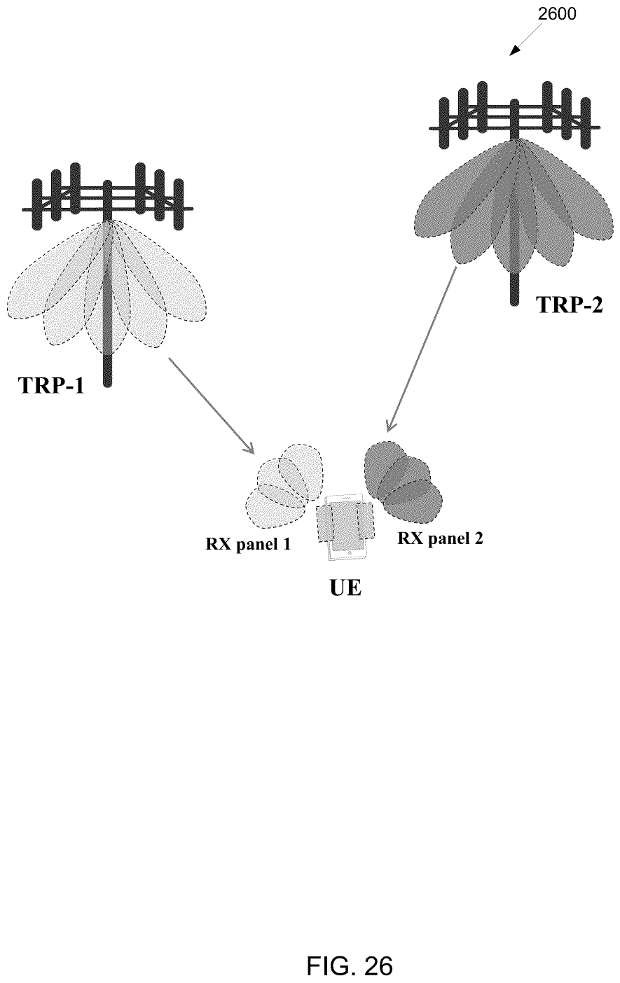

FIG. 26 illustrates an example of multi-TRP multi-beam operation 2600 according to embodiments of the present disclosure. An embodiment of the multi-TRP multi-beam operation 2600 shown in FIG. 26 is for illustration only.

The above described fast TA acquisition strategies could be applied to other deployment scenarios such as multi-TRP operation as well. In FIG. 26, a conceptual example of the multi-TRP operation is depicted. In the multi-TRP system, the UE could simultaneously receive multiple DL transmissions from multiple physically non-co-located TRPs, and the coordinating TRPs could be from the same cell (i.e., intra-cell multi-TRP: TRP-1 and TRP-2 could have the same PCI) or from different cells (i.e., inter-cell multi-TRP: TRP-1 and TRP-2 could have different PCIs). For both intra-cell and inter-cell multi-TRP systems, the propagation delays between the UE and the TRPs could be significantly different, which would require the UE to maintain/update the TRP-specific UL TA. The key components of applying the proposed RACH-less fast TA acquisition method for the multi-TRP system are presented below:

First, the UE maintains and updates the TRP-specific UL TA.

Second, the UE is indicated by the network the starting time (e.g., the starting symbol/slot) of the “target” TRP's (e.g., TRP-2 in FIG. 26) RSs such as SSBs, CSI-RSs, TRSs, and etc. The starting time of the “target” TRP's RSs could be referred from the timing of the “serving” TRP (e.g., TRP-1 in FIG. 26).

Third, the LIE measures the “target” TRP's RSs, and determines the receive timing difference/propagation delay difference between the coordinating TRPs based on the indicated starting time of the “target” TRP's RSs.

Fourth, the UE could report to the network the receive timing difference/propagation delay difference, and wait from the network to send the TA command for the “target” TRP. The UE could also autonomously determine the TA for the “target” TRP based on the propagation delay difference and the UL TA for the “serving” cell, and indicates to the network whether the UE has applied the TA for the “target” TRP by themselves (TA status report).

Fifth, the UE applies the TA for the “target” TRP to the subsequent UL transmissions to the “target” TRP.

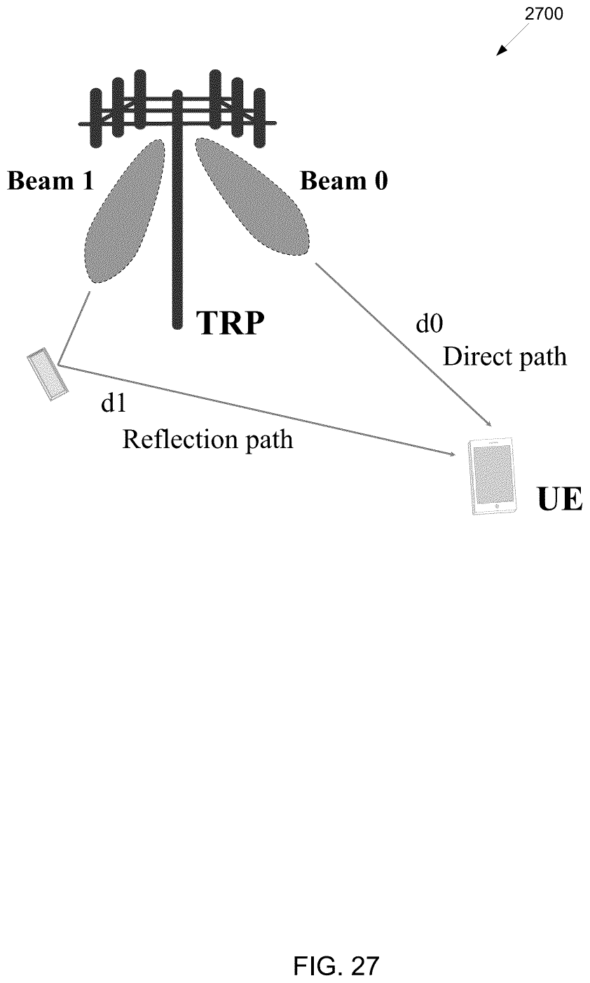

FIG. 27 illustrates an example of single-TRP multi-beam operation 2700 according to embodiments of the present disclosure. An embodiment of the single-TRP multi-beam operation 2700 shown in FIG. 27 is for illustration only.

Even for a single-TRP system, the UE could apply the proposed fast TA acquisition method to change/update the UL TA especially when a beam change at the network side would result in a significant variation/change of the propagation delay. One conceptual example of the considered single-TRP system is depicted in FIG. 27. As can be seen from FIG. 27, if the TRP changes its beam from beam 0 (direct path) to beam 1 (reflection path), their corresponding propagation delay difference could be significant, which would require the UE to maintain/update the TX beam-specific UL TA.

The key components of applying the provided RACH-less fast TA acquisition method for the single-TRP system shown in FIG. 27 are presented in examples below.

First, the UE maintains and updates the TX beam-specific UL TA.

Second, the UE is indicated by the network the TX beam change (e.g., from beam 0 to beam 1 in FIG. 27), e.g., via TCI state indication.

Third, the UE is indicated by the network the starting time (e.g., the starting symbol/slot) of the RSs such as SSBs, CSI-RSs, TRSs, and etc. transmitted from beam 1, e.g., via CSI-ResourceConfig.

Fourth, the UE measures the RSs from beam 1, and determines the receive timing difference/propagation delay difference between beam 0 and beam 1 based on the indicated starting time of the RSs transmitted from beam 1.

Fifth, the UE could report to the network the receive timing difference/propagation delay difference, and wait from the network to send the TA command for beam 1. The UE could also autonomously determine the TA for beam 1 based on the propagation delay difference and the UL TA for beam 0, and indicates to the network whether the UE has applied/adjusted the TA for the new beam 1 by themselves (TA status report).

Sixth, the UE applies the TA for the new beam to the subsequent UL transmissions.

Based on the above discussions, the UE could be provided by the network, e.g., in RAR or absolute timing advance command MAC CE, the UL timing advance command for the serving cell PCI (and therefore, the associated CORESETPoolIndex value or CORESETGroupIndex value). For the non-serving cell PCI (and therefore, the associated CORESETPoolIndex value or CORESETGroupIndex value),

In one example, the UE could transmit to the network (e.g., to the serving cell) in Msg1 or MsgA the PRACH preambles associated with the serving cell PCI and receive from the network, e.g., in RAR or absolute timing advance command MAC CE, the UL timing advance command for the non-serving cell PCI.

In another example, the UE could send to the network (e.g., to the serving cell) in part of CSI/beam report or PUSCH the TD(s) between the serving cell PCI and the non-serving cell PCI, and receive from the network, e.g., in RAR or absolute timing advance command MAC CE, the UL timing advance command for the non-serving cell PCI.

In yet another example, the UE could autonomously determine and apply timing adjustment to the transmission(s) of UL channels/signals such as PUCCH/SRS/PUSCH to the serving cell PCI and indicate to the network (e.g., to the serving cell) that the UE has autonomously determined and applied UL TA/timing adjustment for the non-serving cell PCI.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive, via a first absolute TA command medium access control control element (MAC CE), a first uplink (UL) timing advance (TA) command for a first link associated with a first physical cell identity (PCI); and
receive, a second absolute TA command MAC CE, a second UL TA command for a second link associated with a second PCI; and
a processor operably coupled to the transceiver, the processor configured to determine, based on the first and second UL TA commands, first and second UL timing adjustments for the first and second links associated with the first and second PCIs, respectively,
wherein the transceiver is further configured to:
transmit a physical uplink control channel (PUCCH), a physical uplink shared channel (PUSCH), or a sounding reference signal (SRS) associated with the first PCI according to the first UL timing adjustment; and
transmit a PUCCH, a PUSCH, or a SRS associated with the second PCI according to the second UL timing adjustment,
wherein the second PCI is different from the first PCI,
wherein the first UL TA command includes a first entity identifier (ID),
wherein the second UL TA command includes a second entity ID, and
wherein the first or second entity ID corresponds to at least one of:
a PCI;
a PCI index pointing to a PCI in a set of PCIs higher layer configured to the UE;
a CORESETPoolIndex value;
a CORESETGroupIndex value;
a UE panel ID;
a SRSPoolIndex value;
a SRS resource set index;
a SRS resource group index; and
a SRS resource index.
